(19) United States
(12) Patent Application Publication
(10) Pub. No.: US 2025/0362485 A1
(43) Pub. Date: Nov. 27, 2025

(54) OPTICAL SYSTEM AND CAMERA MODULE

(71) Applicant: LG INNOTEK CO., LTD., Seoul (KR)

(72) Inventors: Ju Yong SHIM, Seoul (KR); Chang Gyun SON, Seoul (KR)

(21) Appl. No.: 19/108,347

(22) PCT Filed: Sep. 4, 2023
(86) PCT No.: PCT/KR2023/013185

§ 371 Date: Mar. 3, 2025

(30) Foreign Application Priority Data
Sep. 2, 2022 (KR) 10-2022-0111532

(51) Int. Cl. G02B 13/18; G02B 9/34

(52) U.S. Cl. CPC G02B 13/18; G02B 9/34

(57) ABSTRACT

The optical system disclosed in the embodiment of the invention includes an image sensor; and first to fourth lenses aligned along an optical axis from an object toward the image sensor, wherein a power of the first lens is positive, a power of the second lens is negative, a power of the third lens is positive, at least two of the first to fourth lenses are plastic lenses, a refractive index of the first lens is 1.7 or greater, and an object-side surface and a sensor-side surface of a lens of the first to fourth lenses closest to the image sensor may include a critical point between the optical axis and an edge.

### CROSS-REFERENCE TO RELATED APPLICATIONS

This application is the U.S. national stage application of International Patent Application No. PCT/KR2023/013185, filed Sep. 4, 2023, which claims the benefit under 35 U.S.C. § 119 of Korean Application No. 10-2022-0111532, filed Sep. 2, 2022, the disclosures of each of which are incorporated herein by reference in their entirety.

### TECHNICAL FIELD

An embodiment of the invention relates to an optical system and a camera module including the same.

### BACKGROUND ART

ADAS (Advanced driving assistance system) is an advanced driver assistance system to assist the driver in driving, and it consists of sensing the situation ahead, judging the situation based on the sensed results, and controlling the behavior of the vehicle based on the situation judgment.

Due to the rapid global growth of ADAS, the driver monitoring system (DMS) is quickly becoming an important safety feature.

The camera for DMS linked to the advanced driver assistance system is placed inside the vehicle and can detect the situation of the driver and passengers. For example, the camera can photograph the driver at a location adjacent to the driver and can detect the driver's health status, whether he or she is drowsy, whether he or she is drinking, etc. In addition, the camera can photograph the passenger at a location adjacent to the passenger and can detect whether the passenger is sleeping, whether he or she is healthy, etc., and can provide information about the passenger to the driver.

The most important element for obtaining an image from a camera is the imaging lens that forms the image. Recently, interest in high-definition and high-resolution, etc., has been increasing, and research on an optical system including multiple lenses is being conducted to implement this. However, there is a problem that the characteristics of the optical system change when the camera is exposed to a harsh environment, such as high temperature, low temperature, moisture, or high humidity, outside or inside the vehicle. In this case, the camera has a problem that it is difficult to uniformly derive excellent optical characteristics and aberration characteristics. Therefore, new optical systems and cameras that can solve the above-described problems are required.

### DISCLOSURE

### Technical Problem

An embodiment may provide an optical system and a camera module having improved optical characteristics. The embodiment provides an optical system and a camera module having excellent optical performance in low-temperature to high-temperature environments. An embodiment provides an optical system and a camera module capable of inhibiting or minimizing changes in optical characteristics in various temperature ranges. The embodiment may be provided for a camera for an interior of a vehicle or a DMS.

### Technical Solution

An optical system according to an embodiment of the invention comprises an image sensor; and first to fourth lenses aligned along an optical axis from an object toward the image sensor, wherein a power of the first lens is positive, a power of the second lens is negative, a power of the third lens is positive, and at least two of the first to fourth lenses are plastic lenses, and a refractive index of the first lens is 1.7 or greater, and an object-side surface and a sensor-side surface of a lens closest to the image sensor among the first to fourth lenses may include a critical point between the optical axis and an edge.

An optical system according to an embodiment of the invention comprises at least two plastic lenses and at least two glass lenses, wherein a power of a lens closest to an object side is positive, a composite power of the remaining lenses excluding the lens closest to the object side is positive, a lens having the thinnest thickness in the optical axis among the lenses may be one of the glass lenses, a lens having the thickest thickness in the optical axis among the lenses may be one of the plastic lenses.

In the embodiment of the invention, the lens having the thickest thickness in the optical axis may be a plastic lens closest to the glass lens. The object-side surface and the sensor-side surface of the lens positioned farthest from the object may include a critical point between the optical axis and an edge.

In the embodiment of the invention, a refractive index of the lens closest to the object may be 1.7 or more. The glass lenses may be the two lenses closest to the object.

In the embodiment of the invention, each of the glass lenses adjacent to the object may have a meniscus shape convex toward the object side on the optical axis. In the embodiment of the invention, the glass lenses are spherical lenses, the plastic lenses are aspherical lenses, the glass lens closest to the plastic lens may have a meniscus shape convex toward the sensor side on the optical axis, and the plastic lens closest to the glass lens may have a meniscus shape convex toward the sensor side on the optical axis.

According to the embodiment of the invention, a sum of the thicknesses of the glass lenses in the optical axis is ΣGL_CT, and an optical axis distance from the object-side surface of the first lens to the sensor-side surface of the fourth lens is TD, and the following Equation may satisfy: 0.15≤ΣGL_CT/TD≤0.25.

An optical system according to an embodiment of the invention includes lenses of a first material arranged continuously along the optical axis; and lenses of a second material arranged continuously along the optical axis on an sensor side of the lenses of the first material, wherein the lenses of the first material include lenses having an aspherical surface and lenses having a spherical surface, and the lenses of the second material include lenses having an aspherical surface, and the first material is different from the second material, and the average of the center thicknesses of the lenses of the first material may be greater than the average of the center thicknesses of the lenses of the second material.

According to an embodiment of the invention, the first material may be a glass material, and the second material may be a plastic material.

According to an embodiment of the invention, an average refractive index of the lenses of the first material is greater than an average refractive index of the lenses of the second material, and an average effective diameter of the lenses of the first material may be greater than an average effective diameter of the lenses of the second material.

According to an embodiment of the invention, a number of lenses of the first material is greater than that of the lenses of the second material, and a difference between the number of lenses of the first material and the number of lenses of the second material may be smaller than the number of lenses of the second material.

According to an embodiment of the invention, at least two of the lenses of the first material include a cemented lens that is bonded to each other, and the cemented lens may include a lens having positive refractive power and a lens having negative refractive power.

A camera module according to an embodiment of the invention includes an image sensor; first to fourth lenses aligned with an optical axis from an object toward the image sensor; and an optical filter between the image sensor and the fourth lens, wherein a center thickness of the third lens is greater than a sum of the center thicknesses of each of the first and second lenses, each of the effective diameters of the first to third lenses is smaller than a diagonal length of the image sensor, at least one of the first to fourth lenses is a spherical lens, and at least one of the first to fourth lenses is an aspherical lens, a distance from a center of the object-side surface of the first lens to a surface of the image sensor is TTL, a total effective focal length is F, and ½ of the diagonal length of the image sensor is ImgH, and the camera module may satisfy the Equation 1:1 mm≤F≤10 mm, Equation 2:1 mm<TTL/ImgH<5 mm, and Equation 3: TTL≤10 mm.

### Effects of the Invention

An optical system and a camera module according to an embodiment may have improved optical characteristics. In detail, in the optical system according to an embodiment, a plurality of lenses may have set thicknesses, powers, and intervals with adjacent lenses. Accordingly, the optical system and camera module according to the embodiment may have improved MTF characteristics, aberration control characteristics, resolution characteristics, etc. in the set field of view range, and may have good optical performance in the periphery of the field of view.

In addition, the optical system and camera module according to the embodiment may have good optical performance in the temperature range of low temperature (about −20° C. to −40° C.) to high temperature (85° C. to 105° C.). In detail, the plurality of lenses included in the optical system may have set materials, power, and refractive index. Accordingly, even when the focal length of each lens changes due to a change in refractive index according to a change in temperature, the lenses can mutually compensate. That is, the optical system can effectively perform power distribution in the low temperature to high temperature temperature range, and can inhibit or minimize changes in optical characteristics in the low temperature to high temperature temperature range. Therefore, the optical system and camera module according to the embodiment can maintain improved optical characteristics in various temperature ranges.

In addition, the optical system and camera module according to the embodiment may satisfy the set field of view and implement excellent optical characteristics by mixing an aspherical lens and a spherical lens. This allows the optical system to provide a slimmer vehicle camera module. Accordingly, the optical system and camera module may be provided for various applications and devices, and may have excellent optical properties even in harsh temperature environments, such as when exposed to the outside of a vehicle or inside a vehicle at high temperatures in summer. The embodiment can improve the reliability of a camera for vehicle interiors or DMS.

### DESCRIPTION OF DRAWINGS

FIG. 1 is a side cross-sectional view of an optical system according to the first embodiment and a camera module having the same.

FIG. 2 is a side cross-sectional view for explaining the relationship between the n-th and n−1th lenses according to FIG. 1.

FIG. 3 is a table showing lens characteristics of the optical system of FIG. 1.

FIG. 4 is a table showing aspherical coefficients of lenses in the optical system of FIG. 1.

FIG. 5 is a table showing center thicknesses of each lens and center distances between adjacent lenses in the optical system of FIG. 1.

FIG. 6 is a table showing CRA (Chief ray angle) data at room temperature, low temperature, and high temperature according to the position of the image sensor in the optical system of FIG. 1.

FIG. 7 is a graph showing data on diffraction MTF (Modulation transfer function) of the optical system of FIG. 1 at room temperature.

FIG. 8 is a graph showing data on diffraction MTF of the optical system of FIG. 1 at low temperature.

FIG. 9 is a graph showing data on diffraction MTF of the optical system of FIG. 1 at high temperature.

FIG. 10 is a graph showing data on the aberration characteristics of the optical system of FIG. 1 at room temperature.

FIG. 11 is a graph showing data on the aberration characteristics of the optical system of FIG. 1 at low temperature.

FIG. 12 is a graph showing data on the aberration characteristics of the optical system of FIG. 1 at high temperature.

FIG. 13 is a side cross-sectional view of an optical system according to the second embodiment and a camera module having the same.

FIG. 14 is a table showing lens characteristics of the optical system of FIG. 13.

FIG. 15 is a table showing aspherical coefficients of lenses in the optical system of FIG. 13.

FIG. 16 is a table showing the thickness of each lens of the optical system of FIG. 13 and the spacing between adjacent lenses.

FIG. 17 is a table showing CRA data at room temperature, low temperature, and high temperature according to the position of the image sensor in the optical system of FIG. 13.

FIG. 18 is a graph showing data on the diffraction MTF of the optical system of FIG. 13 at room temperature.

FIG. 19 is a graph showing data on the aberration characteristics of the optical system of FIG. 13 at room temperature.

FIG. 20 is a table showing data on relative illuminance according to the height of the image sensor according to the first and second embodiments.

FIG. 21 is a side cross-sectional view of an optical system according to an embodiment and a camera module having the same.

FIG. 22 is a side cross-sectional view for explaining the relationship between the n-th and n−1th lenses according to FIG. 21.

FIG. 23 is a table showing lens characteristics of the optical system of FIG. 21.

FIG. 24 is a table showing aspherical coefficients of lenses in the optical system of FIG. 21.

FIG. 25 is a table showing the thickness of each lens of the optical system of FIG. 21 and the spacing between adjacent lenses.

FIG. 26 is a table showing Sag values of lens surfaces of the third to sixth lenses in the optical system of FIG. 21.

FIG. 27 is a table showing CRA data at room temperature, low temperature, and high temperature according to the position of the image sensor in the optical system of FIG. 21.

FIG. 28 is a graph showing data on the diffraction MTF of the optical system of FIG. 21 at room temperature.

FIG. 29 is a graph showing data on the diffraction MTF of the optical system of FIG. 21 at low temperature.

FIG. 30 is a graph showing data on the diffraction MTF of the optical system of FIG. 21 at high temperature.

FIG. 31 is a graph showing data on the aberration characteristics of the optical system of FIG. 21 at room temperature.

FIG. 32 is a graph showing data on the aberration characteristics of the optical system of FIG. 21 at low temperature.

FIG. 33 is a graph showing data on the aberration characteristics of the optical system of FIG. 21 at high temperature.

FIG. 34 is a graph showing relative illuminance according to the height of the image sensor according to an embodiment.

FIG. 35 is an example of a vehicle having an optical system according to an embodiment of the invention.

### BEST MODE

Hereinafter, preferred embodiments of the invention will be described in detail with reference to the accompanying drawings. A technical spirit of the invention is not limited to some embodiments to be described, and may be implemented in various other forms, and one or more of the components may be selectively combined and substituted for use within the scope of the technical spirit of the invention. In addition, the terms (including technical and scientific terms) used in the embodiments of the invention, unless specifically defined and described explicitly, may be interpreted in a meaning that may be generally understood by those having ordinary skill in the art to which the invention pertains, and terms that are commonly used such as terms defined in a dictionary should be able to interpret their meanings in consideration of the contextual meaning of the relevant technology.

The terms used in the embodiments of the invention are for explaining the embodiments and are not intended to limit the invention. In this specification, the singular forms also may include plural forms unless otherwise specifically stated in a phrase, and in the case in which at least one (or one or more) of A and (and) B, C is stated, it may include one or more of all combinations that may be combined with A, B, and C. In describing the components of the embodiments of the invention, terms such as first, second, A, B, (a), and (b) may be used. Such terms are only for distinguishing the component from other component, and may not be determined by the term by the nature, sequence or procedure etc. of the corresponding constituent element. And when it is described that a component is “connected”, “coupled” or “joined” to another component, the description may include not only being directly connected, coupled or joined to the other component but also being “connected”, “coupled” or “joined” by another component between the component and the other component. In addition, in the case of being described as being formed or disposed “above (on)” or “below (under)” of each component, the description includes not only when two components are in direct contact with each other, but also when one or more other components are formed or disposed between the two components. In addition, when expressed as “above (on)” or “below (under)”, it may refer to a downward direction as well as an upward direction with respect to one element. Several embodiments described below may be combined with each other, unless it is specifically stated that they cannot be combined with each other. In addition, the description of other embodiments may be applied to parts omitted from the description of any one of several embodiments unless otherwise specified.

In the description of the invention, “object-side surface” may refer to a surface of the lens facing the object side with respect to the optical axis OA, and “sensor-side surface” may refer to a surface of the lens facing the imaging surface (image sensor) with respect to the optical axis. A convex surface of the lens may mean a convex shape on the optical axis or paraxial region, and a concave surface of the lens may mean a concave shape on the optical axis or paraxial region. A curvature radius, center thickness, and distance between lenses described in the table for lens data may mean values on the optical axis, and the unit is mm. The vertical direction may mean a direction perpendicular to the optical axis, and an end of the lens or the lens surface may mean the end or edge of the effective region of the lens through which the incident light passes. The size of the effective diameter on the lens surface may have a measurement error of up to ±0.4 mm depending on the measurement method. The paraxial region refers to a very narrow region near the optical axis, and is a region where the distance a light ray falls from the optical axis OA is almost 0. Hereinafter, the optical axis may include the center of each lens or a very narrow region near the optical axis.

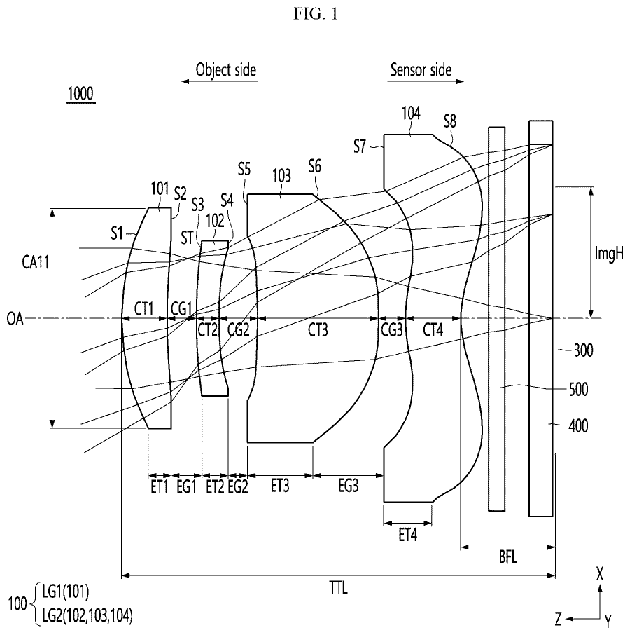

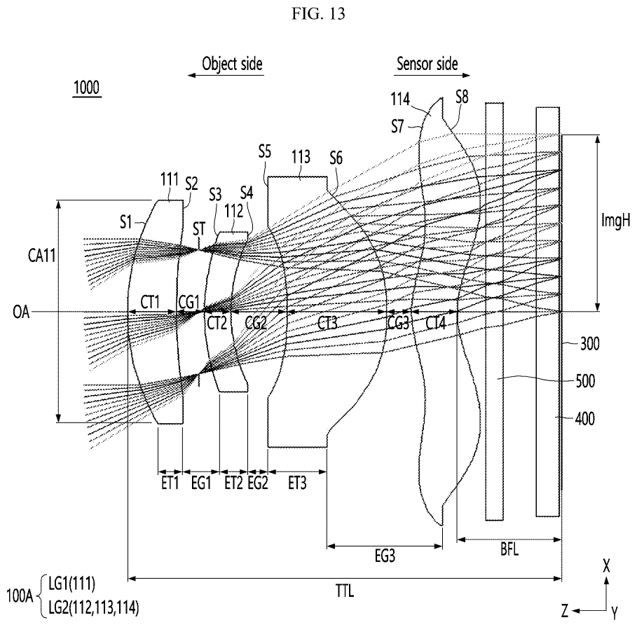

As shown in FIG. 1 and FIG. 13, the optical system 1000 according to the first and second embodiments of the invention may include a plurality of lens groups LG1 and LG2. The plurality of lens groups LG1 and LG2 may include a first lens group LG1 and a second lens group LG2 that are sequentially arranged along the optical axis OA from the object side toward the image sensor 300. The number of lenses of each of the first lens group LG1 and the second lens group LG2 may be different from each other. The number of lenses of the second lens group LG2 may be greater than the number of lenses of the first lens group LG1, for example, may be more than two times or more than three times the number of lenses of the first lens group LG1. The first lens group LG1 may have two or fewer lenses. The first lens group LG1 may preferably have one lens. The second lens group LG2 may include two or more lenses or three or more lenses. The second lens group LG2 may include three lenses. The optical system 1000 may include n lenses, and the n-th lens may be the lens closest to the image sensor 300, and the n−1th lens may be the lens closest to the n-th lens. n is an integer less than or equal to 5, for example, 3 to 5.

The first lens group LG1 may include at least one lens made of glass. The first lens group LG1 may provide the lens closest to the object side as a lens made of glass. Such glass material has a small amount of expansion and contraction change due to external temperature change, and the surface is not easily scratched, so that surface damage may be inhibited. The lens material of the second lens group LG2 may include at least one lens made of glass and at least one lens made of plastic. Preferably, when the number of the glass lens is nGL and the plastic lens is nPL, the second lens group LG2 may satisfy the following condition: nGL<nPL. The optical system 1000 may have the same number of glass lens lenses and plastic lens lenses.

The second lens group LG2 may include at least one spherical lens and at least one aspherical lens. The number of aspherical lenses in the second lens group LG2 may be greater than the number of spherical lenses. Here, the spherical lens is a lens in which the object-side surface and the sensor-side surface of the lens are spherical in the optical axis, and the aspherical lens is a lens in which the object-side surface and the sensor-side surface of the lens are aspherical. Here, the n-th lens is a lens closest to the image sensor 300, and may be an aspherical lens or a plastic lens to inhibit deterioration of optical performance. As another example, the aspherical lens may be made of a glass mold material. The glass mold material lens is a lens that is injection-molded to have an aspherical surface using glass material. The number of aspherical lenses in the second lens group LG2 may be at least twice that of spherical lenses. The aspherical lenses can inhibit spherical aberration within the optical system 1000, and since aberration does not occur even when the effective diameter increases, miniaturization and weight reduction of the camera module may be possible.

The optical system 1000 can compensate for heat within the lens barrel by arranging a mixture of glass and plastic materials, and can suppress deterioration of optical characteristics due to temperature changes. In addition, since the optical system 1000 includes at least one plastic lens or at least one aspherical lens, occurrence of various aberrations may be suppressed.

In the optical system 1000, a lens having a maximum Abbe number may be positioned in the second lens group LG2, and a lens having a maximum refractive index may be positioned in the first lens group LG1. The maximum Abbe number above is 55 or more, and the maximum refractive index may be 1.70 or more. The lens having the maximum Abbe number above can reduce chromatic dispersion, and the lens having the maximum refractive index can increase chromatic dispersion of incident light. The refractive index of the i-th lens is Ndi, the Abbe number of the i-th lens is Adi, and the value of the following condition: Ndi*Adi may be maximum when i is 2. Also, the value of the following condition: Ndi*Adi is 45 or more when i=1, 2, and the value of the following condition: Ndi*Adi is less than 50 when i=3, 4. A lens having a minimum effective diameter in the optical system 1000 may satisfy the value of the following condition of Ndi*Adi satisfies: 80<(Ndi*Adi)<140, and * indicates multiplication.

The lens having the maximum effective diameter within the lens portion 100 and 100A is an aspherical lens and may be arranged closest to the image sensor 300. The aspherical lens having the maximum effective diameter can refract light to the entire region of the image sensor 300. In addition, the lens having the maximum effective diameter may be a plastic lens and may be a glass lens having the minimum effective diameter. The lens having the minimum effective diameter may be arranged between the plastic lens and the glass lens. The lens having the maximum effective diameter may be arranged between the plastic lens or the aspherical lens and the image sensor. In addition, the lens closest to the object may be a spherical lens or a glass lens. The effective diameter of each lens may be the diameter of the effective region into which effective light is incident on each lens, and is an average of the effective diameter of the object-side surface and the effective diameter of the sensor-side surface. The embodiment of the invention can reduce the weight of the camera module, provide a lower manufacturing cost, and suppress the deterioration of optical characteristics due to temperature change by further mixing an aspherical lens into the optical system 1000.

Each of the lenses may include an effective region and an ineffective region. The effective region may be a region through which light incident on each of the lenses passes. In other words, the effective region may be defined as an effective region or an effective diameter in which the incident light is refracted to implement optical characteristics. An end of the ineffective region may be a region fixed to a lens barrel (not shown) that accommodates the lens.

In the optical system 1000, the TTL (Total top length or Total track length) may be 1 time more than ImgH, for example, 1 time more than ImgH and 5 times less than ImgH. Preferably, the following condition may satisfy: 1<TTL/ImgH<3. The TTL is an optical axis distance from the center of the object-side surface of the first lens to the surface of the image sensor 300. The ImgH is half of the diagonal length of the image sensor 300 in the optical axis OA. In the optical system 1000, the effective focal length (EFL) is 10 mm or less and the diagonal field of view (FOV) is more than 45 degrees, so that the optical system may be provided as a standard optical system in a vehicle camera module. That is, the focal length may be reduced to 10 mm or less for the diagonal field of view. For example, the optical system and the camera module according to the embodiment may be applied to a camera module for DMS provided in a vehicle interior. The optical system 1000 may have a value of TTL/(2*ImgH) greater than 0.5, for example, greater than 0.5 and less than 2.5 or 0.5<TTL/(2*ImgH)<1.5. By setting the value of TTL/(2*ImgH) to less than 1.5, the optical system 1000 can provide an optical system for driver monitoring. The total number of lenses of the first and second lens groups LG1 and LG2 is 5 or less. Accordingly, the optical system 1000 can provide an image without exaggeration or distortion for the image being formed.

The length of the image sensor 300 is the maximum length of the diagonal line orthogonal to the optical axis OA. The number of lenses having an effective diameter larger than the diagonal length of the image sensor 300 in the optical system 1000 is 2 or less or 1 or less, and the number of lenses having an effective diameter smaller than the length of the image sensor 300 may be 2 or more or 3 or more. The diagonal length of the image sensor 300 may be larger than the diameter of the spherical lens or the glass lens. The diagonal length of the image sensor 300 may be smaller than or larger than the diameter of at least one of the aspherical lens or the plastic lens. Preferably, half of the diagonal length of the image sensor 300 may be larger than the minimum effective diameter of the lens.

Within the lens portion 100 and 100A, the first lens may have an effective diameter smaller than the effective diameter of the last lens closest to the image sensor 300, and may be provided with a glass material having a high refractive index. Accordingly, the center thickness of the first lens of the optical system may be provided thinner than the center thickness of the last lens, and the refractive angle and color dispersion may be increased. The effective diameters of the lenses may gradually decrease from the first lens portion to the last spherical lens, and may gradually increase from the last spherical lens portion to the last aspherical lens. By controlling the effective diameter size of each lens, it is possible to control light incident on the image sensor 300 having at least 2 megabytes of pixels, compensate for the deterioration of optical characteristics due to resolution and temperature changes within the optical system, improve chromatic aberration control characteristics, and improve the vignetting characteristics of the optical system 1000.

The optical system 1000 may include an aperture stop ST. The aperture stop ST can control the amount of light incident on the optical system 1000. The aperture stop ST may be arranged between any two lenses in the lens portion 100 and 100A. In the lenses arranged between the object and the aperture stop ST, the effective diameter of the lens surface tends to become smaller as it goes from the object side to the aperture stop ST. In the lenses arranged between the aperture stop ST and the image sensor 300, the effective diameter of the lens surfaces tends to become larger as it goes from the aperture stop ST to the sensor side. The meaning of ‘the effective diameter of the lenses tends to become larger as it goes from the aperture stop ST to the sensor side’ may include lenses arranged between the aperture stop ST and the image sensor 300 in which the effective diameter of the lens surface gradually becomes larger or smaller as it goes from the aperture stop ST to the sensor side. As another example, the aperture stop ST may be arranged around the object-side surface of the lens closest to the object side among the lenses of the second lens group LG2. Alternatively, the aperture stop ST may be arranged around the object-side surface of the object-side lens of the first lens group LG1. Alternatively, at least one lens selected from the plurality of lenses may serve as an aperture stop. In detail, the object-side surface or the sensor-side surface of one lens selected from the lenses of the optical system 1000 may serve as an aperture stop for controlling the amount of light.

The optical axis distance between the first lens group LG1 and the second lens group LG2 may be the optical axis distance between the sensor-side surface of the first lens group LG1 and the object-side surface of the second lens group LG2. The optical axis distance between the first lens group LG1 and the second lens group LG2 may be the center distance between adjacent spherical lenses. In addition, the optical axis distance between the first lens group LG1 and the second lens group LG2 may be smaller than the center distance between the object-side spherical lens and the sensor-side aspherical lens. The optical axis distance between the first lens group LG1 and the second lens group LG2 may be larger than the center distance between the aspherical lens and the aspherical lens.

The optical axis distance between the first lens group LG1 and the second lens group LG2 may be less than 1 time the optical axis distance of the first lens group LG1, for example, greater than 0.5 times and less than 0.8 times the optical axis distance of the first lens group LG1. The optical axis distance between the first lens group LG1 and the second lens group LG2 may be less than 0.5 times the optical axis distance of the second lens group LG2, for example, greater than 0 times and less than 0.3 times. The optical axis distance of the first lens group LG1 is the optical axis distance from the object-side surface to the sensor-side surface. The optical axis distance of the second lens group LG2 is the optical axis distance between the object-side surface of the lens closest to the object side of the second lens group LG2 and the sensor-side surface of the lens closest to the image sensor 300. Here, the first lens group LG1 may include lenses located closer to the object side than the aperture stop ST, and the second lens group LG2 may include lenses located closer to the sensor side than the aperture stop ST. The first lens group LG1 and the second lens group LG2 may be divided into an object-side lens group and a sensor-side lens group based on the aperture stop ST. The sensor-side surface of the first lens group LG1 may have a concave shape in the optical axis, and the object-side surface of the second lens group LG2 may have a convex shape in the optical axis, and may be opposite to each other.

The first lens group LG1 may have positive (+) power, and the second lens group LG2 may have positive (+) power. The lens closest to the object side in the first lens group LG1 may have positive (+) power, and the lens closest to the sensor side among the lenses of the second lens group LG2 may have negative (−) power. When the focal length of the first lens group LG1 is F_LG1, and the focal length of the second lens group LG2 is F_LG2, F_LG1<F_LG2 may be satisfied. Here, when the composite focal length of the first lens 101 and 111 and the second lens 102 and 112 in the optical system 1000 is set to F12, and the composite focal length of the third lens 103 and 113 and the fourth lens 104 and 114 is set to F34, the following condition may satisfy: F12<F34, and the conditions of F13, F47>0 may be satisfied. In addition, the following conditions may satisfy: F_LG1<F12<F_LG2 and F_LG1<F34<F_LG2. Here, F_LG1 is the focal length of the first lens 101 and 111 and may be defined as F1, and F_LG2 is the composite focal length of the second lens 102 and 112 to the fourth lens 104 and 114 and may be defined as F24. In addition, the number of lenses having negative (−) power on the optical system 1000 may be equal to the number of lenses having positive (+) power. The number of lenses having negative (−) power may be 60% or less of the total number of lenses, for example, in the range of 40% to 60%.

The lens portion 100 and 100A may be a mixture of spherical lenses and aspherical lenses. The average effective diameter of the glass lenses may be smaller than the average effective diameter of the plastic lenses, and the difference between the average effective diameter of the glass lenses and the average effective diameter of the plastic lenses may be 0.5 mm or more, for example, in the range of 0.5 mm to 2.5 mm. The plastic lenses may be aspherical lenses, and the glass lenses may be spherical lenses. The number of lenses of the plastic lenses may be 60% or less of the total number of lenses, for example, in the range of 40% to 60%. Accordingly, when two or more plastic lenses are arranged in the camera module, the weight of the camera module may be reduced and the optical characteristics may be improved. In addition, the difference in effective diameter between the plastic lens and the glass lens may be reduced, thereby inhibiting deterioration of the assembly.

The first lens group LG1 can refract light incident through the object side in the direction of the optical axis, and the second lens group LG2 can refract light emitted through the first lens group LG1 to the image sensor 300. The optical axis distance between the first lens group LG1 and the second lens group LG2 may be less than 1 mm, for example, 0.7 mm or less.

The average Abbe number of the spherical material lenses in the lens portion 100 and 100A may be greater than the average Abbe number of the aspherical lenses. Since the lens closest to the object has a low Abbe number and a high refractive index, it can increase the chromatic dispersion of incident light in an optical system with five or less lenses and widen the field of view compared to the focal length.

The sum of the refractive indices of the lenses of the lens portion 100 and 100A of the embodiment may be 8 or less, for example, in the range of 5 to 8, and the average of the refractive indices may be in the range of 1.67 to 1.77. The sum of the Abbe numbers of each of the lenses may be 200 or less, for example, in the range of 100 to 200, and the average of the Abbe numbers may be 45 or less, for example, in the range of 25 to 45. The sum of the center thicknesses of the entire lens may be 6 mm or less, for example, in the range of 3 mm to 6 mm or 3.5 mm to 5 mm. The average of the center thicknesses of the entire lens may be 1.5 mm or less, for example, in the range of 0.8 mm to 1.5 mm. The sum of the center distances between the lenses in the optical axis OA may be 2.5 mm or less, for example, in the range of 1 mm to 2.5 mm or 1.2 mm to 2.1 mm, and may be smaller than the sum of the center thicknesses of the lenses. In addition, the average value of the effective diameter of each lens surface of the lens portion 100 and 100A may be provided within a range of 5 mm or less, for example, 2 mm to 5 mm. The maximum and minimum difference of the effective diameter may have a difference of 3 mm or less. Therefore, an optical system in which the effective diameter difference of each lens surface is not large may be provided, and the assemblability of lenses assembled within the lens barrel may be improved.

In the lens portion 100 and 100A, when the number of aspherical lenses is Ma, the number of lenses having an effective diameter smaller than the diagonal length of the image sensor 300 is Mb, and the number of lenses having negative power is Mc, the following condition may satisfy: Mb≤Ma<Mb, and preferably, Ma and Mb may be the same. In the lens portion 100 and 100A, the number of lens surfaces having an aspherical surface is Ma1, the number of lens surfaces having an effective diameter smaller than the diagonal length of the image sensor 300 is Mb1, and the number of lenses having negative power is Mc, then the following condition may satisfy: Mc<Ma1<Mb1. The lens surfaces are the object-side surface and the sensor-side surface of each lens. In the lens portion 100 and 100A, the number of spherical lenses is Ga, the number of lenses having an effective diameter larger than the diagonal length of the image sensor 300 is Gb, and the number of lenses having positive power is Gc, then the following condition may satisfy: Gb≤Ga≤Gc, and preferably, Ga and Gc may be the same.

If the average of the effective diameters of glass lenses or spherical lenses is GL_CA_Aver, and the average of the effective diameters of plastic lenses or aspherical lenses is PL_CA_Aver, the following condition may satisfy: GL_CA_Aver<PL_CA_Aver. If the average of the center thicknesses of glass lenses or spherical lenses is GL_CT_Aver, and the average of the center thicknesses of plastic lenses or aspherical lenses is PL_CT_Aver, the following condition may satisfy: GL_CT_Aver<PL_CT_Aver. If the average of the refractive indices of glass lenses or spherical lenses is GL_Nd_Aver, and the average of the refractive indices of plastic lenses or aspherical lenses is PL_Nd_Aver, the following condition may satisfy: PL_Nd_Aver<GL_Nd_Aver. The average Abbe number of the glass lens or spherical lens is GL_Ad_Aver, and the average Abbe number of the plastic lens or aspherical lens is PL_Ad_Aver, so that the following condition may satisfy: PL_Ad_Aver<GL_Ad_Aver.

The F number of the optical system or the camera module may be 2.4 or less, for example, in the range of 1.4 to 2.4 or in the range of 1.8 to 2.2. The maximum field of view (diagonal FOV) of the optical system may be less than 75 degrees, for example, in the range of more than 45 degrees and less than 75 degrees, or in the range of 50 degrees to 70 degrees. The vehicle optical system may have a horizontal field of view FOV_H in the Y-axis direction that may be more than 40 degrees and less than 60 degrees, for example, in the range of 45 degrees to 55 degrees. In addition, the vertical field of view is provided at an angle smaller than the horizontal field of view, and may be less than 51 degrees, for example, in the range of 31 degrees to 51 degrees. At this time, the sensor length in the horizontal direction Y may be 4.800 mm±0.5 mm, and the sensor height in the vertical direction X may be 3.900 mm±0.5 mm. The horizontal field of view FOV_H is a field of view based on the horizontal length of the sensor. Accordingly, it is possible to suppress the change in the focus imaging position due to temperature change, and provide a vehicle camera in which various aberrations are well corrected. When the diagonal field of view of the optical system 1000 is 50 to 70 degrees, when there is at least one glass lens and at least one plastic lens in the optical system, the center thickness of the plastic lens arranged on the sensor side of the glass lens may be the thickest. In addition, the average of the center thicknesses of the plastic lenses may be provided to be thicker than the average of the center thicknesses of the glass lenses. Accordingly, the number of plastic lenses in the optical system, the center thickness of the plastic lenses, the plastic lens having an aspherical surface, and at least one plastic lens having a critical point can reduce the influence of aberrations such as spherical aberration, field curvature, and distortion caused by glass lenses on the optical performance, and can reduce the change in optical performance due to temperature changes from low to high temperatures. In addition, by applying one or more plastic lenses in the optical system, it may be advantageous in reducing the manufacturing cost and weight, and the processing of the plastic lens may be easier than that of the glass lens. In addition, by applying a plastic lens having an aspherical surface for aberration correction and increasing the thickness of the plastic lens, the sensitivity of the aspherical shape may be lowered, and the assemblability in the lens barrel may be improved.

The optical system 1000 or camera module may include an image sensor 300. The image sensor 300 may detect light and convert it into an electrical signal. The image sensor 300 may detect light that has sequentially passed through the lens portion 100 and 100A. The image sensor 300 may include a device capable of detecting incident light, such as a CCD (Charge coupled device) or a CMOS (Complementary metal oxide semiconductor). Here, the diagonal length of the image sensor 300 may be 87% or more of the maximum effective diameter of the lenses, for example, in the range of 87% to 107%, and for example, in the range of 90% to 105%.

The optical system 1000 or camera module may include an optical filter 500. The optical filter 500 may be disposed between the second lens group LG2 and the image sensor 300. The optical filter 500 may be placed between the lens closest to the sensor side among the lenses of the lens portion 100 and 100A and the image sensor 300. For example, the optical system 100 may be disposed between the last lens and the image sensor 300. The cover glass 400 is disposed between the optical filter 500 and the image sensor 300, and may protect the upper portion of the image sensor 300 and inhibit the reliability of the image sensor 300 from being deteriorated. The cover glass 400 may be removed.

The optical filter 500 may include an infrared filter or an infrared cut-off filter. The optical filter 500 may pass light of a set wavelength band and filter light of a different wavelength band. If the optical filter 500 includes an infrared filter, it can block radiant heat emitted from external light from being transmitted to the image sensor 300. In addition, the optical filter 500 can transmit visible light and reflect infrared rays. The optical filter 500 can transmit wavelengths of 920 nm or more, and for example, can transmit wavelength bands of 920 nm to 960 nm.

Since the embodiment is an optical system applied to a vehicle camera, the first lens 101 and 111 may be provided as a glass material even though it is designed using an aspherical lens and a spherical lens together. This has the advantage that the glass material is resistant to scratches and is not sensitive to external temperature compared to a plastic material. Since the first lens has a convex shape toward the driver inside the vehicle, it can more effectively inhibit foreign substances from accumulating or scratches and improve the incidence efficiency. Accordingly, the reliability of the driving or surveillance camera module may be improved. The last lens in the lens portion 100 and 100A may be provided as an aspherical lens made of plastic. Since the last lens is made of a plastic material having an aspherical surface, various aberrations may be corrected to reduce the influence on optical characteristics and the overall length (TTL) may be reduced. In addition, since the last lens is provided as an aspherical lens, chromatic aberration may be corrected, and since it has a thicker thickness than a spherical lens, the assemblability with the lens barrel may be improved. In addition, the last lens can refract light to the entire region of the image sensor 300 by means of an aspherical sensor-side surface having a critical point. The last lens has a gull-shaped cross-section and can refract incident light to the entire region of the image sensor 300. The gull-shaped shape is a shape in which the center and the edge of the object-side surface and the sensor-side surface of the lens are convex and the region between the center and the edge is concave. In addition, since the last lens is made of plastic, in order to increase the low refractive index or low refractive angle of the plastic lens, the last lens may have a lens surface having at least one critical point from the optical axis to the end of the effective region. The lens surface having the critical point may include the object-side surface or/and the sensor-side surface of the last lens.

The optical system 1000 according to the embodiment may further include a reflective member (not shown) for changing the path of light. The reflective member may be implemented as a prism that reflects the incident light of the first lens group LG1 toward the lenses. Hereinafter, the optical system according to the embodiment will be described in detail.

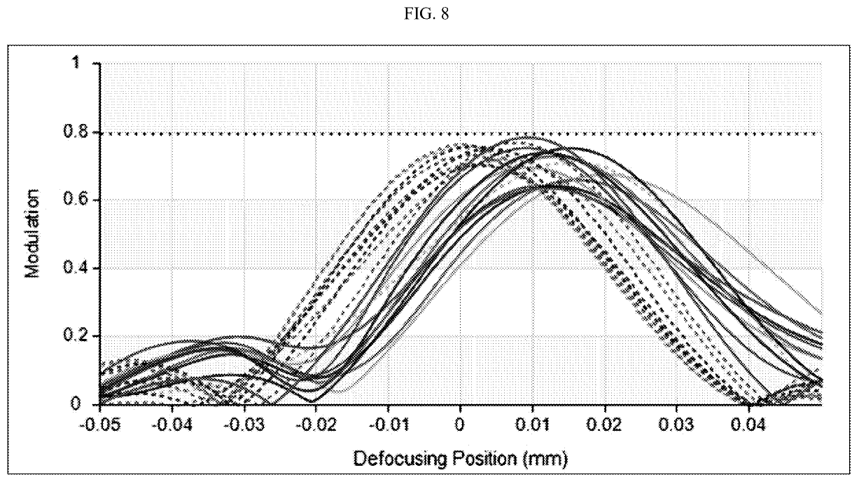

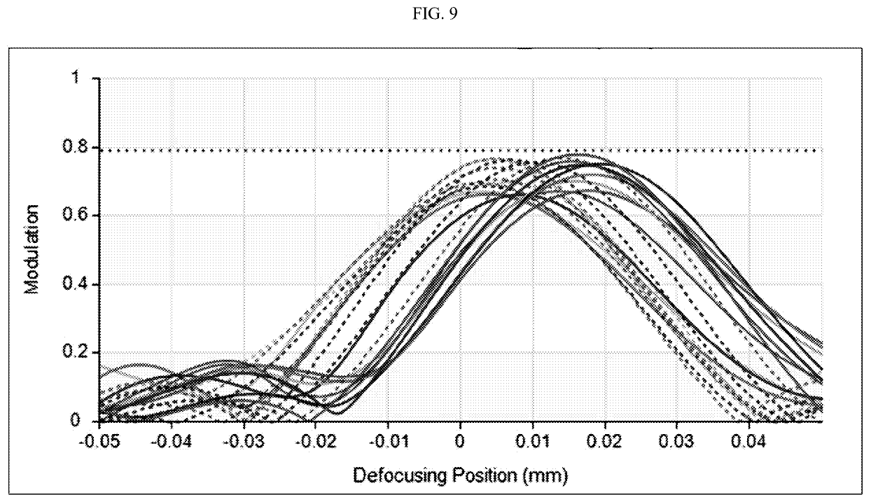

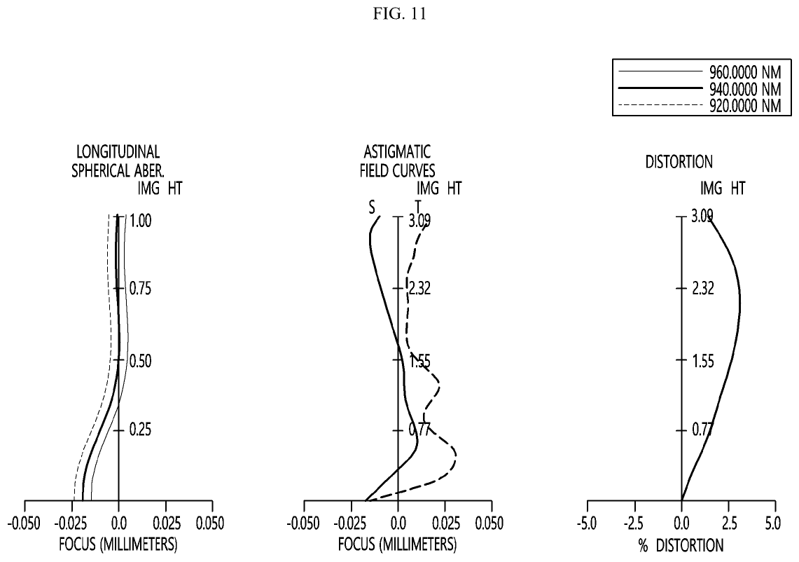

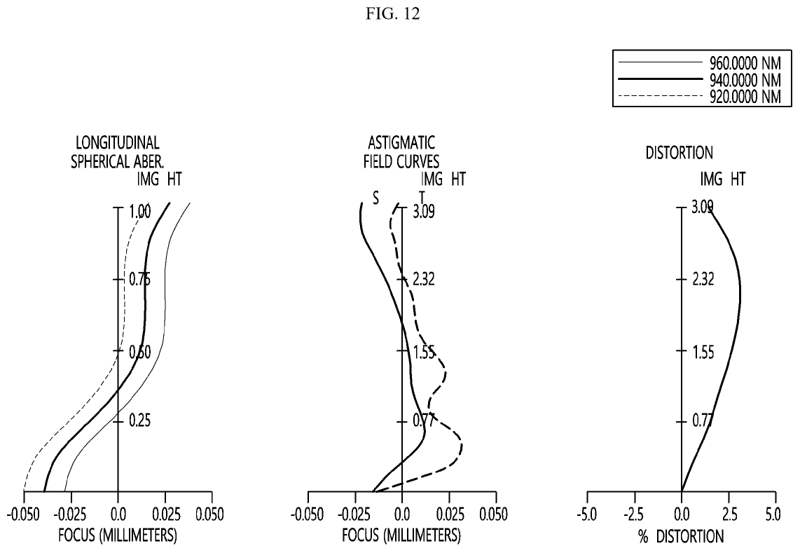

The optical system and camera module according to the first embodiment of the invention will be described with reference to FIGS. 1 to 12.

Referring to FIGS. 1 to 3, the optical system 1000 according to the first embodiment includes a lens portion 100, and the lens portion 100 may include a first lens 101 to a fourth lens 104. The first to fourth lenses 101-104 may be sequentially aligned along an optical axis OA, and incident light may pass through the first lens 101 to the fourth lens 104 and the optical filter 500 to be incident on the image sensor 300.

The first lens 101 is a lens of the first lens group LG1 and is the lens closest to the object side. The fourth lens 104 is a lens closest to the image sensor 104 within the second lens group LG2 or the lens portion 100. The second to fourth lenses 102, 103, and 104 may be the second lens group LG2. As the composite focal lengths of the lenses, F12, F24, and F34 may satisfy the following conditions.

F12<F34<F24, Condition 1:

F<F12, Condition 2:

(F34−F12)<(F12−F) Condition 3:

The first lens 101 may have positive (+) or negative (−) power on the optical axis OA. The first lens 101 may have positive (+) power. The first lens 101 may include a plastic material or a glass material, and may be, for example, a glass material. The first lens 101 made of a glass material may reduce changes in the center position and the radius of curvature due to temperature changes according to the surrounding environment, and may protect the incident side surface of the optical system 1000. On the optical axis, the first surface S1 on the object side of the first lens 101 may have a convex shape, and the second surface S2 on the sensor side may have a concave shape. The first lens 101 may have a meniscus shape that is convex toward the object side on the optical axis. Differently, the first surface S1 may have a concave shape, and the second surface S2 may have a convex shape on the optical axis OA. The first lens 101 may have the thickest thickness among glass lenses, so that it may inhibit a decrease in rigidity due to external impact, and when the temperature changes to low or high temperature due to the glass material, it may suppress a change in optical performance. In addition, since a spherical surface is applied to the glass material, even if the thickness of the lens is designed to be thick, the change in the refractive index of light may not be large. Here, the thickness of the lens may be center thickness. The first lens 101 has a convex first surface S1 and a concave second surface S2 on the optical axis, so that the incident light may be refracted in a direction close to the optical axis, and the center distance between the first and second lenses 101 and 102 and the effective diameter of the second lens 102 may be reduced. Since the second lens 102 is arranged closest to the sensor side of the aperture stop ST, the second lens 102 may have the smallest effective diameter among the first to fourth lenses 101-104.

The aperture stop ST may be disposed around the sensor-side surface of the first lens 101. Alternatively, the aperture stop ST may be disposed around the object-side or sensor-side surface of the second lens 102, or around the object-side surface of the third lens 103. Since an aperture stop ST is disposed on the periphery between the first and second lenses 101 and 102, the center distance between the first and second lenses 101 and 102 may not be increased, and the effective diameter difference between the first and second lenses 101 and 102 may be reduced. The first lens 101 and the second lens 102 on both sides of the aperture stop ST may have powers with opposite signs.

The second lens 102 may be arranged between the first lens 101 and the third lens 103. The second lens 102 may have positive (+) or negative (−) power on the optical axis OA. The second lens 102 may have negative (−) power. The second lens 102 may include a plastic or glass material. For example, the second lens 102 may be provided with a glass material. The object-side third surface S3 of the second lens 102 on the optical axis OA may be convex, and the sensor-side fourth surface S4 may be concave. The second lens 102 may have a meniscus shape convex from the optical axis toward the object side. Alternatively, the third surface S3 may be concave, and the fourth surface S4 may be convex. Alternatively, the second lens 102 may have a concave shape on both sides. The second lens 102 may be provided with a spherical lens made of glass. The third surface S3 and the fourth surface S4 may be spherical.

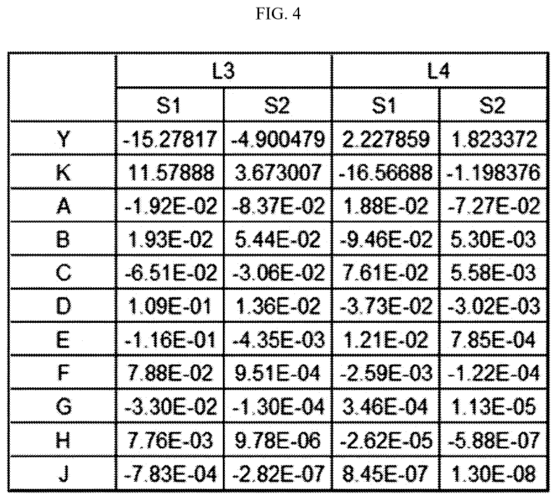

The third lens 103 may have positive (+) or negative (−) power on the optical axis OA. The third lens 103 may have positive (+) power. The third lens 103 may include a plastic or glass material. For example, the third lens 103 may be a plastic material. On the optical axis, the fifth surface S5 on the object side of the third lens 103 may have a concave shape, and the sixth surface S6 on the sensor side may have a convex shape. The third lens 103 may have a meniscus shape that is convex from the optical axis toward the sensor side. Alternatively, the third lens 103 may have a meniscus shape that is convex from the object side, or a shape that is concave on both sides from the optical axis. The third lens 103 includes a plastic material and may be defined as a first aspherical lens. The fifth surface S5 and the sixth surface S6 may be aspherical in the optical axis, and the aspherical coefficients may be provided as L3S1 and L3S2 of FIG. 4. At least one or both of the fifth surface S5 and the sixth surface S6 may be provided without a critical point from the optical axis OA to the end of the effective region. The center thickness of the third lens 103 may be the thickest among the lenses. The edge thickness of the third lens 103 may be the thickest among the lenses. Since the third lens 103 has the thickest thickness and has a convex meniscus shape toward the sensor on the optical axis, the effective diameter of the fourth lens 104 may be increased.

The fourth lens 104 may have positive (+) or negative (−) power on the optical axis OA. The fourth lens 104 may have negative power. The fourth lens 104 may include a plastic or glass material. For example, the fourth lens 104 may include a plastic material. The seventh surface S7 of the fourth lens 104 on the object side may be convex on the optical axis, and the eighth surface S8 on the sensor side may have a concave shape. The fourth lens 104 may have a meniscus shape convex toward the object side on the optical axis. Differently, the fourth lens 104 may have a meniscus shape convex toward the sensor side on the optical axis. The fourth lens 104 may be provided as an aspherical lens made of a plastic material. The seventh surface S7 and the eighth surface S8 may be aspherical on the optical axis, and the aspherical coefficients may be provided as L4S1 and L4S2 of FIG. 4.

The fourth lens 104 may be an aspherical lens that is closest to the image sensor 300. Since the aspherical lens is arranged closest to the image sensor 300, it is possible to inhibit a decrease in optical performance, improve aberration characteristics, and control the influence on resolution. In addition, since the aspherical lens is arranged closest to the image sensor 300, it may be insensitive to assembly tolerance compared to a spherical lens. In other words, being insensitive to assembly tolerance means that even if the assembly is slightly different from the design during assembly, it may not significantly affect the optical performance. Accordingly, the effective diameter of the fourth lens 104 may be increased, or the center thickness or edge thickness may be increased. In other words, the effective diameter of the fourth lens 104 may have the maximum effective diameter among the effective diameters of the lenses. The center thickness or edge thickness of the fourth lens 104 may be larger than the center thickness or edge thickness of the glass lenses.

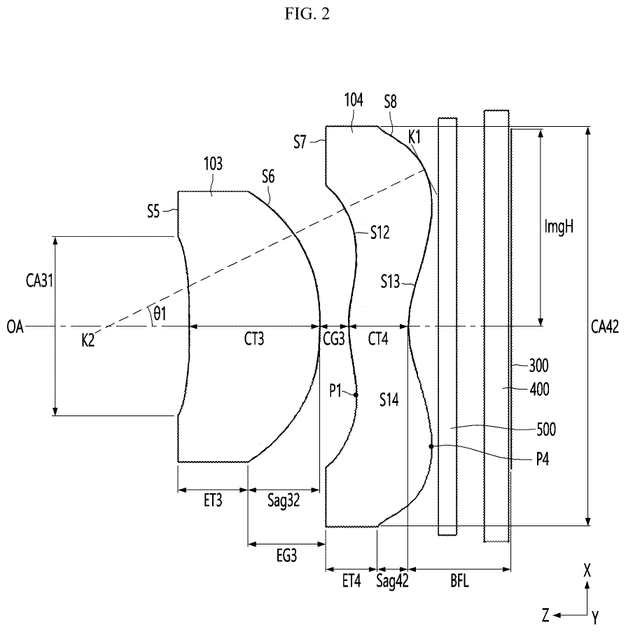

Referring to FIG. 2, at least one of the seventh surface S7 and the eighth surface S8 of the fourth lens 104 may have a critical point. The seventh surface S7 of the fourth lens 104 may have a first critical point P1 from the optical axis OA to the end of the effective region. The sensor-side eighth surface S8 of the fourth lens 104 may have a second critical point P2 from the optical axis OA to the end of the effective region. The critical point is a point where the trend of the Sag value changes. That is, it is a point where the Sag value increases and then decreases, or a point where the Sag value decreases and then increases. The first critical point P1 of the seventh surface S7 may be located at a distance of 1.6 mm or less, for example, between a point of 0.9 mm and a point of 1.6 mm, in a direction perpendicular to the optical axis based on the optical axis. Since the first critical point P1 is positioned closer to the optical axis than the second critical point P2, the light incident through the seventh surface S7 may be refracted to the periphery of the eighth surface S8. The second critical point P2 of the eighth surface S8 may be positioned at a distance of 1.8 mm or more in a direction perpendicular to the optical axis, for example, between a point of 1.8 mm and a point of 2.4 mm. For example, the Sag value on the seventh and eighth surfaces increases in a direction perpendicular to the optical axis up to the first and second critical points, and then decreases toward the edge after the first and second critical points. The eighth surface S8 of the fourth lens 114 can refract light to the periphery of the image sensor 300 by the second critical point P2.

The Sag value is the optical axis distance between the straight line perpendicular to the center of each lens surface and the lens surface, and the Sag value has a positive value at a position located closer to the sensor than the center of each lens surface, and a negative value at a position located closer to the object than the center of each lens surface. When expressed as an absolute value for the Sag value, the maximum value of Sag32 may be greater than the maximum values of Sag31, Sag41, and Sag42. Sag32 is the optical axis distance between the straight line perpendicular to the center of the sensor-side surface of the third lens 103 and the object-side surface of the third lens 103, Sag42 is the optical axis distance between the straight line perpendicular to the center of the sensor-side surface of the fourth lens 104 and the sensor-side surface, and Sag41 is the optical axis distance between the straight line perpendicular to the center of the object-side surface of the fourth lens 104 and the object-side surface.

The BFL (Back focal length) is the optical axis distance from the image sensor 300 to the center of the sensor-side surface of the last lens. A tangent line K1 passing through an arbitrary point of the eighth surface S8 of the fourth lens 104 and a normal line K2 perpendicular to the tangent line K1 may have a predetermined angle θ1 with the optical axis OA. The maximum tangent angle θ1 on the eighth surface S8 in the first direction X may be 25 degrees or more, for example, in the range of 25 to 60 degrees or in the range of 35 to 50 degrees, with respect to an axis parallel to the optical axis. The maximum tangent angle on the seventh surface S7 in the first direction X may be 25 degrees or more, for example, in the range of 25 to 60 degrees or in the range of 30 to 45 degrees, with respect to an axis parallel to the optical axis. In terms of the maximum tangential angle, the maximum tangential angle of the sensor-side sixth surface S6 of the third lens 103 may be the largest among the tangential angles of the lenses, and may be, for example, in the range of 40 to 65 degrees. Accordingly, light refracted from the third and fourth lenses 103 and 104 in the optical system 1000 having five or less lenses may be refracted to the entire region of the image sensor 300.

CT4 is a center thickness or optical axis thickness of the fourth lens 104, and ET4 is the edge thickness of the fourth lens 104. CT3 is the center thickness or optical axis thickness of the third lens 103, and ET3 is the edge thickness of the third lens 103. The edge thickness is the distance in the optical axis direction between the object-side surface and the sensor-side surface at the end of the effective region of each lens. CG3 is the optical axis distance (i.e., center distance) from the center of the sensor-side surface of the third lens 103 to the center of the object-side surface of the fourth lens 104. That is, CG3 is the distance from the center of the sixth surface S6 to the center of the seventh surface S7. EG3 is the distance in the optical axis direction (i.e., edge distance) from the edge of the sensor-side surface of the third lens 103 to the edge of the object-side surface of the fourth lens 104.

The optical system 1000 can guide light to the entire region of the image sensor through a small number of lens optical systems by making the effective diameter of at least one plastic lens having an aspherical surface larger than the effective diameter of a glass lens. The first lens 101 may be disposed on the object side of the aperture stop ST, and the second lens 102, the third lens 103, and the fourth lens 104 may be disposed on the sensor side of the aperture stop ST. Here, the effective diameters of the first lens 101 to the fourth lens 104 are defined as CA1, CA2, CA3, and CA4, and the effective diameters of the object-side surface and the sensor-side surface of the first lens 101 to the fourth lens 104 may be defined as CA11, CA12, CA21, CA22, CA31, CA32, and CA42. When the aperture stop ST is disposed on the sensor-side surface of the first lens 101, the following condition may be satisfied.

$$Condition 1 : CA 2 < CA 1 < CA 3 < CA 4$$

$$Condition 2 : ( CA 1 - CA 2 ) < ( CA 3 - CA 2 ) < ( CA 4 - CA 3 )$$

$$Condition 3 : CA 2 < CA 3 < ImgH < CA 4 < ( 2 * ImgH )$$

$$Condition 4 : CA 21 < CA 11 < CA 32 < CA 42$$

Since the second lens 102 disposed on the sensor side of the aperture stop ST has negative power (F2<0), the second lens 102 can refract the incident light in the direction of the optical axis, and since the third lens 103 has a convex meniscus shape toward the sensor side, it can refract the light in the direction of the edge of the lens. Accordingly, the yield by weight of the optical system may be inhibited from decreasing by the second and third lenses 102 and 103 and the production efficiency may be improved. Here, the composite focal length of the second to fourth lenses 102-104 arranged on the sensor side of the aperture stop ST may have a positive value, and can reduce the TTL within the field of view range.

The distance between the second lens 102 and the third lens 103 can gradually decrease from the center to the edge. This distance may gradually decrease from the optical axis to the edge due to the concave shape of the sensor-side surface of the second lens 102 and the concave shape of the object-side surface of the third lens 103.

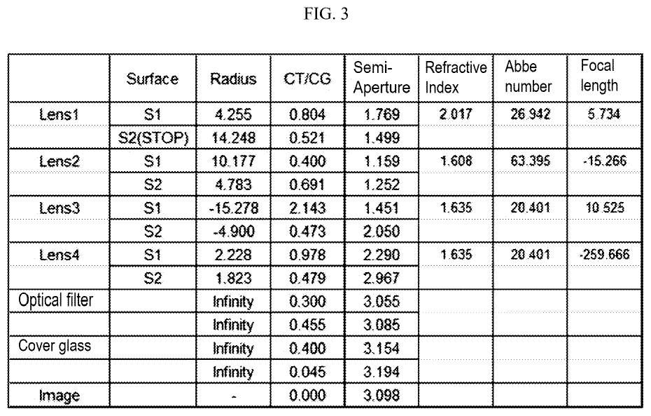

FIG. 3 is an example of lens data of the optical system of the embodiment of FIG. 1. As shown in FIG. 3, the radius of curvature of the first to fourth lenses 101-104 on the optical axis OA, the center thickness CT of the lenses, the center distance CG between adjacent lenses, the refractive index at the d-line, the Abbe number, and the size of the effective radius (e.g., semi-aperture) may be set. When the radius of curvature of each lens on the optical axis is expressed as an absolute value, the radius of curvature of each of the first to fourth lenses 101-104 on the optical axis OA may be 50 mm or less, for example, in the range of 1 mm to 50 mm or 1 mm to 30 mm. In addition, the difference in the radius of curvature of two adjacent lens surfaces may be less than 50 mm, for example, in the range of 0.1 mm to 30 mm or 0.1 mm to 20 mm. Accordingly, light may be guided without increasing the difference in the radius of curvature of the optical system 1000 having five or less lenses. For example, the difference in the curvature radii of the first and second surfaces S1 and S2 may be 15 mm or less, the difference in the curvature radii of the second and third surfaces S2 and S3 may be 6 mm or less, the difference in the curvature radii of the third and fourth surfaces S3 and S4 may be 12 mm or less, the difference in the curvature radii of the fourth and fifth surfaces S4 and S5 may be 15 mm or less, the difference in the curvature radii of the fifth and sixth surfaces S6, S6 may be 15 mm or less, the difference in the curvature radii of the sixth and seventh surfaces S6 and S7 may be 5 mm or less, and the difference in the curvature radii of the seventh and eighth surfaces S7 and S8 may be 3 mm or less.

When the curvature radii of each lens are expressed as absolute values, the curvature radii of the fifth surface S5 of the third lens 103 or the second surface S2 of the first lens 101 may be the largest among the lenses. Preferably, the radius of curvature of the fifth surface S5 of the third lens 103 may be maximum. The radius of curvature of the eighth surface S8 of the fourth lens 104 may be minimum among the lenses. The maximum radius of curvature may be 50 mm or less, for example, 30 mm or less, and may be less than 50 times, for example, 4 to 10 times, of the minimum radius of curvature. The radius of curvature of the fourth lens 104, which is an aspherical lens, may be smaller than the radius of curvature of the first and second lenses 101 and 102 made of glass. Here, the radius of curvature is an average of the absolute values of the radius of curvature of the object-side surface and the sensor-side surface of each lens.

When expressed as an absolute value, the radius of curvature of the first lens 101 arranged on the object side of the aperture stop ST on the optical axis may be larger than the radius of curvature of the second lens 102 arranged on the sensor side of the aperture stop ST. When expressed as an absolute value, the radius of curvature of the fourth lens 104 on the optical axis may be smaller than the radius of curvature of the third lens 103. When expressed as an absolute value, the difference in the radius of curvature between the object-side surface and the sensor-side surface of the third lens 103 may be greater than the difference in the radius of curvature between the object-side surface and the sensor-side surface of the fourth lens 104, and may be greater than the difference in the radius of curvature between the object-side surface and the sensor-side surface of the second lens 102.

When the third lens 103 is designed as an aspherical surface, it may satisfy thermal compensation and improve optical performance, but it may not be as easy to assemble as a spherical lens, and the aspherical third lens 103 may affect the optical characteristics of lenses disposed on the sensor side more than the third lens 103 due to the assemblability of the aspherical third lens 103. If the third lens is a spherical lens, even if the third lens is affected by the optical characteristics, the curvature radius of the third lens may not be significantly changed due to the spherical characteristics. The invention is designed so that the curvature radius of the third lens 103 having an aspherical surface is 30 m or less, the effective diameter is small, and the thickness is thick, so that assembly may be facilitated, and also, if the thickness is large in the optical axis, even if it is assembled with a slight tilt from the optical axis, the influence on the lenses on the sensor side may be minimal.

In addition, since the first lens 101 having a spherical surface is arranged on the object side of the aperture stop ST and is the lens most sensitive to the optical characteristics, the curvature radius of the first lens 101 is made larger than the curvature radius of the second lens, and the thickness of the first lens 101 is provided thicker than the thickness of the second lens 102. Here, a sensitive lens means a lens that has a large influence on the optical system even if the assembly is slightly misaligned. Therefore, since the lens placed on the object side of the aperture stop is the most sensitive to assembly, the curvature radius of the lenses adjacent to the aperture stop or the first lens sensitive to assembly is adjusted. Since the fourth lens 104 is provided as an aspherical surface, the curvature radius on the optical axis may be increased without greatly increasing the difference in the curvature radius between the object-side surface and the sensor-side surface, and the assembling performance may be improved by a large effective diameter and the influence on optical characteristics may be reduced.

The curvature radii of the first and second surfaces S1 and S2 of the first lens 101 are defined as L1R1 and L1R2, the curvature radii of the seventh and eighth surfaces S7 and S8 of the fourth lens 104 are defined as L4R1 and L4R2, and the curvature radii of each lens surface of the second and third lenses 102 and 103 may be defined as L2R1, L2R2, L3R1, and L3R2. The ratio of the curvature radii of the object-side surface and the sensor-side surface of each lens is as follows.

$$Condition 1 : 0 < L 1 R 1 / L 1 R 2 < 1 ,$$

$$Condition 2 : 1 < L 2 R 1 / L 2 R 2 < 5$$

$$Condition 3 : 1.5 < \vert L 3 R 1 / L 3 R 2 \vert < 6 ( wherein , L 3 R 1 , L 3 R 2 < 0 )$$

$$Condition 4 : 0.7 < \vert L 4 R 1 / L 4 R 2 \vert < 2 ,$$

$$Condition 5 : 3 mm \leq \vert L 3 R 1 \vert - \vert L 3 R 2 \vert \leq 30 mm$$

Preferably, Condition 5 satisfies: 3 mm≤|L3R1|−|L3R2|≤15 mm.

$$Condition 6 : 0.1 mm < ( L 4 R 1 - L 4 R 2 ) < 3 mm$$

If the difference between the object-side curvature radius and the sensor-side curvature radius of the third lens 103 is provided within the above range, the assembling performance of the third lens 103 having an aspherical surface may be improved and the optical influence by the third lens 103 may be reduced. In addition, if the absolute value of the curvature radius of the object-side surface of the i-th lens is LiR1 and the absolute value of the curvature radius of the sensor-side surface is LiR2, the value of Condition: LiR1/LiR2 (i=1˜4) may be minimum when i is 1 and maximum when i is 3. In addition, the difference in the curvature radius between the adjacent aspherical lens surface and the spherical lens surface may satisfy the following condition.

$$Condition 7 : 1 < \vert L 3 R 1 \vert / L 2 R 2 < 6$$

The difference in curvature radius between the spherical lens surface and the aspherical lens surface is set to 30 mm or less, for example, in the range of 3 mm to 15 mm, so that chromatic aberration due to the spherical lens surface may be corrected.

When the center thickness of the first to fourth lenses 101-104 is defined as CT1-CT4 and the edge thickness of the first to fourth lenses 101-104 is defined as ET1-ET4, the sum of the center thicknesses of the first to fourth lenses 101-104 may be defined as ΣCT, and the sum of the edge thicknesses of the first to fourth lenses 101-104 may be defined as ΣET.

In terms of the thicknesses of the lenses, the center thickness CT3 of the third lens 103 may be greater than the center thicknesses CT1, CT2, and CT4 of the first, second, and fourth lenses 101, 102, and 104, and preferably, may have the maximum thickness among the lenses. Since the center thickness CT3 of the third lens 103 is maximum and the radius of curvature of the sensor-side surface is provided as the largest, the light incident through the glass lens may be refracted to the end of the effective region of the last lens with the largest effective diameter. That is, in order to control the light path due to the difference in effective diameters of the third and fourth lenses 103 and 104 and the TTL of 10 mm or less, the third lens 103 may have a convex meniscus shape toward the sensor and the maximum center thickness.

The center thickness CT2 of the second lens 102 may have a minimum thickness within the lens portion 100. The average of the center thicknesses of the aspherical lenses may be provided to be thicker than the average of the center thicknesses of the spherical lenses, and accordingly, the light incident through the optical system 1000 of 5 or less may be guided to the entire region of the image sensor 300. The ratio of the center thickness and the edge thickness of each lens may satisfy the following conditions.

$$Condition 1 : 1 < CT 1 / ET 1 < 2 ,$$

$$Condition 2 : 0.5 < CT 2 / ET 2 < 1.5$$

$$Condition 3 : 1 < CT 3 / ET 3 < 2.5 ,$$

$$Condition 4 : 0.5 < CT 4 / ET 4 < 1.5$$

$$Condition 5 : 0.8 < \sum CT / \sum ET < 1.4 or 1 < \sum CT / \sum ET < 1.2$$

$$Condition 6 : 0.1 < CT 1 / \sum CT < 0.3 ,$$

$$Condition 7 : 0.3 < CT 3 / \sum CT < 0.7$$

In the conditions, when CTi/ETi (i=1˜4), it may be maximum when i is 3 and minimum when i is 4. The difference between the center thickness and the edge thickness of each lens may be set to be greater than 0.005 mm and less than 2 mm. This can effectively guide light without increasing the difference between the center thickness and the edge thickness of each lens by arranging the aspherical lens in the third and fourth lenses 103 and 104. In addition, by setting the center thickness and the edge thickness difference of the fourth lens 104 to the range of condition 4, the difference in the radius of curvature between the object-side surface and the sensor-side surface may be designed without being large, and the assemblability of the aspherical fourth lens 104 may be improved and the influence on the optical characteristics may be reduced.

In addition, the difference between the maximum center thickness and the minimum center thickness of the lenses may be 2 mm or less, for example, in the range of 0.5 mm to 2 mm or 1 mm to 2 mm. That is, even if the center thickness of the spherical lenses is provided thinly, the optical performance may not be degraded, and the thickness of the camera module may be provided slimly. In addition, since the difference between the center thickness and the edge thickness of each lens is not made large, even if at least one lens is tilted, the influence on the optical characteristics may be reduced. It can also reduce the influence on the thermal characteristics between the center and edge of the lenses. The maximum center thickness may be greater than the sum of the center thicknesses of two different lenses. For example, the conditions may satisfy: (CT1+CT2)<CT3, (CT1+CT4)<CT3, and (CT2+CT4)<CT3.

The center distance between the first to fourth lenses 101-104 may be defined as CG1-CG3, and the sum of the center distances between the first to fourth lenses 101-104 may be defined as ECG.

The center distance CG2 between the second lens 102 and the third lens 103 is the center distance between the spherical lens and the aspherical lens, and is the maximum within the lens portion 100, greater than the center distance between the spherical lenses, and greater than the center distance between the aspherical lenses. The center thickness of each lens and the center distance between adjacent lenses may satisfy the following conditions.

$$Condition 1 : 1 < CT 1 / CG 1 < 3 ,$$

$$Condition 2 : 0 < CT 2 / CG 2 < 1$$

$$Condition 3 : 2 < CT 3 / CG 3 < 7 ,$$

$$Condition 4 : 1 < CT 4 / CG 3 < 4$$

$$Condition 5 : ( CT 1 / CG 1 ) < ( CT 3 / CG 3 ) ,$$

$$Condition 6 : 0.1 < CG 3 / \sum CG < 0.7$$

$$Condition 7 : 2 < CT 3 / CG 2 < 5$$

The maximum center thickness between the lenses is more than twice the maximum center distance, for example, by providing a range of 2.1 to 4.5 times, a camera module applying an aspherical lens to the optical system may be provided without increasing the center distance compared to the center thickness of each lens. In Condition 3, since the aspherical third lens 103 is provided in a convex meniscus shape toward the sensor, the center distance between the third and fourth lenses 104 and 105 may be reduced. Here, if the i-th center distance between adjacent two lenses is defined as CGi, and the center thickness of the i-th lens positioned closer to the object than CGi is defined as CTi, the following condition may be satisfied. The ratio of CTi/CGi may be maximum when i is 3 and minimum when i is 2. The condition that the value of CTi/CGi is minimum when i is 2 may be implemented by the shapes of the spherical lenses and the aspherical lenses.

When the optical axis distance from the center of the object-side surface of the first lens 101 to the surface of the image sensor 300 is TTL, the following condition 1 may satisfy: 0<CT1/TTL<0.4 can be satisfied. Preferably, condition 1 may satisfy: 0.05≤CT1/TTL≤0.3. Since the first lens 101 is a spherical lens glass material, an optical system may be designed that may satisfy thermal compensation according to temperature change by the thickness of the first lens 101 satisfying condition 1. That is, condition 1 may be a feature that appears when the first lens 101 is designed as spherical glass.

0<CT2/TTL<0.2, Condition 2:

0.1<CT3/TTL<0.7 Condition 3:

0<CT4/TTL<0.4, Condition 4:

the ratio of CT1/TTL of condition 3 may be greater than the values of conditions 1, 2, and 4, and may be minimum when i is 2 in the ratio of CTi/TTL (i=1˜4).

In terms of the refractive index, the refractive index of the first lens 101 is the largest among the lenses, and preferably, the refractive index of the first lens 101 may be the largest and may be 1.7 or more. The difference in the refractive indices of the first and third lenses 101 and 103 is 0.20 or more. Since the first lens 101 is the glass lens closest to the object side and is arranged with the largest refractive index, at least one or more lenses among the lenses arranged on the sensor side of the first lens 101 may be made of a plastic material. Since the first lens 101 is arranged with a glass material having a high refractive index, it may be arranged to be thicker than the center thickness of the second lens 102 arranged on the sensor side of the aperture stop ST and thinner than the third lens 103. Since the first lens 101 is made of a glass material having a high refractive index, the amount of change in the lens, such as shrinkage and movement of the lens, is small as the ambient temperature changes from room temperature to low temperature/high temperature. Therefore, the resolution degradation is less than that of a plastic lens even when the temperature changes. The fact that the first lens, which is arranged at the very front of the optical system, is made of a glass material with a high refractive index affects reducing the amount of change in the resolution of the entire optical system as the ambient temperature changes from room temperature to low/high temperature. The first lens 101 is the glass lens closest to the object side, and by designing it with the highest refractive index, at least one or more lenses among the lenses arranged on the sensor side of the first lens 101 may be made of a plastic material, thereby inhibiting a degradation in resolution due to temperature changes. When the refractive index of the first lens 101 is made high, the center thickness of the first lens 101 may be provided thinly, thereby reducing the weight of the lens, increasing color dispersion, and increasing the light reflectivity of the lens facing the driver. The refractive index of the second lens 102 is the lowest among the lenses. The difference between the maximum refractive index and the minimum refractive index may be 0.25 or more. By adjusting the refractive index of the spherical lens and the aspherical lens, the incident light efficiency may be increased and the incident light may be guided to the image sensor 300.

In explaining the Abbe number, the Abbe number of the second lens 102 is the largest among the lenses and may be 55 or more. The Abbe number of at least one of the third and fourth lenses 103 and 104 is the smallest among the lenses. The difference between the maximum Abbe number and the minimum Abbe number may be 30 or more. By making the Abbe number of the object-side lens of the aperture stop ST small, making the Abbe number of the sensor-side lens large, and providing the Abbe number of the aspherical fourth lens 104 closest to the image sensor 300 small, the color dispersion of light traveling between the glass lenses may be controlled, and the color dispersion between the spherical lens and the aspherical lens may be increased to guide it to the image sensor 300.

The focal lengths F1 and F3 of the first and third lenses 101 and 103 may have positive power, and the focal lengths F2 and F4 of the second and fourth lenses 102 and 104 may have negative power. In addition, two lenses arranged adjacently may be arranged with opposite signs. Since the lenses repeatedly contract and expand as the temperature changes from low temperature to high temperature, the plastic lens can correct the chromatic aberration of the glass lens. When the focal length is expressed as an absolute value, the focal length of the fourth lens 104 is the maximum among the lenses and may be 100 mm or more. The focal length of the first lens 101 is the minimum among the lenses. The difference between the maximum focal length and the minimum focal length may be 100 mm or more. By increasing the difference in focal lengths of the third and fourth lenses 103 and 104, which are aspherical lenses, the optical system may have improved MTF characteristics, aberration control characteristics, resolution characteristics, etc. in the set field of view range, and may have good optical performance in the periphery of the field of view.

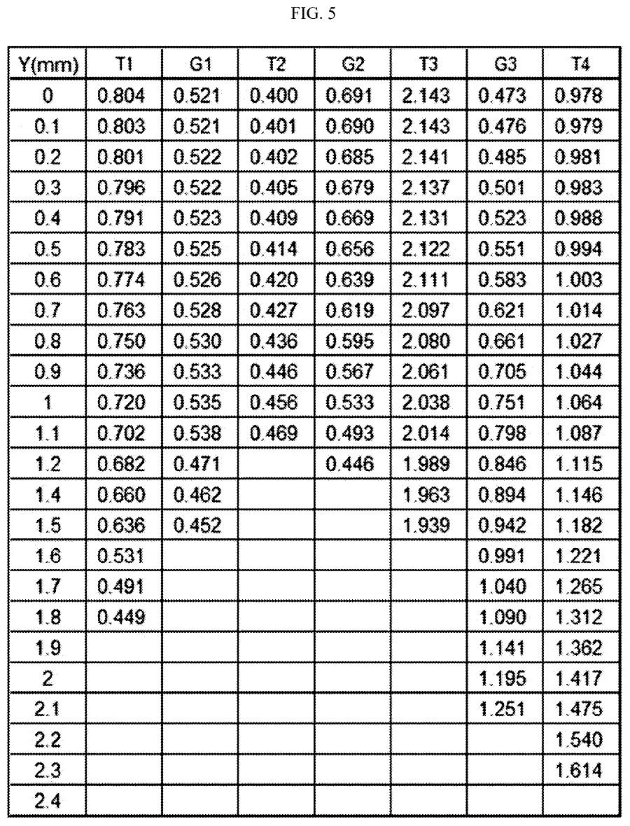

As shown in FIG. 4, among the lenses of the lens portion 100 in the first embodiment, the lens surfaces of the third and fourth lenses 103 and 104 may include aspherical surfaces having a 30th aspherical coefficient. For example, the third and fourth lenses 103 and 104 may include lens surfaces having a 30th aspherical coefficient. As described above, since the aspherical surface having a 30th aspherical coefficient (a value other than “0”) can significantly change the aspherical shape of the periphery, the optical performance of the periphery of the field of view (FOV) may be well corrected. As shown in FIG. 5, the thicknesses T1-T4 of the first to fourth lenses 101-104 and the distances G1-G3 between adjacent two lenses may be set. As shown in FIG. 5, the thickness T1-T4 of each lens in the Y-axis direction may be expressed at intervals of 0.1 mm or more from the optical axis, and each of the distances G1-G3 between the lenses may be expressed at intervals of 0.1 mm or more from the optical axis.

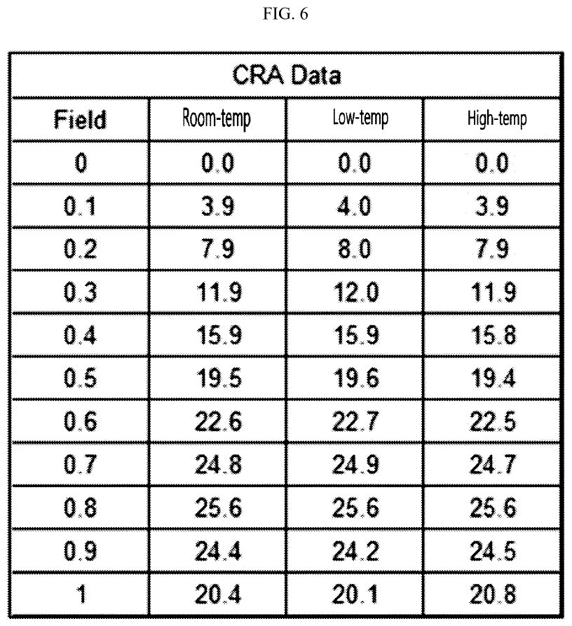

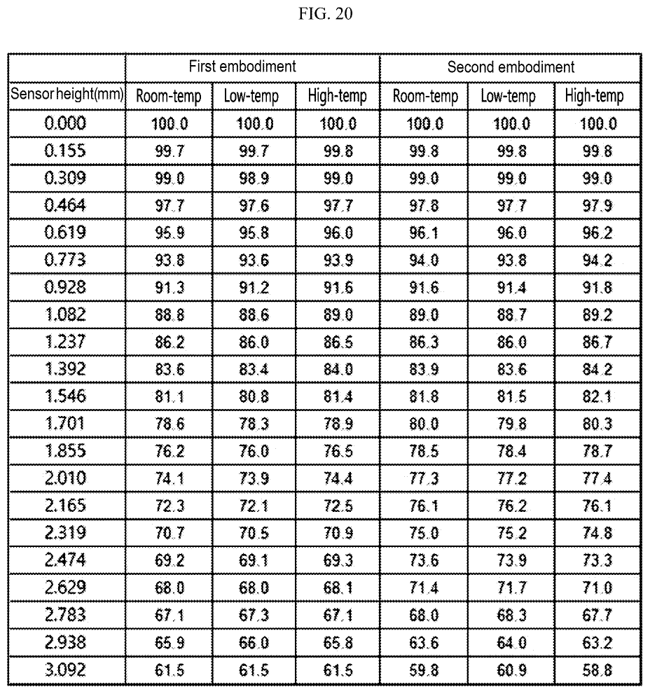

As shown in FIG. 6, in the optical system and camera module of FIG. 1, chief ray angle (CRA) is 10 degrees or more, for example, in the range of 10 degrees to 35 degrees or in the range of 10 degrees to 25 degrees, when the center field value of the image sensor is 0 and the diagonal end field of the image sensor is 1. As shown in FIG. 20, in the optical system according to the first embodiment, the table shows the relative illumination or the relative illumination from the center of the image sensor to the image height, that is, from 0 to 3.09 mm, and it may be seen that the relative illumination is 55% or more, for example, 55% or more, from the center of the image sensor to the diagonal end. That is, it may be seen that the difference in the relative illumination according to the low temperature, room temperature, and high temperature is almost no difference up to 3.09 mm from the optical axis.

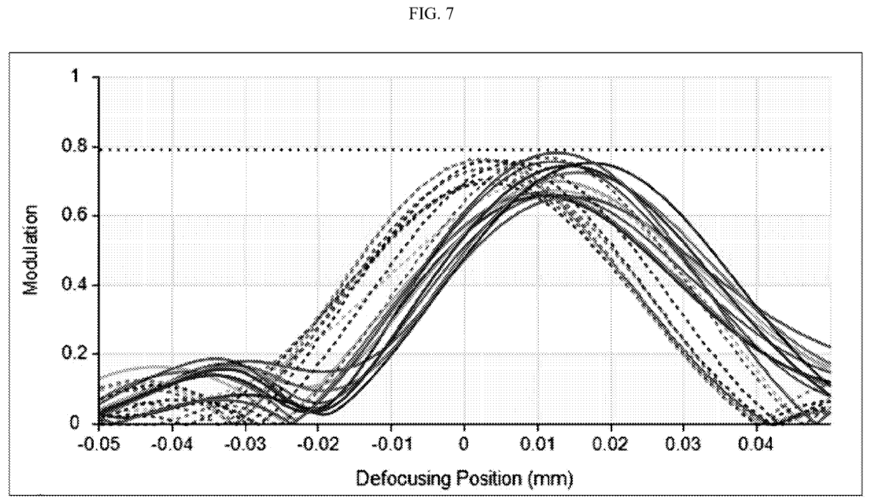

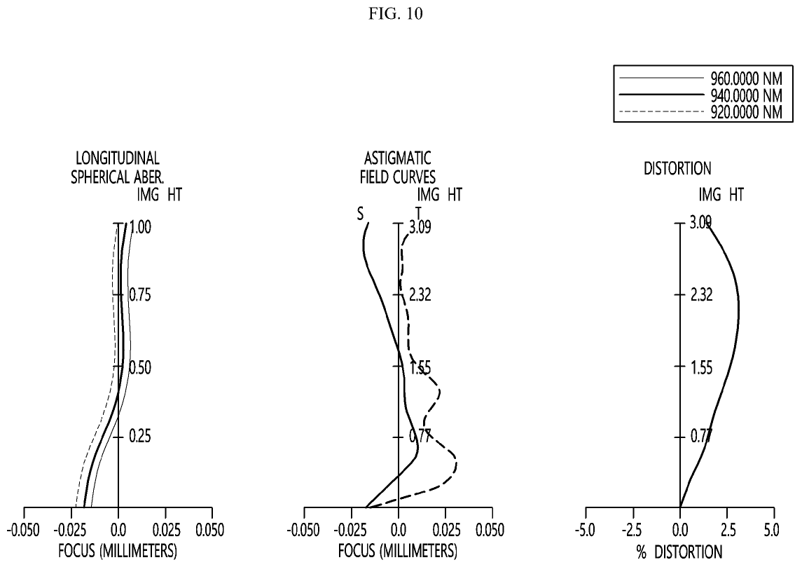

FIGS. 7 to 9 are graphs showing the diffraction MTF at room temperature, low temperature, and high temperature in the optical system of FIG. 1, and are graphs showing the modulation according to the spatial frequency. As shown in FIGS. 7 to 9, in the first embodiment of the invention, the deviation of the MTF between the low temperature and the high temperature based on the room temperature may be less than 10%, that is, 7% or less. In FIGS. 7 to 9, the x-axis represents the defocusing position, and the y-axis represents the MTF, and the graphs are measured in units of 0.309 mm from 0.000 mm to 3.092 mm from F1 to F11. FIGS. 10 to 12 are graphs showing aberration characteristics at room temperature, low temperature, and high temperature in the optical system of FIG. 1. The aberration graphs of FIGS. 10 to 12 are graphs measuring spherical aberration (Longitudinal spherical aberration), astigmatic field curves, and distortion from left to right. In FIGS. 10 to 12, the X-axis may represent the focal length (mm) and distortion (%), and the Y-axis may mean the height of the image. In addition, the graph for spherical aberration is a graph for light in wavelength bands of about 920 nm, about 940 nm, and about 960 nm, and the graph for astigmatism and distortion is a graph for light in wavelength bands of about 940 nm. In the aberration diagrams of FIGS. 10 to 12, it may be interpreted that the closer each curve at room temperature, low temperature, and high temperature is to the Y-axis, the better the aberration correction function is. It may be seen that the optical system 1000 according to the first embodiment has measurement values close to the Y-axis in almost all regions. That is, the optical system 1000 according to the first embodiment has improved resolution and may have good optical performance not only in the center of the FOV but also in the periphery. Here, the low temperature is −20 degrees or less, for example, in the range of −20 to −40 degrees, the room temperature is in the range of 22 degrees±5 degrees or in the range of 18 degrees to 27 degrees, and the high temperature may be in the range of 85 degrees or more, for example, in the range of 85 to 105 degrees. Accordingly, it may be seen that the reduction in the modulation of the brightness from the low temperature to the high temperature of FIGS. 10 to 12 is less than 10%, for example, less than 5%, or is almost unchanged.

When the center wavelength of the infrared wavelength is 940 nm±20 nm, and the distance from the first lens of the camera module to the subject is 600 mm as a standard, 400 mm<depth of field<1000 mm, when 800 mm is a standard, 500 mm<depth of field<1400 mm, and when 1100 mm is a standard, 700 mm<depth of field<2500 mm. The optical system of the first embodiment disclosed above can effectively control aberration characteristics such as chromatic aberration and distortion aberration, and may have good optical performance not only at the center of the FOV but also at the periphery.

The optical system and camera module according to the second embodiment of the invention will be described with reference to FIGS. 13 to 19. In describing the second embodiment, a different configuration from the first embodiment will be described, and the same configuration will be referred to the first embodiment.

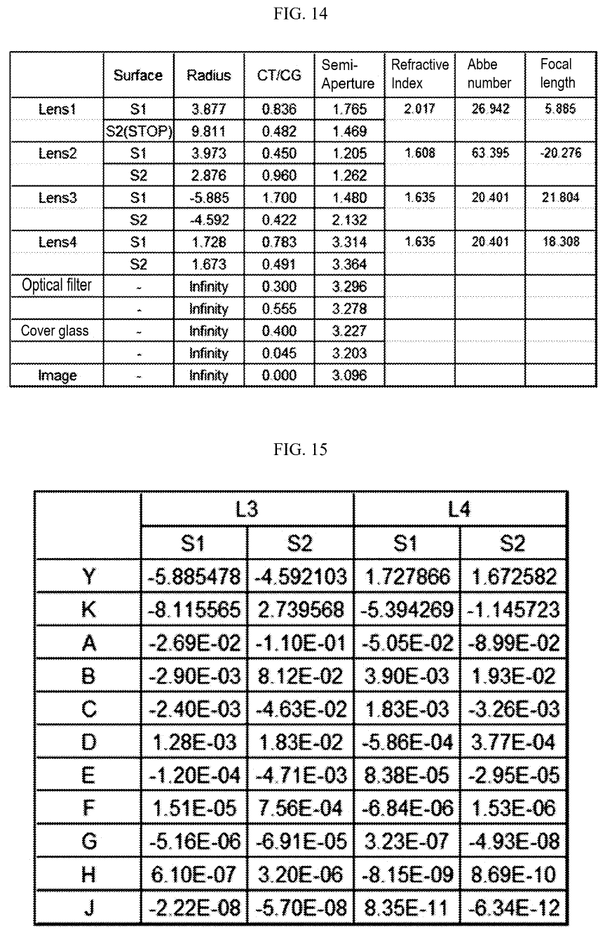

Referring to FIGS. 13 and 14, the optical system 1000 according to the second embodiment includes a lens portion 100A, and the lens portion 100A may include a first lens 111 to a fourth lens 114. The first lens 111 may be a first lens group LG1, and the second to fourth lenses 112, 113, and 114 may be a second lens group LG2.

The first lens 111 may have positive (+) power on the optical axis OA. The first lens 111 may be made of glass. The first surface S1 of the first lens 111 may have a convex shape on the optical axis, and the second surface S2 may have a concave shape. The second lens 112 may have negative (−) power on the optical axis OA. The second lens 112 may be made of glass. The third surface S3 of the second lens 112 may have a convex shape on the optical axis OA, and the fourth surface S4 may be concave. The first and second lenses 111 and 112 may be provided as spherical lenses made of glass.

The third lens 113 may have positive (+) or negative (−) power on the optical axis OA. The third lens 113 may have positive (+) power. The third lens 113 may be made of a plastic material. The fifth surface S5 of the third lens 113 on the optical axis may have a concave shape, and the sixth surface S6 on the sensor side may have a convex shape. The fifth surface S5 and the sixth surface S6 may be aspherical. The center thickness of the third lens 113 may be the thickest among the lenses. The edge thickness of the third lens 113 may be the thickest among the lenses. Since the third lens 113 has the thickest thickness and has a meniscus shape convex toward the sensor side on the optical axis, the effective diameter of the fourth lens 114 may be increased.

The fourth lens 114 may have negative power on the optical axis OA. The fourth lens 114 may include a plastic material. The seventh surface S7 of the fourth lens 114 may have a convex shape on the optical axis, and the eighth surface S8 may have a concave shape. The fourth lens 114 may be provided as an aspherical lens made of a plastic material. The seventh surface S7 and the eighth surface S8 may be aspherical on the optical axis.

The fourth lens 114 may be an aspherical lens that is closest to the image sensor 300. Since the aspherical lens is arranged closest to the image sensor 300, it is possible to inhibit deterioration of optical performance, improve aberration characteristics, and control the influence on resolution. In addition, by arranging the aspherical lens as the lens closest to the image sensor 300, it may be insensitive to the assembly tolerance compared to the spherical lens. In other words, being insensitive to the assembly tolerance means that even if it is assembled with a slight difference compared to the design during assembly, it may not significantly affect the optical performance. Accordingly, the effective diameter of the fourth lens 114 may be increased or the center thickness or edge thickness may be increased. In other words, the effective diameter of the fourth lens 114 may have the maximum effective diameter among the effective diameters of the lenses. The center thickness or edge thickness of the fourth lens 114 may be larger than the center thickness or edge thickness of the glass lenses.

The seventh surface S7 of the fourth lens 114 may have a first critical point P1 (See FIG. 2) from the optical axis OA to the end of the effective region. The sensor-side eighth surface S8 of the fourth lens 114 may have a second critical point P2 (See FIG. 2) from the optical axis OA to the end of the effective region. The first critical point P1 of the object-side seventh surface S7 may be located at a distance of 1.9 mm or less in a direction perpendicular to the optical axis, for example, between a point of 1.2 mm and a point of 1.9 mm. Since the first critical point P1 is disposed closer to the optical axis than the second critical point P2, light incident through the seventh surface S7 may be refracted to the periphery of the eighth surface S8. The second critical point P2 of the sensor-side eighth surface S8 may be located at a distance of 1.7 mm or more in a direction perpendicular to the optical axis, for example, between a point of 1.7 mm and a point of 2.3 mm. For example, on the seventh and eighth surfaces, the Sag value increases in a direction perpendicular to the optical axis to the first and second critical points, and then decreases toward the edge after the first and second critical points. The eighth surface S8 of the fourth lens 114 can refract light to the periphery of the image sensor 300 by the second critical point P2. When expressed as an absolute value for the Sag value, the maximum value of Sag32 may be greater than the maximum values of Sag31, Sag41, and Sag42. Sag32 is the optical axis distance between the object-side surface of the third lens 113 and the straight line perpendicular to the center of the sensor-side surface of the third lens 113, Sag42 is the optical axis distance between the sensor-side surface of the fourth lens 114 and the straight line perpendicular to the center of the sensor-side surface, and Sag41 is the optical axis distance between the object-side surface of the fourth lens 114 and the straight line perpendicular to the center of the object-side surface.

A tangent line K1 (See FIG. 2) passing through an arbitrary point of the eighth surface S8 of the fourth lens 114 and a normal line K2 (See FIG. 2) perpendicular to the tangent line K1 may have a predetermined angle θ1 (See FIG. 2) with the optical axis OA. The maximum tangential angle θ1 on the eighth surface S8 of the first direction X may be 25 degrees or more, for example, in the range of 25 to 60 degrees or in the range of 25 to 45 degrees, based on an axis parallel to the optical axis. The maximum tangential angle on the thirteenth surface S13 of the first direction X may be 35 degrees or less, for example, in the range of 5 to 35 degrees or in the range of 7 to 27 degrees, based on an axis parallel to the optical axis. Indicating the maximum tangential angle, the maximum tangential angle of the sensor-side sixth surface S6 of the third lens 113 may be the largest among the tangential angles of the lenses, and may be in the range of 33 to 65 degrees, for example. Accordingly, light refracted from the third and fourth lenses 113 and 114 in the optical system 1000 having five or less lenses may be refracted to the entire region of the image sensor 300.

The optical system 1000 can guide light to the entire region of the image sensor through a small number of lens optical systems by making the effective diameter of at least one plastic lens having an aspherical surface larger than the effective diameter of the glass lens. The aperture stop ST may be disposed around the sensor-side of the first lens 111. The first lens 111 may be arranged on the object side of the aperture stop, and the second lens 112, the third lens 113, and the fourth lens 114 may be arranged on the sensor side of the aperture stop ST, and the following conditions may be satisfied.

$$Condition 1 : CA 2 > CA 1 < CA 3 < CA 4 ,$$

$$Condition 2 : ( CA 1 - CA 2 ) < ( CA 3 - CA 2 ) < ( CA 4 - CA 3 )$$

$$Condition 3 : CA 2 < CA 3 < ImgH < ( 2 * ImgH ) < Ca 4 ,$$

$$Condition 4 : CA 21 < CA 11 < CA 32 < CA 42$$

Since the second lens 112 disposed on the sensor side of the aperture stop ST has negative power (F2<0), the second lens 112 can refract the incident light in the direction of the optical axis, and since the third lens 113 has a convex meniscus shape toward the sensor side, it can refract the light in the direction of the edge of the lens. Accordingly, the yield by weight of the optical system may be inhibited from decreasing by the second and third lenses 112 and 113 and the production efficiency may be improved. Here, the composite focal length of the second to fourth lenses 112-114 disposed on the sensor side of the aperture stop ST may have a positive value, and may reduce the TTL within the field of view range. The distance between the second lens 112 and the third lens 113 may gradually decrease from the center to the edge. This distance may gradually decrease from the optical axis to the edge due to the concave shape of the sensor-side surface of the second lens 112 and the concave shape of the object-side surface of the third lens 113.

FIG. 14 is an example of lens data of the optical system of the embodiment of FIG. 13. As shown in FIG. 14, the radius of curvature of the optical axis OA of the first to fourth lenses 111-114, the center thickness CT of the lenses, the center distance CG between adjacent lenses, the refractive index at the d-line, the Abbe number, and the size of the effective radius (e.g., semi-aperture) may be set. When the radius of curvature of each lens in the optical axis is expressed as an absolute value, the radius of curvature of each of the first to fourth lenses 111-114 on the optical axis OA may be 30 mm or less, for example, in the range of 1 mm to 30 mm or 1 mm to 25 mm. In addition, the difference in the radius of curvature of adjacent two lens surfaces may be less than 30 mm, for example, in the range of 0.1 mm to 25 mm or 0.1 mm to 10 mm. Accordingly, light may be guided without increasing the difference in the radius of curvature of the optical system 1000 having 5 or fewer lenses. For example, the difference in the curvature radii of the first and second surfaces S1 and S2 may be 10 mm or less, the difference in the curvature radii of the second and third surfaces S2 and S3 may be 10 mm or less, the difference in the curvature radii of the third and fourth surfaces S3 and S4 may be 5 mm or less, the difference in the curvature radii of the fourth and fifth surfaces S4 and S5 may be 5 mm or less, the difference in the curvature radii of the fifth and sixth surfaces S5 and S6 may be 5 mm or less, the difference in the curvature radii of the sixth and seventh surfaces S6 and S7 may be 7 mm or less, and the difference in the curvature radii of the seventh and eighth surfaces S7 and S8 may be 3 mm or less.

When the curvature radii of each lens are expressed as absolute values on the optical axis, the curvature radii of the fifth surface S5 of the third lens 113 or the second surface S2 of the first lens 111 may be the largest among the lenses. Preferably, the radius of curvature of the second surface S2 of the first lens 111 may be maximum. The radius of curvature of the eighth surface S8 of the fourth lens 114 may be minimum among the lenses. The maximum radius of curvature may be 30 mm or less, for example, 25 mm or less, and may be less than 20 times, for example, in a range of 2 to 10 times, of the minimum radius of curvature. The radius of curvature of the fourth lens 114, which is an aspherical lens, may be smaller than the radii of curvature of the first and second lenses 111 and 112 made of glass. Here, the radius of curvature is an average of the absolute values of the radii of curvature of the object-side surface and the sensor-side surface of each lens.

When expressed as an absolute value, the radius of curvature of the first lens 111 disposed on the object side of the aperture stop ST on the optical axis may be greater than the radius of curvature of the second lens 112 disposed on the sensor side of the aperture stop ST. When expressed as an absolute value, the radius of curvature of the fourth lens 114 in the optical axis may be smaller than the radius of curvature of the third lens 113. When expressed as an absolute value, the difference in the radius of curvature between the object-side surface and the sensor-side surface of the third lens 113 may be greater than the difference in the radius of curvature between the object-side surface and the sensor-side surface of the fourth lens 114, and may be smaller than the difference in the radius of curvature between the object-side surface and the sensor-side surface of the first lens 112.

The radius of curvature of the third lens 113 having an aspherical surface is 25 m or less, and the effective diameter may be designed to be small and thick, and the radius of curvature of the first lens 111 having a spherical surface may be designed to be large. In addition, since the third and fourth lenses 113 and 114 are provided as aspherical surfaces, the radius of curvature in the optical axis may be increased without increasing the radius of curvature, and the difference in the radius of curvature between the object-side surface and the sensor-side surface may be made small. Also, the assembly may be improved by the large effective diameter, and the influence on the optical characteristics may be reduced.

The ratio of the radius of curvature of the object-side surface and the sensor-side surface of each lens is as follows.

$$Condition 1 : 0 < L 1 R 1 / L 1 R 2 < 1 ,$$

$$Condition 2 : 1 < L 2 R 1 / L 2 R 2 < 3$$

$$Condition 3 : 1 < \vert L 3 R 1 / L 3 R 2 \vert < 2 ( but , L 3 R 1 , L 3 R 2 < 0 )$$

$$Condition 4 : 0.5 < \vert L 4 R 1 / L 4 R 2 \vert < 2 ,$$

$$Condition 5 : 2 mm < ( L 1 R 2 - L 1 R 1 ) \leq 10 mm$$

Preferably, Condition 5 satisfies: 4 mm≤(L1R2−L1R1)≤8 mm.

$$Condition 6 : 1 mm < ( L 3 R 1 - \vert L 3 R 2 \vert ) < 4 mm$$

When the difference between the object-side curvature radius and the sensor-side curvature radius of the third lens 113 is provided within the above range, the assembling performance of the third lens 113 having an aspherical surface may be improved and the optical influence caused by the third lens 113 may be reduced. Also, if the absolute value of the curvature radius of the object-side surface of the i-th lens is LiR1 and the absolute value of the curvature radius of the sensor-side surface is LiR2, the value of LiR1/LiR2 (i=1˜4) may be minimum when i is 1 and maximum when i is 2.

Also, the difference in the curvature radius between the adjacent aspherical lens surface and the spherical lens surface may satisfy the following condition 7:1<|L3R1|/L2R2<4. The maximum difference in the curvature radius between the spherical lens surface and the aspherical lens surface is set to 30 mm or less, for example, in the range of 3 mm to 15 mm, so that the chromatic aberration caused by the spherical lens surface may be corrected.

When explaining the thickness of the lenses, the center thickness CT3 of the third lens 113 may be greater than the center thicknesses CT1, CT2, and CT4 of the first, second, and fourth lenses 111, 112, and 114, and may have a maximum thickness within the lens portion 100A. The center thickness CT2 of the second lens 112 may have a minimum thickness within the lens portion 100A. The average of the center thicknesses of the aspherical lenses may be provided to be thicker than the average of the center thicknesses of the spherical lenses, and accordingly, light incident through the optical system 1000 having 5 or fewer lenses may be guided to the entire region of the image sensor 300. The ratio of the center thickness and the edge thickness of each lens may satisfy the following conditions.

$$Condition 1 : 1 < CT 1 / ET 1 < 3 ,$$

$$Condition 2 : 0.5 < CT 2 / ET 2 < 1.5$$

$$Condition 3 : 1 < CT 3 / ET 3 < 3 ,$$

$$Condition 4 : 0.5 < CT 4 / ET 4 < 2.5$$

$$Condition 5 : 1 < \sum CT / \sum ET < 2 or 1 < \sum CT / \sum ET < 1.6$$

$$Condition 6 : 0.1 < CT 1 / \sum CT < 0.3 ,$$

$$Condition 7 : 0.3 < CT 3 / \sum CT < 0.7$$

In the conditions, when CTi/ETi (i=1˜4), it may be maximum when i is 3 and minimum when i is 2. The difference between the center thickness and the edge thickness of each lens may be set to be more than 0.005 mm and less than 2 mm. This can effectively guide light without increasing the difference between the center thickness and the edge thickness of each lens by arranging the aspherical lens in the third and fourth lenses 113 and 114. In addition, by setting the center thickness and the edge thickness difference of the fourth lens 114 to the range of condition 4, the difference in the radius of curvature between the object-side surface and the sensor-side surface may be designed without being large, and the assemblability of the aspherical fourth lens 114 may be improved and the influence on the optical characteristics may be reduced.

In addition, the difference between the maximum center thickness and the minimum center thickness of the lenses may be 2 mm or less, for example, in the range of 0.5 mm to 2 mm or 1 mm to 2 mm. That is, even if the center thickness of the spherical lenses is provided thinly, the optical performance may not be degraded, and the thickness of the camera module may be provided slimly. In addition, since the difference between the center thickness and the edge thickness of each lens is not made large, even if at least one lens is tilted, the influence on the optical characteristics may be reduced. It can also reduce the influence on the thermal characteristics between the center and edge of the lenses. Also, the maximum center thickness of the lenses may be greater than the sum of the center thicknesses of two different lenses. For example, the following conditions may satisfy: (CT1+CT2)<CT3, (CT1+CT4)<CT3, and (CT2+CT4)<CT3.

The center distance CG2 between the second lens 112 and the third lens 113 is the center distance between the spherical lens and the aspherical lens, is the maximum within the lens portion 100A, is greater than the center distance between the spherical lenses, and is greater than the center distance between the aspherical lenses. The center thickness of each lens and the center distance between adjacent lenses may satisfy the following conditions.

$$Condition 1 : 1 < CT 1 / CG 1 < 3 ,$$

$$Condition 2 : 0 < CT 2 / CG 2 < 1$$

$$Condition 3 : 2 < CT 3 / CG 3 < 7 ,$$

$$Condition 4 : 1 < CT 4 / CG 3 < 4$$

$$Condition 5 : ( CT 1 / CG 1 ) < ( CT 3 / CG 3 ) ,$$

$$Condition 6 : 0.1 < CG 3 / \sum CG < 0.7$$

$$Condition 7 : 1 < CT 3 / CG 2 < 4$$

The maximum center thickness between the lenses is more than twice the maximum center distance, for example, by providing a range of 2.1 to 3.5 times, a camera module applying an aspherical lens to the optical system may be provided without increasing the center distance compared to the center thickness of each lens. In condition 3, since the aspherical third lens 113 is provided in a convex meniscus shape toward the sensor, the center distance between the third and fourth lenses 113 and 114 may be reduced. Here, if the i-th center distance between two adjacent lenses is defined as CGi, and the center thickness of the i-th lens positioned closer to the object than CGi is defined as CTi, the following conditions may be satisfied. The ratio of CTi/CGi may be maximum when i is 3, and minimum when i is 2. The condition that the value of CTi/CGi is minimum when i is 2 may be implemented by the shapes of the spherical lens and the aspherical lens.

The relationship between the center thickness of each lens and the TTL may satisfy the following conditions.

$$Condition 1 : 0 < CT 1 / TTL < 0.4 ,$$

$$Condition 2 : 0 < CT 2 / TTL < 0.2$$

$$Condition 3 : 0.1 < CT 3 / TTL < 0.7 ,$$

$$Condition 4 : 0 < CT 4 / TTL < 0.4$$

The ratio of CT1/TTL in the condition 3 may be greater than the values in conditions 1, 2, and 4, and may be minimum when i is 2 in the ratio of CTi/TTL (i=1˜4).

In terms of the refractive index, the refractive index of the first lens 111 may be the maximum among the lenses, and preferably, the refractive index of the first lens 111 may be the maximum and may be 1.7 or more. The difference in refractive index between the first and third lenses 111 and 113 may be 0.20 or more. The refractive index of the second lens 112 may be the minimum among the lenses. The difference between the maximum refractive index and the minimum refractive index may be 0.25 or more. By controlling the refractive index of the spherical lens and the aspherical lens, the incident efficiency may be increased, and the incident light may be guided to the image sensor 300.

In terms of the Abbe number, the Abbe number of the second lens 112 is the largest among the lenses, and may be 55 or more. The Abbe number of at least one of the third and fourth lenses 113 and 114 is the smallest among the lenses. The difference between the maximum Abbe number and the minimum Abbe number may be 30 or more. By reducing the Abbe number of the object-side lens of the aperture stop ST, increasing the Abbe number of the sensor-side lens, and providing a small Abbe number of the aspherical fourth lens 114 closest to the image sensor 300, the color dispersion of the light traveling between the glass lenses may be controlled, and the color dispersion between the spherical lens and the aspherical lens may be increased to guide it to the image sensor 300.

The focal lengths F1 and F3 of the first and third lenses 111 and 113 may have positive power, and the focal lengths F2 and F4 of the second and fourth lenses 112 and 114 may have negative power. In addition, two lenses arranged adjacently may be arranged with opposite signs. Since the lenses repeatedly contract and expand as the temperature changes from low temperature to high temperature, the plastic lens can correct the chromatic aberration of the glass lens. When the focal length is expressed as an absolute value, the focal length of the third lens 113 is the largest among the lenses and may be greater than 18. The focal length of the first lens 111 is the smallest among the lenses. The difference between the maximum focal length and the minimum focal length may be 15 or more. By increasing the difference in focal lengths of the first and second lenses 111 and 112, which are aspherical lenses, the optical system may have improved MTF characteristics, aberration control characteristics, resolution characteristics, etc. in the set field of view range, and may have good optical performance in the periphery of the field of view.

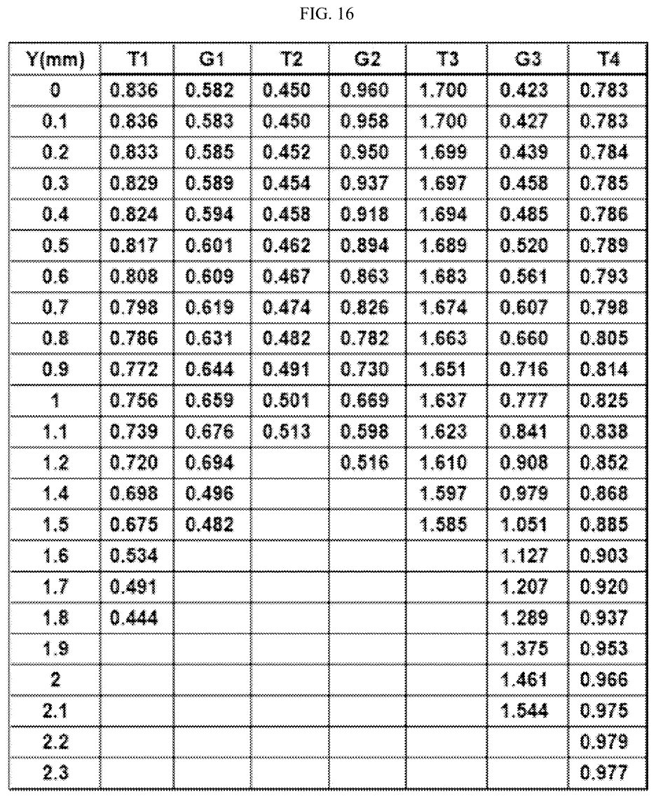

As shown in FIG. 15, among the lenses of the lens portion 100A in the embodiment, the aspherical coefficients of the lens surfaces S5-S8 of the third and fourth lenses 113 and 114 may be provided as L3S1, L3S2, L4S1, and L4S2 of FIG. 15, and may include an aspherical surface having a 30th aspherical coefficient. For example, the third and fourth lenses 113 and 114 may include a lens surface having a 30th aspherical coefficient. As shown in FIG. 16, the thickness T1-T4 of the first to fourth lenses 111-114 and the distance G1-G3 between adjacent two lenses may be set. As shown in FIG. 5, the thickness T1-T4 of each lens in the Y-axis direction may be expressed at intervals of 0.1 mm or more from the optical axis, and the distance G1-G3 between each lens may be expressed at intervals of 0.1 mm or more from the optical axis.

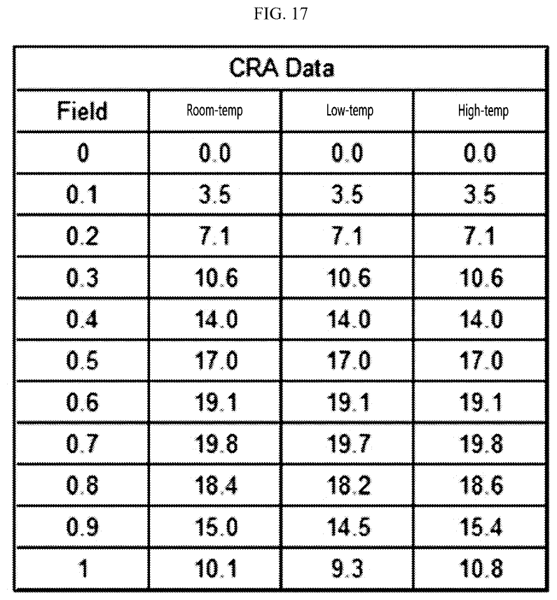

As shown in FIG. 17, in the optical system and camera module of FIG. 13, CRA (Chief ray angle) is 10 degrees or more at the end of the image sensor when the center field value of the image sensor is 0 and the diagonal end field of the image sensor is 1, for example, a range of 10 degrees to 35 degrees or a range of 10 degrees to 25 degrees. As shown in FIG. 20, in the optical system according to the second embodiment, the table shows the ambient light ratio or ambient illuminance from the center of the image sensor to the image height, that is, from 0 to 3.09 mm, and it may be seen that the ambient light ratio from the center of the image sensor to the diagonal end is 55% or more, for example, 55% or more. That is, it may be seen that the difference in ambient illuminance according to low temperature, room temperature, and high temperature is almost the same up to 3.09 mm from the optical axis.

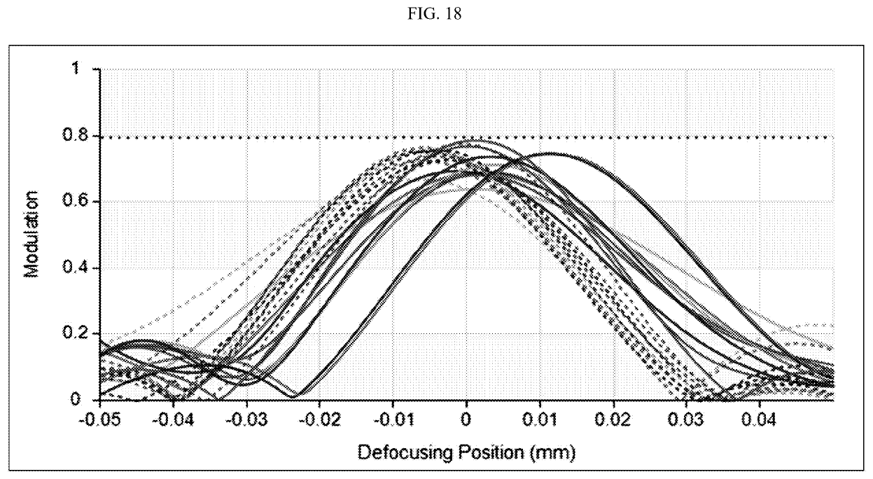

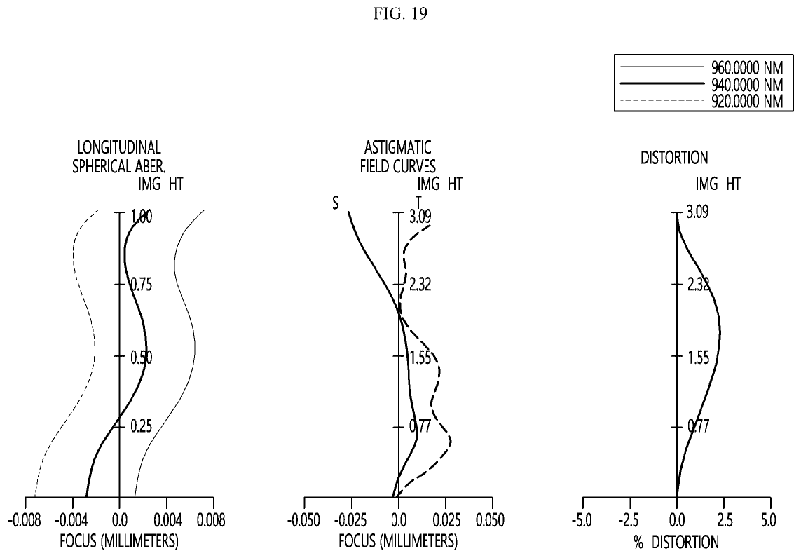

FIG. 18 is a graph showing the diffraction MTF at room temperature in the optical system of FIG. 13, and is a graph showing the modulation according to the spatial frequency. As shown in FIG. 18, in the second embodiment of the invention, the deviation of the MTF between the low temperature and the high temperature based on the room temperature may be less than 10%, that is, 7% or less. In FIG. 18, the x-axis represents the defocusing position, and the y-axis represents the MTF, and the graphs are measured from 0.000 mm to 3.092 mm in units of 0.309 mm from F1 to F11. FIG. 19 is a graph showing the aberration characteristics at room temperature in the optical system of FIG. 13. The aberration graph of FIG. 19 is a graph measuring spherical aberration (Longitudinal spherical aberration), astigmatic field curves, and distortion from left to right. In FIG. 19, the X-axis can represent the focal length (mm) and distortion (%), and the Y-axis can mean the height of the image. In addition, the graph for spherical aberration is a graph for light in the wavelength bands of about 920 nm, about 940 nm, and about 960 nm, and the graph for astigmatism and distortion is a graph for light in the wavelength band of about 940 nm. In the aberration diagram of FIG. 19, the closer each curve at room temperature is to the Y-axis, the better the aberration correction function may be interpreted, and it may be seen that the optical system 1000 according to the second embodiment has measurement values close to the Y-axis in almost all areas. That is, the optical system 1000 according to the second embodiment has improved resolution and may have good optical performance not only in the center of the FOV but also in the periphery.

The optical system 1000 according to the first and second embodiments may satisfy at least one or two or more of the mathematical equations described below. Accordingly, the optical system 1000 according to the embodiment has improved optical characteristics, can effectively control aberration characteristics such as chromatic aberration and distortion aberration, and may have good optical performance in the center and periphery of the FOV. In addition, the optical system 1000 may have improved resolution. In addition, the thickness of the lens on the optical axis OA and the spacing of adjacent lenses on the optical axis OA described in the Equations can refer to the above-described embodiments.

$$1 < CT 1 / CT 2 < 5 \qquad [ Equation 1 ]$$

Equation 1 may improve the chromatic aberration of the optical system by setting the center thickness difference of the first and second lenses to be large. Preferably, 1.4<CT1/CT2<2.2 may be satisfied. The center thickness of the first and second lenses 101 and 102 having a spherical surface may be set, so that the optical performance in the center and periphery of the FOV may be improved.

$$( CT 4 * CA 4 ) < ( CT 3 * CA 3 ) \qquad [ Equation 2 ]$$

CA1 is the effective diameter of the first lens 101 and 111, and CA3 is the effective diameter of the third lens. The effective diameter is the average of the effective diameters of the object-side surface and the sensor-side surface of each lens. Preferably, the following condition may satisfy: CA3<CA4. By setting the thickness and effective diameter of the third and fourth lenses, the optical system can improve spherical aberration.

$$Po 1 > 0 \qquad [ Equation 3 ]$$

In Equation 3, Po1 means the power of the first lens 101 and 111, and may be set to have an effective focal length F similar to TTL in the optical system for the performance of the optical system. Accordingly, TTL<F may be satisfied, and for example, the following condition may satisfy: 0.5<TTL/F<1.

$$1.7 \leq Nd 1 < 2.2 \qquad [ Equation 4 ]$$

Nd1 is the refractive index at the d-line of the first lens 101 and 111. Equation 4 sets the refractive index of the first lens high, so that it can control the factor affecting the reduction of the third-order aberration (Seidel aberration) of the optical system, and can reduce the aberration that may occur when the TTL is somewhat longer. Equation 4 preferably satisfies: 1.8≤Nd3≤2.1. If it is designed to be lower than the lower limit of Equation 4, the aberration may be reduced to obtain performance, and the power of the first lens 101 is weakened, so that light cannot be collected efficiently, which may deteriorate the performance of the optical system. If it is designed to be higher than the upper limit of Equation 4, there is a disadvantage that it is difficult to obtain materials. In addition, if the refractive index of the third lens is designed to be lower than the lower limit of Equation 4, the radius of curvature of the second lens must be increased in order to increase the power of the second lens, in which case lens manufacturing becomes more difficult, the lens failure rate increases, and the yield may decrease.

$$1.65 \leq A v e r ( Nd 1 : Nd 4 ) \leq 1.75 \qquad [ Equation 4 - 1 ]$$

In Equation 4-1, Aver(Nd1:Nd4) is the average of the refractive index values of the d-line of the first to fourth lenses. If the optical system 1000 according to the embodiment satisfies Equation 4-1, the optical system may set the resolution and suppress the influence on the TTL.

$$40 < FOV\_H < 60 \qquad [ Equation 5 ]$$

In Equation 5, FOV_H represents the horizontal field of view and may set the range of the vehicle optical system. A horizontal field of view may be set in an optical system having at least one glass lens and at least one plastic lens and having 5 or less lenses. Equation 5 preferably satisfies: 45≤FOV_H≤55, or a range of 50 degrees±3 degrees, and at this time, the sensor length in the horizontal direction may be based on 4.80 mm±0.5 mm. In addition, when Equation 5 is satisfied, when the temperature changes from room temperature to high temperature, the change rate of the effective focal length and the change rate of the field of view may be set to 5% or less, for example, 0 to 5%. In addition, even when an aspherical lens and a spherical lens are mixed and used in the optical system 1000, the deterioration of the optical characteristics may be inhibited through temperature compensation of the glass lens.

$$L 1 R 1 > 0 \qquad [ Equation 6 ]$$

L1R1 means the radius of curvature of the first surface S1 of the first lens 101 and 111 and may be set to be greater than 0. If this Equation 6 is satisfied, the shape of the optical system may be restricted. The object-side surface of the first lens 101 and 111 has a convex shape from the optical axis toward the driver, and can increase the amount of incident light. In addition, since the following condition satisfies: L1R1*L1R2>0, the incident light may be refracted in a direction closer to the optical axis. Accordingly, the embodiment can reduce the center distance between the first and second lenses, or provide the effective diameter of the second lens to be smaller than that of the first lens.

$$L 3 R 1 < 0 and L 3 R 1 < 0 \qquad [ Equation 6 - 1 ]$$

Since the first and second lenses have a meniscus shape convex toward the object side, and the third lens has a meniscus shape convex toward the sensor side, the incident light may be refracted into the effective region of the fourth lens with the largest effective diameter. Since the first lens has a meniscus shape convex toward the object side, the effective diameters of the lenses may be designed to gradually increase from the aperture stop position toward the sensor, and the number of lenses may be reduced. In addition, since the following conditions satisfy: L1R2>L1R1 and |L3R1|>|L3R2|, the effective diameter of the second lens may be designed to be minimal, and the TTL may be reduced. If the following condition satisfies: |L3R1|<|L3R2|, there is a problem that the TTL increases. By setting the radius of curvature of the third and fourth lenses to be large, the influence of the optical characteristics on the incident light may be reduced.

$$1 < BFL / L 4 S 2 \_max \_sag to Sensor < 6 \qquad [ Equation 7 ]$$

BFL is the optical axis distance from the center of the sensor-side surface of the last lens, i.e., the fourth lens, to the surface of the image sensor. L4S2_max_sag to Sensor may be the maximum Sag value of the fourth lens 104 and 114, i.e., the distance in the optical axis direction from the low point to the image sensor 300. When the optical system satisfies Equation 7, TTL may be reduced, and conditions for manufacturing the camera module may be set. In addition, L4S2_max_sag to Sensor may set the space in which the optical filter 500 and the cover glass 400 located between the image sensor 300 and the fourth lens 104 and 114 may be placed. If the range of Equation 7 is smaller than the lower limit, the space for arranging circuit structures such as optical filters and image sensors becomes limited, and the process of assembling circuit structures such as filters and image sensors into the optical system may become difficult. If the range of Equation 7 is larger than the upper limit, the process of assembling circuit structures such as filters and image sensors into the optical system is easy, but the TTL becomes long, making it difficult to miniaturize the optical system. That is, Equation 7 may set the minimum distance between the image sensor 300 and the last lens, and preferably, it may satisfy the following condition: L7S2_max_sag to Sensor<BFL. In addition, if the last lens does not have a point where it protrudes further toward the image sensor than the center of the sensor-side surface, the value of Equation 6 may be equal to BFL. Preferably, if the following condition satisfies: 2≤BFL/L7S2_max_sag to Sensor≤5, the convenience of manufacturing and TTL reduction are easier.

$$0 < CT 1 / CT 4 < 1.5 \qquad [ Equation 8 ]$$

If Equation 8 is satisfied, the aberration characteristics may be improved and the influence on the reduction of the optical system may be set. Equation 8 may preferably satisfy: 0.5<CT1/CT4<1.3. Equation 8 may set the center thickness of the first lens on the object side of the optical system and the fourth lens having an aspherical surface, and can limit the difference in their center thicknesses. Accordingly, the chromatic aberration of the optical system may be improved, and good optical performance may be achieved at the set field of view and TTL may be controlled.

$$0.1 < CT 1 / CA 11 < 0.5 \qquad [ Equation 8 - 1 ]$$

In Equation 8-1, the center thickness CT1 of the first lens 101 and 111 and the effective diameter CA11 of the object-side surface S1 of the first lens 101 and 111 may be set, and if these are satisfied, the strength and optical characteristics of the glass lens may be inhibited from being deteriorated. If it is lower than the range of Equation 8-1, the lens may be damaged or injection molding may be difficult, and if it is larger than the above range, the TTL may increase and the weight of the optical system may become heavy. Preferably, 0.15<CT1/CA11<0.4 may be satisfied.

$$1 < ( CT 3 / CT 4 ) < ( CT 3 / CT 2 ) < 7 \qquad [ Equation 9 ]$$

When the optical system satisfies Equation 9, the ratio of the center thicknesses of adjacent plastic lenses and the ratio of the center thicknesses of adjacent plastic lenses and glass lenses may be set, and the aberration characteristics may be improved and the influence on the reduction of the optical system may be set. Equation 9 preferably satisfies: 1<(CT3/CT4)<(CT3/CT2)<3.

$$1 < CT 3 / ( CT 1 + CT 4 ) < 2 \qquad [ Equation 10 ]$$

In Equation 10, the center thickness of the third lens 103 and 113 made of plastic material may be set to be larger than the sum of the center thicknesses of the first and fourth lenses, so that light may be guided to the entire region of the fourth lens.

$$1 < CT 34 / CT 4 < 5 \qquad [ Equation 11 ]$$

CT34 is the sum of the center thicknesses of the third and fourth lenses. If Equation 11 is satisfied, the center thickness of the fourth lens 104 and 114 made of plastic material is provided to be thinner than the center thickness of the third lens, so that the fourth lens can guide the light refracted through the third lens to the periphery of the image sensor 300. Preferably, 2<CT34/CT4<4 may be satisfied.

$$0 < CA 11 / CA 31 < 2 \qquad [ Equation 12 ]$$

CA11 means the effective diameter of the first surface S1 of the first lens 101 and 111, and CA31 means the effective diameter of the fifth surface S5 of the third lens 103 and 113. If Equation 13 is satisfied, the optical system 1000 can control the incident light and set the factor affecting the aberration, and preferably, 1<CA11/CA31<1.5 may be satisfied. Since the first and third lenses satisfy Equation 13, the difference in effective diameters of the first and third lenses is not large, so that the influence of assembly may be reduced, and the optical influence of temperature change may be reduced.

$$1 < CA 42 / CA 31 < 3 \qquad [ Equation 13 ]$$

CA42 means the effective diameter of the eighth surface S8 of the fourth lens 104 and 114, and CA31 means the effective diameter of the fifth surface S5 of the third lens 103 and 113. When Equation 13 is satisfied, the optical system 1000 can control the incident light path, and may set factors for performance changes according to CRA and temperature. Preferably, Equation 13 may satisfy: 1.5<CA42/CA31<2.5.

$$0 < CA 22 / CA 31 < 2 \qquad [ Equation 14 ]$$

CA22 means the effective diameter of the fourth surface S4 of the second lens 102 and 112, and CA31 means the effective diameter of the fifth surface S5 of the third lens 103 and 113. When the optical system 1000 according to the embodiment satisfies Equation 14, light passing from the first lens group LG1 to the second lens group LG2 may be controlled, and a factor affecting a decrease in lens sensitivity may be set. Equation 15 preferably satisfies: 0.5<CA22/CA31<1. Since the second and third lenses satisfy Equation 14, the size for assembling the spherical lens and the aspherical lens may be set.

$$1.5 < \sum PL\_CT / \sum GL\_CT < 4 \qquad [ Equation 15 ]$$

ΣPL_CT is the sum of the center thicknesses of the plastic lenses, for example, the sum of the center thicknesses of the third and fourth lenses. ΣGL_CT is the sum of the center thicknesses of the spherical lenses, for example, the sum of the center thicknesses of the first and second lenses. If Equation 15 is satisfied, the relationship between the thickness of the aspherical lens and the thickness of the spherical lens relative to the TTL may be set to control the overall TTL. Preferably, Equation 15 in the embodiment may satisfy: 1.7<ΣPL_CT/ΣGL_CT<3.

$$0 \text{.3} < \sum PL\_CT / TD < 0.7 \qquad [ Equation 16 ]$$

TD is the optical axis distance from the center of the object-side surface of the first lens to the center of the sensor-side surface of the last fourth lens. Equation 16 may set the relationship between the sum of the center thicknesses of the plastic lenses of the optical system and the maximum distance between the lenses. Equation 16 may preferably satisfy: 0.4≤ΣPL_CT/TD≤0.6.

$$0.1 < \sum GL\_CT / TD < 0.3 \qquad [ Equation 17 ]$$

Equation 17 may set the relationship between the sum of the center thicknesses of the glass lenses of the optical system and the maximum distance between the lenses. Preferably, it may satisfy: 0.15≤ΣGL_CT/TD≤0.25.

$$0.1 < \sum GL\_CT / TTL < 0.5 \qquad [ Equation 18 ]$$

Equation 84 may set the relationship between the sum of the center thicknesses of the glass lenses and the total optical length (TTL). Equation 84 may preferably satisfy: 0.2≤ΣGL_CT/TTL≤0.4.

$$0.2 < GL\_CA \_Aver / PL\_CA \_Aver < 2 \qquad [ Equation 19 ]$$

GL_CA_Aver means the average effective diameter of glass lenses having a spherical surface, and PL_CA_Aver means the average effective diameter of glass mold lenses having an aspherical surface. In Equation 19, by setting the effective diameters of the spherical lens and the aspherical lens, the path of the incident light may be effectively guided. Equation 19 preferably satisfies: 0.5<GL_CA_Aver/PL_CA_Aver<1.2. In the embodiment, by mixing a spherical lens and an aspherical lens in an optical system, the number of lenses may be reduced, and deterioration of optical characteristics may be inhibited.

$$0 < GL\_Nd \_Aver / PL\_Nd \_Aver < 1.6 \qquad [ Equation 20 ]$$

GL_Nd_Aver is the average of the refractive indices of the glass lenses, for example, the average of the refractive indices of the first and second lenses. PL_Nd_Aver is the average of the refractive indices of the third and fourth lenses. Preferably, the refractive indices of the spherical lens and the refractive indices of the aspherical lens may be set to satisfy the following condition: 1<GL_Nd_Aver/PL_Nd_Aver<1.5.

$$\sum PL\_Nd < \sum GL\_Nd \qquad [ Equation 20 - 1 ]$$

ΣPL_Nd is the sum of the refractive indices of the plastic lenses, and ΣGL_Nd is the sum of the refractive indices of the glass lenses. The optical system can adjust the resolution and color dispersion by setting the sum of the refractive indices of the object-side glass lenses to be higher than the sum of the refractive indices of the sensor-side plastic lenses.

$$5 < \vert Max\_slope42 \vert < 65 \qquad [ Equation 21 ]$$

Max_slope42 is the maximum slope angle of the tangent passing through the sensor-side surface of the fourth lens with respect to the optical axis. When the optical system 1000 according to the embodiment satisfies Equation 21, the optical system 1000 can control the occurrence of lens flare. Preferably, Equation 21 may satisfy: 30≤|Max slope42|≤50. In addition, the maximum slope angle of the sensor-side surface of the third lens is |Max Slope32|, and may be greater than the maximum tangent angle of the fourth lens.

$$( CG 1 + CG 2 ) < CT 3 \qquad [ Equation 22 ]$$

CG1 is the center distance between the first and second lenses, and CG2 is the center distance between the second and third lenses. In Equation 22, the center thickness of the third lens is increased, and the center distance between the first and third lenses is reduced, so that the TTL may be adjusted.

$$LD 12 < LD 34 \qquad [ Equation 23 ]$$

LD12 is the distance from the center of the object-side surface of the object-side glass material lens to the center of the object-side surface of the last glass lens. For example, LD12 is the distance from the center of the object-side surface of the first lens to the center of the sensor-side surface of the second lens. LD34 is the distance from the center of the object-side surface of the first plastic lens to the center of the sensor-side surface of the last plastic lens. LD34 is the distance from the center of the object-side surface of the third lens to the center of the sensor-side surface of the fourth lens. In Equation 23, the optical axis distance of the plastic lenses is provided to be thicker than the optical axis distance of the glass lenses, so that the light with the chromatic aberration corrected may be refracted to the entire region of the image sensor.

$$0.2 < LD 12 / TTL < 0.5 \qquad [ Equation 24 ]$$

In Equation 24, by setting the optical axis distance of the glass lenses relative to the total length (TTL), the effective diameter, radius of curvature, refractive index, Abbe number, etc. of the glass lenses may be set. Preferably, 0.35≤LD12/TTL≤0.55 may be satisfied.

$$0.1 < CT 3 / TTL < 0.7 \qquad [ Equation 25 ]$$

In Equation 25, by setting the center thickness of the third lens to the above range based on TTL, the light incident through the first and second lenses may be refracted to the entire region of the fourth lens, and the chromatic aberration of the optical system may be improved.

$$0.4 < CT 3 / ImgH < 0.9 \qquad [ Equation 25 - 1 ]$$

In Equation 25-1, the center thickness of the third lens is set to the above range relative to ImgH, so that the change in optical characteristics due to temperature change may be reduced.

$$0 < \vert L 2 R 1 / L 4 R 2 \vert < 10 \qquad [ Equation 26 ]$$

L2R1 means the radius of curvature of the third surface of the second lens, and L4R2 means the radius of curvature of the eighth surface of the fourth lens. In Equation 28, the radius of curvature of the object-side surface of the second lens and the sensor-side surface of the fourth lens are set, so that the power of the second and fourth lenses may be controlled. Accordingly, good optical performance may be achieved at the center and periphery of the field of view. Preferably, Equation 26 may satisfy: 2<|L2R1/L4R2|<5.

$$1 < L 4 R 1 / CT 4 < 10 \qquad \{ Equation 27 ]$$

L4R1 means the radius of curvature of the object-side surface of the fourth lens. If Equation 27 is satisfied, the power of the fourth lens may be controlled to control the incident light as an aspherical lens, and the deterioration of the aspherical assembly may be inhibited. Preferably, 1.5≤L4R1/CT4<5 may be satisfied.

$$1 < \vert L 3 R 1 / L 3 R 2 \vert < 5 \qquad [ Equation 28 ]$$

L3R1 means the radius of curvature of the object-side surface of the third lens, and L3R2 means the radius of curvature of the sensor-side surface of the third lens. If Equation 28 is satisfied, the third lens may be expressed as a cemented lens. Preferably, 1≤|L3R1/L3R2|<3 may be satisfied.

$$L 1 R 1 * L 3 R 1 < 0 \qquad [ Equtaion 29 ]$$

L1R1 and L3R1 may have radii of curvature with opposite signs on the optical axis. For example, the radius of curvature of the object-side surface of the first lens may be a positive value, and the radius of curvature of the object-side surface of the third lens may be a negative value.

$$( Nd 1 * Vd 1 ) < ( Nd 2 * Vd 2 ) \qquad [ Equation 30 ]$$

Nd1 and Nd2 are the refractive indices of the d-line of the first and second lenses, and Vd1 and Vd2 are the Abbe numbers of the first and second lenses. By setting the relationship between the refractive indices and Abbe numbers of the first and second lenses made of glass, the incident light may be dispersed and guided to the third lens.

$$0 < CT\_Max / CG\_Max < 5 \qquad [ Equation 31 ]$$

In Equation 31, the maximum center thickness CT_Max among the lenses and the maximum center distance CG_Max between adjacent lenses may be set. If Equation 31 is satisfied, the optical system may have good optical performance at the focal length at the set field of view and can reduce TTL. Preferably, the embodiment may satisfy: 1.5<CT_Max/CG_Max<3.5.

$$1 < Σ CT / Σ CG < 5 \qquad [ Equation 32 ]$$

In Equation 32, ΣCT is the sum of the center thicknesses of the lenses, and ΣCG is the sum of the center distances between adjacent lenses. If Equation 32 is satisfied, the optical system may have good optical performance at the focal length at the set field of view and can reduce TTL. Preferably, Equation 32 may satisfy: 1.4<ΣCT/ΣCG<3.

$$5 < Σ Nd < 10 \qquad [ Equation 33 ]$$

ΣNd means the sum of the refractive indices at the d-lines of each of the plurality of lenses. When Equation 33 is satisfied, TTL may be controlled in an optical system 1000 in which an aspherical lens and a spherical lens are mixed, and improved resolution may be achieved. In addition, glass lenses having relatively high refractive indices and plastic lenses having relatively thick center thicknesses may be arranged in the optical axis direction to set the TTL and refractive indices. Equation 33 may preferably satisfy: 6<ΣNd<8.

$$10 < Σ Abbe / Σ Nd < 50 \qquad [ Equation 34 ]$$

ΣAbbe means the sum of the Abbe numbers of each of the plurality of lenses. If Equation 34 is satisfied, the optical system 1000 may have improved aberration characteristics and resolution. By setting the Abbes sum and the sum of the refractive indices of the lenses in Equation 34, the optical characteristics may be controlled, and preferably, 15<ΣAbbe/ΣNd<25 may be satisfied.

$$Distortion < 10 \qquad [ Equation 35 ]$$

Distortion means the maximum value of distortion or the absolute value of the maximum from the center (0.0 F) of the image sensor to the diagonal end (1.0 F) based on the optical characteristics detected by the image sensor 300. If the optical system 1000 satisfies Equation 35, the optical system 1000 can improve the distortion characteristics and set conditions for image processing. Preferably, Distortion<2 may be satisfied.

$$0.5 < CA 11 / CA\_Min < 2.5 \qquad [ Equation 36 ]$$

CA11 means the effective diameter of the object-side surface of the first lens, and CA_Min means the minimum effective diameter among the object-side surfaces and the sensor-side surfaces of the lenses. When Equation 36 is satisfied, the optical system can provide a slimmer module while controlling incident light and maintaining optical performance. Equation 36 preferably satisfies: 1<CA11/CA_Min<2.

$$1 < CA\_Max / CA\_Min < 5 \qquad [ Equation 37 ]$$

CA_Max means the maximum effective diameter among the object-side surfaces and the sensor-side surfaces of the lenses. If Equation 37 is satisfied, the optical system may set the size for a slim and compact structure while maintaining optical performance. Equation 37 may preferably satisfy: 2<CA_Max/CA_Min<3.

$$1 < CA\_Max / CA\_Aver < 3 \qquad [ Equation 38 ]$$

CA_Aver means the average of the effective diameters of the object-side surfaces and the sensor-side surfaces of the lenses. If Equation 38 is satisfied, the optical system may set the size for a slim and compact structure while maintaining optical performance. Equation 38 may preferably satisfy: 1.2<CA_Max/CA_Aver<2.

$$0.2 < CA\_Min / CA\_Aver < 2 \qquad \{ Equation 39 ]$$

If Equation 39 is satisfied, the optical system may set the size for a slim and compact structure while maintaining optical performance. Preferably, Equation 39 may satisfy: 0.5<CA_Min/CA_Aver<0.8.

$$0.5 < CA\_Max / ( 2 * ImgH ) < 2 \qquad [ Equation 40 ]$$

Equation 40 may be set by the maximum effective diameter CA_Max of lens surfaces and the diagonal length of the image sensor, and if it is satisfied, the optical system can maintain good optical performance and set the size for a slim and compact structure. Preferably, it may satisfy: 0.7<CA_Max/(2*ImgH)<1.5.

$$0.5 < TD / CA\_Max < 4 \qquad [ Equation 41 ]$$

If Equation 41 is satisfied, the total optical axis distance and maximum effective diameter of the lenses may be set, and the size for good optical performance may be set. Preferably, Equation 41 may satisfy: 0.7<TD/CA_Max<1.2.

$$TD > SD \qquad [ Equation 41 - 1 ]$$

The SD is the distance from the position of the aperture stop to the center of the sensor-side surface of the last lens.

$$0 < TD / CT\_Max < 0.7 \qquad [ Equation 42 ]$$

In Equation 42, the maximum center thickness and maximum optical axis distance of the lenses may be set, and good optical performance may be improved. Preferably, 0.3≤TD/CT_Max≤0.4 may be satisfied.

$$0 < F / CA 41 < 1 \qquad [ Equation 43 ]$$

F means the effective focal length (EFL) of the optical system, and may be less than 15 mm or less than 10 mm, for example, in the range of 1 mm to 10 mm. In Equation 43, the relationship between the effective focal length and the effective diameter of the object-side surface of the last spherical lens is set, so that the influence on the optical system reduction, for example, TTL, may be controlled. Equation 43 preferably satisfies: 0.2<F/CA41<0.5.

$$0 < F / L 1 R 1 < 1 \qquad [ Equation 44 ]$$

In Equation 44, the effective focal length of the optical system and the radius of curvature of the object-side surface of the first lens are set, so that the influence on the incident light and TTL may be controlled. Equation 44 preferably satisfies: 0.2<F/L1R1<0.7.

$$1 < Max ( CT / ET ) < 3 \qquad [ Equation 45 ]$$

Max(CT/ET) means the maximum value of the ratio of the center thickness and edge thickness of each lens. When Equation 45 is satisfied, the optical system can control the influence on the effective focal length. Equation 45 may preferably satisfy: 1.2<Max(CT/ET)<2.

When looking at the ratio of the center thickness and edge thickness of the glass lens and the plastic lens within the lens portion, the following condition may satisfy: Max_GL(CT/ET)<Max_PL(CT/ET). Max_GL(CT/ET) means the maximum ratio of the center thickness and edge thickness among the glass lenses, and Max_PL(CT/ET) means the maximum ratio of the center thickness and edge thickness among the plastic lenses.

$$0 < EPD / L 1 R 1 < 1 \qquad [ Equation 46 ]$$

EPD means the size (mm) of the entrance pupil diameter of the optical system 1000. When the optical system 1000 according to the embodiment satisfies Equation 46, the optical system 1000 can control the incident light. Equation 46 may preferably satisfy: 0.3<EPD/L1R1<0.7.

$$0 < F 1 / F 3 < 1 \qquad [ Equation 47 ]$$

F1 is the focal length of the first lens, and F3 is the focal length of the third lens. When Equation 47 is satisfied, the power of the first and third lenses may be controlled to improve the resolution, and can affect the TTL and the effective focal length (F). Preferably, 0.2≤F1/F3≤0.7 may be satisfied.

$$F 1 < \vert F 4 \vert \qquad [ Equation 47 - 1 ]$$

$$F 1 < F 3 \qquad [ Equation 47 - 2 ]$$

$$F 1 < \vert F 2 \vert \qquad [ Equation 47 - 3 ]$$

$$F < F 4 \qquad [ Equation 47 - 4 ]$$

In Equations 47-1 to 47-4, F1 is the focal length of the first lens, F2 is the focal length of the second lens, F3 is the focal length of the third lens, and F4 is the focal length of the fourth lens. By controlling the power of each lens, light may be effectively guided to the aspherical lens.

The aperture stop ST is disposed on the sensor-side surface of the first lens 101 and 112. The focal length of the lens disposed on the sensor side more than the aperture stop ST and disposed closest to the aperture stop ST is less than 0. The focal length F2 of the second lens 102 and 112 must be designed to be less than 0. In this case, since the second lens 102 and 112 has a convex meniscus shape toward the object side, the effective diameter of the object-side surface of the third lens 103 and 113 may not be increased. Since the third lens 103 has positive power, the effective diameter of the fourth lens may be increased. The composite focal length F24 of the second to fourth lenses may have positive power. That is, the composite focal length F24 of the lenses arranged closer to the sensor than the aperture stop ST, that is, the lenses arranged closer to the sensor than the aperture stop, is designed to be greater than 0. In this case, the optical system may be miniaturized by reducing the TTL at a horizontal field of view FOV_H of 45 to 55 degrees.

$$Po 3 * Po 4 < 0 \qquad [ Equation 48 ]$$

Po3 is the power value of the third lens, and Po4 is the power value of the fourth lens. That is, the powers of the third and fourth lenses have opposite powers, which can improve aberrations and effectively guide light with an aspherical lens.

$$15 < Vd 2 - Vd 3 < 60 \qquad [ Equation 49 ]$$

In Equation 49, Vd2 is the Abbe number of the second lens, and Vd3 is the Abbe number of the third lens. When Equation 49 is satisfied, the difference in Abbe numbers between adjacent two lenses may be maintained above a certain value, and chromatic aberration may be improved. Equation 49 preferably satisfies: 30<Vd2−Vd3<50.

$$0 < F 34 / F 12 < 2 \qquad [ Equation 50 ]$$

In Equation 50, by setting the relationship between the composite focal length F12 of the first and second lenses and the composite focal length F34 of the third and fourth lenses, the power of the glass lenses and the plastic lenses may be controlled to improve the resolution, and the optical system may be provided in a slim and compact size. Equation 50 preferably satisfies: 1<F34/F12<2.

$$0 < \vert F 34 / F 3 \vert < 2 \qquad [ Equation 51 ]$$

In Equation 51, the relationship between the focal length F3 of the third lens and the composite focal length F34 of the third and fourth lenses is set, so that the power of the plastic lenses may be controlled to improve the resolution. Equation 51 preferably satisfies: 0<|F34/F3|<1.

$$1 < F 24 / F 12 < 5 \qquad [ Equation 52 ]$$

In Equation 52, the relationship between the composite focal length F12 of the first and second lenses and the composite focal length F24 of the second to fourth lenses is set, so that the composite focal length of the sensor-side lenses of the aperture stop is set to be greater than the composite power of the plastic lenses, so that the composite power of the sensor-side lenses of the aperture stop may be controlled to improve the resolution. Equation 52 preferably satisfies: 2<F24/F12<3.

$$\vert F\_GL \_Aver \vert < \vert F\_PL \_Aver \vert \qquad [ Equation 53 ]$$

In Equation 53, F_GL_Aver is the average of the focal lengths of the glass lenses, and F_PL_Aver is the average of the focal lengths of the plastic lenses. If Equation 53 is satisfied, chromatic aberration and distortion aberration may be improved by the plastic lenses.

$$0 < nPl / nL < 1 \qquad [ Equation 54 ]$$

nPL is the number of plastic lenses, and nL means the number of total lenses. In Equation 54, by arranging the number of aspherical lenses to be less than 1 times the number of total lenses, the thickness of the optical system may be reduced and more diverse power may be provided through the aspherical surface. In addition, Equation 54-1 may satisfy: 0<nGL/nL<1, and nGL is the number of glass lenses.

$$( CA\_Max / CA\_Min ) < ( CT\_Max / CT\_Min ) \qquad [ Equation 55 ]$$

CA_Max is the maximum effective diameter among the lenses, and CA_Min is the minimum effective diameter among the lenses. CT_Max is the maximum among the center thicknesses of the lenses, and CT_Min is the minimum among the center thicknesses of the lenses. Equation 55 sets the difference in the effective diameters of the lenses to be smaller than the difference in the center thicknesses of the lenses, thereby improving the assemblability of the lenses.

$$2 mm < TTL < 15 mm \qquad [ Equation 56 ]$$

TTL means the distance (mm) from the center of the first surface S1 of the first lens 101 to the surface of the image sensor 300 on the optical axis OA. In Equation 56, by setting TTL to 10 mm or less, a vehicle optical system may be provided. Preferably, 3 mm≤TTL<10 mm or 3 mm≤TTL<8 mm may be satisfied.

$$2 mm < ImgH \qquad [ Equation 57 ]$$

Equation 57 may set ½ of the diagonal length of the image sensor 300, and can provide an optical system having a vehicle sensor size. Equation 57 may preferably satisfy: 3 mm≤ImgH<5 mm.

$$1 mm < BFL < 3 mm \qquad [ Equation 58 ]$$

In Equation 58, BFL is set to be greater than 1 mm and less than 3 mm, so that the installation space of the optical filter 500 and the cover glass 400 may be secured, and the assemblability of the components may be improved through the gap between the image sensor 300 and the last lens, and the bonding reliability may be improved. Equation 58 may preferably satisfy: 1.5 mm≤BFL≤2 mm. When the BFL is less than the range of Equation 58, some of the light that proceeds to the image sensor cannot be transmitted to the image sensor, which may be a cause of resolution degradation. If The BFL exceeds the range of Equation 58, stray light may be introduced, which may deteriorate the aberration characteristics of the optical system.

$$1 < BFL / CG 2 < 3 \qquad [ Equation 59 ]$$

In Equation 59, by setting the center distance CG2 between the BFL and the second and third lenses, the reliability of the bonding of the components may be improved according to the installation space of the optical filter 500 and the cover glass 400 and the gap between the glass lens and the plastic lens. In Equation 59, 2.6<BFL/CG2<2.5 may be satisfied. The center distance CG2 between the first and second lenses may be the largest within the lens portion.

$$0 < CT 1 / BFL < 1 \qquad [ Equation 60 ]$$

In Equation 68, by setting the BFL to be larger than the center thickness of the first lens, the installation space of the optical filter 500 and the cover glass 400 may be secured, and the assembly of the components may be improved through the gap between the image sensor 300 and the last lens, and the bonding reliability may be improved. If the BFL does not satisfy Equation 60, some of the emitted light may not be transmitted to the effective region of the image sensor, and thus the resolution may be reduced. Preferably, 0.2<CT1/BFL<0.6 may be satisfied.

$$F < 15 mm \qquad [ Equation 61 ]$$

Equation 61 may set the total effective focal length F to suit the vehicle optical system. Equation 61 may satisfy the range of 1 mm≤F≤10 mm or 3 mm≤F≤8 mm.

$$45 < FOV < 75 \qquad [ Equation 62 ]$$

In Equation 62, FOV (Field of view) means the angle (Degree) of view in the diagonal direction of the optical system 1000, and may provide a vehicle optical system of less than 75 degrees. Preferably, 50≤FOV≤70 may be satisfied.

$$0.5 < TTL / CA\_Max < 1.5 \qquad [ Equation 63 ]$$

CA_Max means the largest effective diameter (mm) among the object-side and sensor-side surfaces of the plurality of lenses. Equation 63 sets the relationship between the total optical axis length of the optical system and the maximum effective diameter, and may provide an improved vehicle optical system. Equation 63 may preferably satisfy: 0.4<TTL/CA_Max<1.

$$1 < TTL < ImgH < 55 \qquad [ Equation 64 ]$$

Equation 64 may set the total optical axis length TTL of the optical system and the diagonal length ImgH from the optical axis of the image sensor 300. When the optical system 1000 according to the embodiment satisfies Equation 64, the optical system 1000 may have TTL for application to the vehicle image sensor 300, thereby providing improved image quality. Equation 64 may preferably satisfy: 1<TTL/ImgH≤1.5. It can also satisfy: TTL≤10 mm.

$$0.1 < BFL < ImgH < 1 \qquad [ Equation 65 ]$$

Equation 65 may set the optical axis distance between the image sensor 300 and the last lens and the diagonal length from the optical axis of the image sensor 300. When the optical system 1000 according to the embodiment satisfies the Equation 65, the optical system 1000 can secure a BFL for applying the size of the vehicle image sensor 300, set the distance between the last lens and the image sensor 300, and have good optical characteristics at the center and periphery of the FOV. The Equation 65 preferably satisfies the following conditions: 0.3<BFL/ImgH<0.7, and BFL<ImgH.

$$1 < TTL / BFL < 10 \qquad [ Equation 66 ]$$

Equation 66 may set the total optical axis length TTL of the optical system, and the optical axis distance BFL between the image sensor 300 and the last lens. When the optical system 1000 according to the embodiment satisfies the Equation 66, the optical system 1000 can secure a BFL. Equation 66 may preferably satisfy: 2≤TTL/BFL<3.

$$0.5 < TTL / F < 2 \qquad [ Equation 67 ]$$

Equation 75 may set the total focal length F and the total optical axis length TTL of the optical system 1000. Accordingly, an optical system for a driver assistance system or a driver monitoring system may be provided. Equation 67 may preferably satisfy: 0.6≤TTL/F<1. When the optical system 1000 according to the embodiment satisfies Equation 67, the optical system 1000 may have an appropriate focal length in the set TTL range, and provides an optical system that can maintain an appropriate focal length and form an image even when the temperature changes from low temperature to high temperature. If it is less than the lower limit of Equation 67, it is necessary to increase the power of the lenses, so that correction of spherical aberration or distortion aberration becomes difficult, and if it exceeds the upper limit of Equation 67, the effective diameter or TTL of the lenses becomes long, which may cause a problem of the large size of the photographing lens system.

$$1 < F / BFL < 10 \qquad [ Equation 68 ]$$

Equation 68 may set the total effective focal length F of the optical system 1000 and the optical axis distance BFL between the image sensor 300 and the last lens. If the optical system 1000 according to the embodiment satisfies Equation 68, the optical system 1000 may have a set field of view and an appropriate focal length, and an optical system for a vehicle may be provided. In addition, the optical system 1000 can minimize the distance between the last lens and the image sensor 300, so that it may have good optical characteristics in the periphery of the FOV. Equation 68 may preferably satisfy: 2.5<F/BFL<3.5.

$$1 < F / ImgH < 5 \qquad [ Equation 69 ]$$

Equation 69 may set the total effective focal length F of the optical system 1000 and the diagonal length ImgH from the optical axis of the image sensor 300. This optical system 1000 may have improved aberration characteristics in the size of the vehicle image sensor 300. Equation 69 may preferably satisfy: 1.2<F/ImgH<2.

$$1 < F / EPD < 5 \qquad [ Equation 70 ]$$

Equation 70 may set the total effective focal length F and the entrance pupil diameter of the optical system 1000. Accordingly, the overall brightness of the optical system may be controlled. Equation 70 may preferably satisfy: 1<F/EPD<3.

$$0 < BFL / TD < 0.5 \qquad [ Equation 71 ]$$

Equation 71 may set the relationship between the optical axis distance TD and the back focal length BFL of the lenses of the optical system 1000. Accordingly, the resolution of the optical system may be maintained and the overall size may be controlled. Equation 71 may preferably satisfy: 0.2≤BFL/TD<0.4. When the condition value of BFL/TD exceeds 0.5, the BFL is designed to be large compared to the TD, so the size of the entire optical system becomes large, making it difficult to miniaturize the optical system, and the distance between the fourth lens and the image sensor becomes long, so that an unnecessary amount of light may increase between the fourth lens and the image sensor, resulting in a problem of lowering the resolution, such as deterioration of aberration characteristics.

$$0 < EPD / ImgH / FOV < 0.2 \qquad [ Equation 72 ]$$

Equation 72 may set the relationship between the size of the EPD, the length ImgH of half the diagonal length of the image sensor, and the diagonal field of view. Accordingly, the overall size and brightness of the optical system may be controlled. Preferably, Equation 72 may satisfy: 0<EPD/ImgH/FOV<0.1.

$$20 < FOV / F \# < 40 \qquad [ Equation 73 ]$$

Equation 73 may set the relationship between the diagonal field of view and the F number of the optical system. Preferably, Equation 73 may satisfy: 25<FOV/F #<36. Here, F # is provided as 2.2 or less, so as to provide a bright image.

$$1 mm < \sum GL\_CT ⋆ nGL < 3 mm \qquad [ Equation 74 ]$$

Equation 74 may set the center thickness and number of glass lenses by the product of the sum ΣGL_CT of the center thicknesses of the glass lenses and the number of glass lenses. Preferably, Equation 74 may satisfy: 2 mm<ΣGL_CT*nGL<3 mm.

$$3 mm < \sum PL\_CT ⋆ nPL < 8 mm \qquad [ Equation 75 ]$$

Equation 75 may set the center thickness and number of plastic lenses by the product of the sum ΣPL_CT of the center thicknesses of the plastic lenses and the number of plastic lenses. Preferably, Equation 75 may satisfy: 4 mm<ΣPL_CT*nPL<6 mm.

$$5 < TTL ⋆ nGL < 10 \qquad [ Equation 76 ]$$

Equation 76 may set the number of glass lenses and TTL, and can adjust color dispersion and refraction angle by glass lenses in an optical system having a TTL of 10 mm or less.

$$4 < ImgH ⋆ nGL < 8 \qquad [ Equation 77 ]$$

Equation 77 may set the number of glass lenses and ImgH, and can adjust color dispersion and refraction angle by glass lenses in an optical system having an ImgH of less than 5 mm.

$$\vert Max\_Sag 41 \vert < \vert Max\_Sag 32 \vert \qquad [ Equation 78 ]$$

Max_Sag41 is the maximum distance in the optical axis direction from a straight line perpendicular to the optical axis on the object-side surface of the fourth lens to the object-side surface of the fourth lens, and Max_Sag32 is the maximum distance in the optical axis direction from a straight line perpendicular to the optical axis on the sensor-side surface of the third lens to the sensor-side surface of the third lens. When Equation 78 is satisfied, the curvature radius of the lens surfaces of the plastic lenses may be adjusted to guide light to the entire region of the image sensor, and the effective diameters of the third and fourth lenses may be adjusted.

$$\vert Max\_Sag 42 \vert < \vert Max\_Sag 32 \vert \qquad [ Equation 79 ]$$

Max_Sag42 is the maximum distance in the optical axis direction from a straight line perpendicular to the optical axis on the sensor-side surface of the fourth lens to the sensor-side surface of the fourth lens. If Equation 79 is satisfied, the curvature radius of the sensor-side surface of the third and fourth lenses may be adjusted to guide light to the entire region of the image sensor, and the effective diameter of the third and fourth lenses may be adjusted.

The optical system 1000 according to the embodiment may satisfy at least one or two or more Equations among Equations 1 to 40. In this case, the optical system 1000 may have improved optical characteristics. In detail, if the optical system 1000 satisfies at least one of Equations 1 to 40 and/or at least one of Equations 41 to 79, the optical system 1000 may have improved resolution and improve aberration and distortion characteristics. In addition, the optical system 1000 can secure a BFL for applying a vehicle image sensor 300, compensate for the deterioration of optical characteristics due to temperature change, and minimize the distance between the last lens and the image sensor 300, thereby providing good optical performance at the center and periphery of the FOV.

Table 1 shows the items of the Equations described above in the optical system 1000 of the embodiment, including the TTL (mm), BFL, effective focal length F (mm), ImgH (mm), effective diameter CA (mm), thickness (mm), TD (mm), which is an optical axis distance from the first surface S1 to the eighth surface S8, the focal lengths F1, F2, F3, and F4 (mm) of each of the first to fourth lenses, the sum of refractive indices, the sum of Abbe numbers, the sum (mm) of center thicknesses of each lens, the sum of distances between adjacent lenses, the diagonal FOV (Degree), the edge thickness ET, the focal lengths of the first and second lens groups, the composite focal lengths of the second to fourth lenses, the F number, etc.

TABLE 1

| items | Embodiment 1 | Embodiment 2 | Items | Embodiment 1 | Embodiment 2 |
|---|---|---|---|---|---|
| F | 4.944 | 5.038 | ET1 | 0.509 | 0.531 |
| F1 | 5.734 | 5.885 | ET2 | 0.500 | 0.551 |
| F2 | −15.266 | −20.276 | ET3 | 1.282 | 1.023 |
| F3 | 10.525 | 21.804 | ET4 | 1.342 | 0.581 |
| F4 | −259.666 | 18.308 | F-number | 2.002 | 2.000 |
| F_LG1 | 5.734 | 5.885 | FOV (Diagonal | 62.869 | 62.745 |
| | | | angle) | | |
| F_LG2 | 20.770 | 14.646 | EPD | 2.487 | 2.535 |
| F12 | 7.898 | 7.140 | BFL | 1.679 | 1.791 |
| F24 | 9.016 | 8.780 | TD | 6.010 | 5.735 |
| ΣNd | 6.894 | 6.894 | ImgH | 3.092 | 3.092 |
| ΣAbbe | 131.138 | 131.138 | SD | 4.842 | 4.416 |
| ΣCT | 4.326 | 3.769 | TTL | 4.255 | 3.877 |
| ΣCG | 1.685 | 1.865 | Sensor size | 1600*1300 | |
| ΣET | 3.6331 | 2.686 | | | |

Table 2 shows the result values for the Equations 1 to 40 described above in the optical system 1000 of the first and second embodiments. Referring to Table 2, it may be seen that the optical system 1000 satisfies at least one, two or more, or three or more of the Equations 1 to 40. Accordingly, the optical system 1000 may have good optical performance and excellent optical characteristics at the center and periphery of the FOV.

TABLE 2

| Equations | | Embodiment 1 | Embodiment 2 |
|---|---|---|---|
| 1 | 1 < CT1/CT2 < 5 | 2.009 | 1.860 |
| 2 | (CT4*CA4) < (CT3*CA3) | satisfaction | satisfaction |
| 3 | Po1 > 0 | satisfaction | satisfaction |
| 4 | 1.7 ≤ Nd1 < 2.2 | 2.017 | 2.017 |
| 5 | 40 < FOV_H < 60 | 50.00 | 49.99 |
| 6 | L1R1 > 0 | 4.255 | 3.877 |
| 7 | 1 < BFL/Max_Sag42 to Sensor < 6 | 4.430 | 4.546 |
| 8 | 0 < CT1/CT4 < 1 | 0.822 | 1.068 |
| 9 | 1 < (CT3/CT4) < (CT3/CT2) < 7 | 2.191 | 2.171 |
| 10 | 1 < CT3/(CT1 + CT4) < 2 | 1.203 | 1.050 |
| 11 | 1 < CT34/CT4 < 5 | 3.191 | 3.171 |
| 12 | 0 < CA11/CA31 < 2 | 1.219 | 1.193 |
| 13 | 1 < CA42/CA31 < 3 | 2.045 | 2.273 |
| 14 | 0 < CA22/CA31 < 2 | 0.863 | 0.853 |
| 15 | 1.5 < ΣPL_CT/ΣGL_CT < 4 | 2.593 | 1.931 |
| 16 | 0.3 < ΣPL_CT/TD < 0.7 | 0.519 | 0.433 |
| 17 | 0.1 < ΣGL_CT/TD < 0.3 | 0.200 | 0.224 |
| 18 | 0.1 < ΣGL_CT/TTL < 0.5 | 0.283 | 0.332 |
| 19 | 0.2 < GL_CA_Aver/PL_CA_Aver < 2 | 0.736 | 0.617 |
| 20 | 0 < GL_Nd_Aver/PL_Nd_Aver < 1.60 | 1.109 | 1.109 |
| 21 | 5 < \|Max_slope42\| < 65 | 44.762 | 35.490 |
| 22 | (CG1 + CG2) < CT3 | satisfaction | satisfaction |
| 23 | LD12 < LD34 | satisfaction | satisfaction |
| 24 | 0.2 < LD12/TTL < 0.55 | 0.405 | 0.482 |
| 25 | 0.1 < CT3/TTL < 0.7 | 0.504 | 0.439 |
| 26 | 1 < \|L2R1/L4R2\| < 10 | 5.581 | 2.375 |
| 27 | 1 < \|L4R1/CT4\| < 10 | 2.277 | 2.206 |
| 28 | 1 < \|L3R1/L3R2\| < 5 | 3.118 | 1.282 |
| 29 | L1R1*L3R1 < 0 | −65.001 | −22.815 |
| 30 | (Nd1*Vd1) < (Nd2*Vd2) | satisfaction | satisfaction |
| 31 | 0 < CT_Max/CG_Max < 5 | 3.102 | 1.770 |
| 32 | 1 < ΣCT/ΣCG < 5 | 2.568 | 2.021 |
| 33 | 5 < ΣNd < 10 | 6.894 | 6.894 |
| 34 | 10 < ΣAbbe/ΣNd < 50 | 19.022 | 19.022 |
| 35 | Distortion < 10 | satisfaction | satisfaction |
| 36 | 0.5 < CA11/CA_Min < 2.5 | 1.527 | 1.465 |
| 37 | 1 < CA_Max/CA_Min < 5 | 2.561 | 2.792 |
| 38 | 1 < CA_Max/CA_Aver < 3 | 1.644 | 1.683 |
| 39 | 0.2 < CA_Min/CA_Aver < 2 | 0.642 | 0.603 |
| 40 | 0.5 < CA_Max/(2*ImgH) < 2 | 0.960 | 1.088 |

Table 3 shows the result values for the Equations 41 to 79 described above in the optical system 1000 of the first and second embodiments. Referring to Table 3, it may be seen that the optical system 1000 satisfies at least one, two or more, or three or more of the Equations 41 to 79. Accordingly, the optical system 1000 may have good optical performance and excellent optical characteristics at the center and periphery of the FOV.

TABLE 3

| Equations | | Embodiment 1 | Embodiment 2 |
|---|---|---|---|
| 41 | 0.5 < TD/CA_Max < 4 | 1.013 | 0.852 |
| 42 | 0 < CT_Max/TD < 0.7 | 0.357 | 0.296 |
| 43 | 0 < F/CA41 < 1 | 0.437 | 0.302 |
| 44 | 0 < F/L1R1 < 1 | 0.470 | 0.516 |
| 45 | 1 < Max (CT/ET) < 3 | 1.672 | 1.662 |
| 46 | 0 < EPD/L1R1 < 1 | 0.585 | 0.654 |
| 47 | 0 < F1/F3 < 1 | 0.545 | 0.270 |
| 48 | Po3 * Po4 < 0 | satisfaction | satisfaction |
| 49 | 15 < Vd2 − Vd3 < 60 | 42.994 | 42.994 |
| 50 | 0 < F34/F12 < 2 | 1.142 | 1.230 |
| 51 | 0 < \| F34/F3 \| < 2 | 0.857 | 0.403 |
| 52 | 1 < F24/F12 < 5 | 2.630 | 2.051 |
| 53 | \|F_GL_Aver\| < \|F_PL_Aver\| | satisfaction | satisfaction |
| 54 | 0 < nPL/nL < 1 | 0.500 | 0.500 |
| 55 | (CA_Max/CA_Min) < (CT_Max/CT_Min) | satisfaction | satisfaction |
| 56 | 2 < TTL < 15 | 4.255 | 3.877 |
| 57 | 2 < ImgH | 3.092 | 3.092 |
| 58 | 1 < BFL < 3 | 1.679 | 1.791 |
| 59 | 1 < BFL/CG2 < 3 | 2.430 | 1.865 |
| 60 | 0 < CT1/BFL < 1 | 0.479 | 0.467 |
| 61 | F < 15 | 4.944 | 5.038 |
| 62 | 45 < FOV < 75 | 62.890 | 62.740 |
| 63 | 0.5 < TTL/CA_Max < 1.5 | 0.717 | 0.576 |
| 64 | 1 < TTL/ImgH < 5 | 1.376 | 1.254 |
| 65 | 0.1 < BFL/ImgH < 1 | 0.543 | 0.579 |
| 66 | 1 < TTL/BFL < 10 | 2.533 | 2.165 |
| 67 | 0.5 < TTL/F < 2 | 0.860 | 0.769 |
| 68 | 1 < F/BFL < 10 | 2.944 | 2.813 |
| 69 | 1 < F/ImgH < 5 | 1.599 | 1.629 |
| 70 | 1 < F/EPD < 5 | 1.988 | 1.987 |
| 71 | 0 < BFL/TD < 0.5 | 0.2794 | 0.3123 |
| 72 | 0 < EPD/ImgH/FOV < 0.2 | 0.0198 | 0.0194 |
| 73 | 20 < FOV/F# < 40 | 31.408 | 31.372 |
| 74 | 1 < ΣGL_CT*nGL < 3 | 2.408 | 2.572 |
| 75 | 3 < ΣPL_CT*nPL < 8 | 6.244 | 4.966 |
| 76 | 5 < TTL*nGL < 10 | 8.509 | 7.753 |
| 77 | 4 < ImgH*nGL < 8 | 6.185 | 6.185 |
| 78 | \|Max_Sag41 \| < \|Max_Sag32\| | satisfaction | satisfaction |
| 79 | \|Max_Sag42\| < \|Max_Sag32\| | satisfaction | satisfaction |

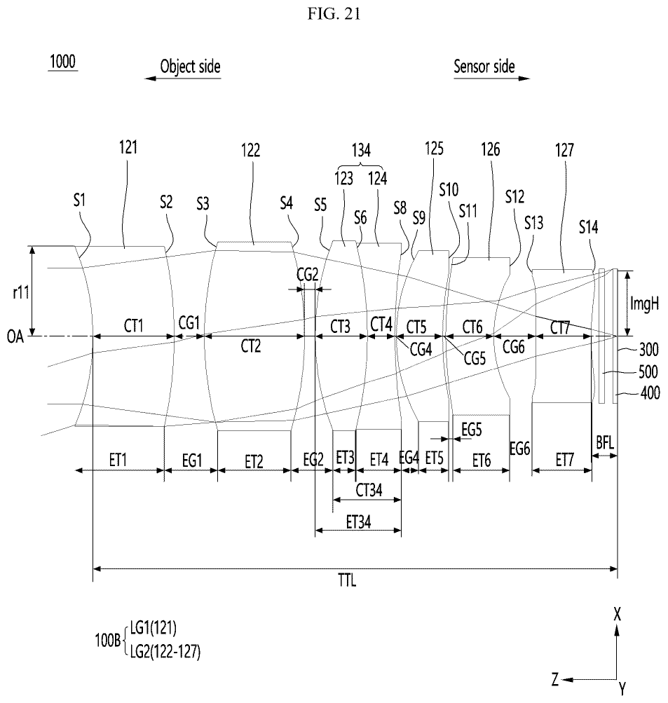

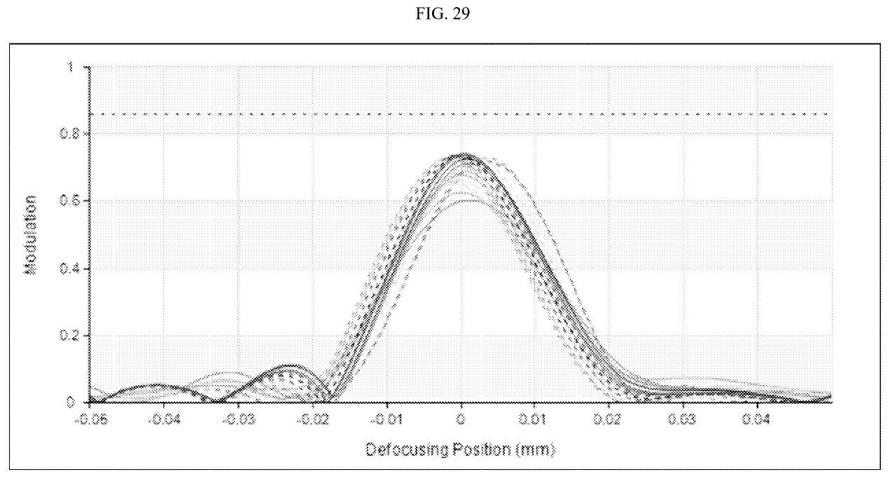

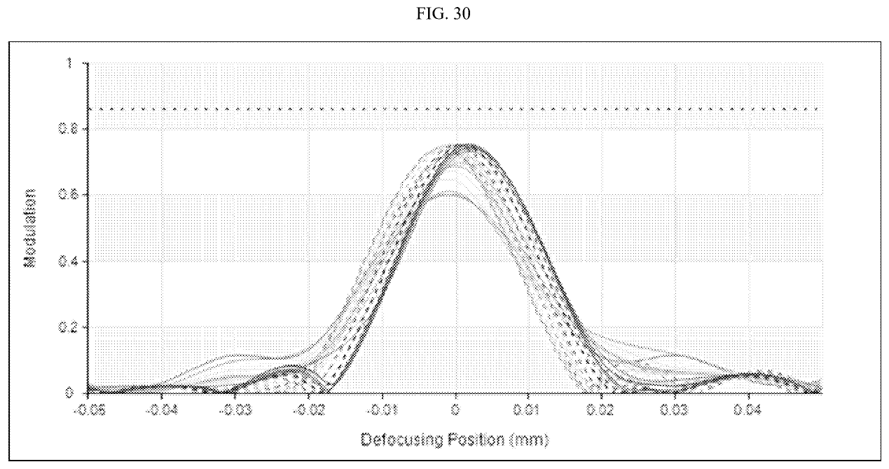

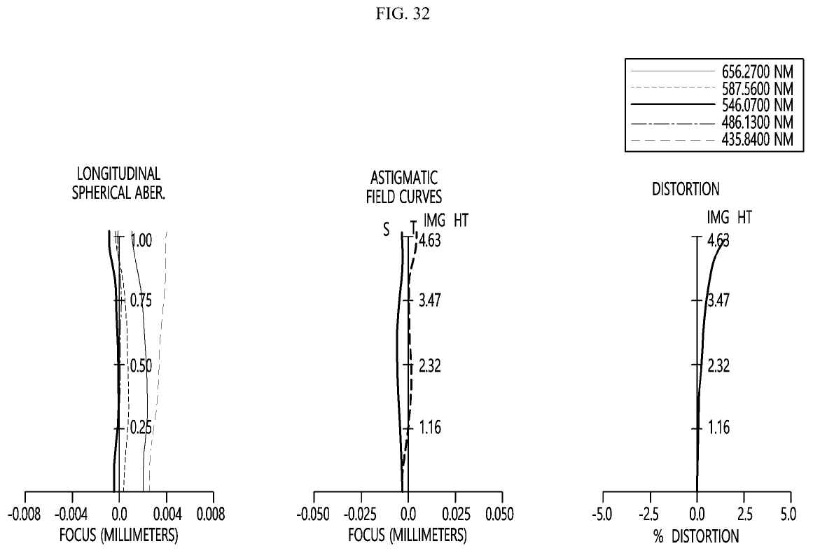

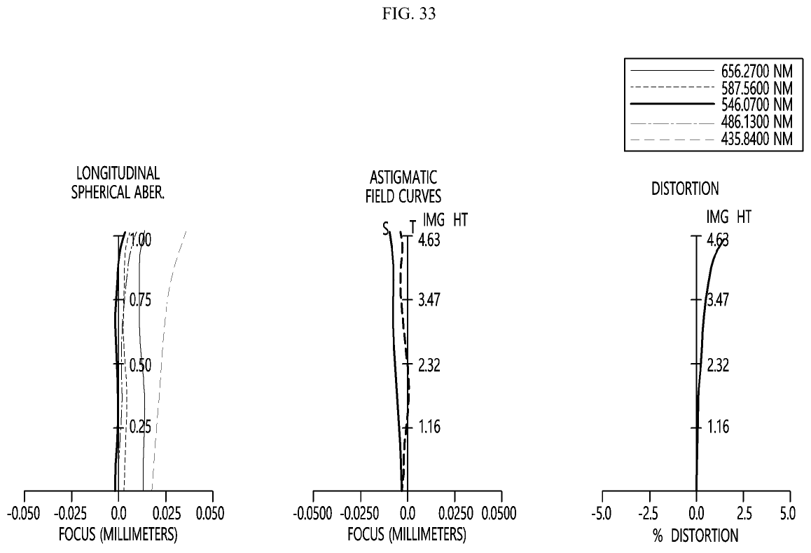

The optical system and camera module according to the third embodiment of the invention will be described with reference to FIGS. 21 to 34. As shown in FIG. 21, the optical system 1000 according to the third embodiment of the invention may include five or more lenses. The optical system 1000 and the camera module having the same may be mounted inside or outside a vehicle to monitor a driver or sense external objects or lanes. The material of the lenses may be selected from glass or plastic, and the coefficient of linear expansion of glass material is lower than that of plastic material. Accordingly, glass lenses are employed to suppress changes in the focal imaging position due to temperature changes. However, glass lenses are expensive compared to plastic lenses, and there is a problem that it is difficult to meet the demand for low cost. Therefore, the lenses in the optical system 1000 are required to have a mixed configuration of glass lenses and plastic lenses. By adopting these plastic lenses, the optical system 1000 can provide weight reduction and low cost because the thickness of the plastic lens may be reduced, and various aberrations such as spherical aberration and chromatic aberration may be well corrected due to the plastic lens. In addition, since the plastic lenses can provide aspherical lenses, the distortion portion of the peripheral region may be minimized.

The optical system 1000 may include n lenses, where n is an integer greater than or equal to 5, for example, 5 to 8. The ratio of the n lenses to the plastic material lenses and the glass material lenses may be in the range of 2:3 to 2:6 or 3:4 to 3:5.

The number of lenses of the second lens group LG2 may be greater than the number of lenses of the first lens group LG1, for example, may be more than 4 times or more than 5 times the number of lenses of the first lens group LG1. The first lens group LG1 may have 3 lenses or less. The first lens group LG1 may preferably be one lens. The second lens group LG2 may include two or more lenses. The second lens group LG2 may include four to seven lenses. The second lens group LG2 may preferably be six lenses.

The first lens group LG1 may include at least one lens made of glass. The first lens group LG1 may provide a lens closest to the object side as a lens made of glass. Such a glass material has a small amount of expansion and contraction change due to external temperature change, and the surface is not easily scratched, so that surface damage may be inhibited. The lens material of the second lens group LG2 may be a mixture of at least one lens made of glass and at least one lens made of plastic. In the second lens group LG2, at least one lens made of plastic may be arranged closer to the sensor side than the lens made of glass. The second lens group LG2 may include two or more lenses made of glass, for example, two to four lenses made of glass. As another example, the second lens group LG2 may have one or more lenses made of plastic. The second lens group LG2 may include two or more lenses made of plastic, for example, two to four lenses made of plastic.

At least one lens closest to the image sensor 300 in the optical system 1000 may be made of plastic. For example, at least two lenses closest to the image sensor 300 may be made of plastic, and preferably, at least three lenses adjacent to the image sensor 300 may be made of plastic. That is, since the nth, n−1th, and n−2th lenses in the optical system 1000 are arranged as plastic lenses, various aberrations may be corrected for the incident light of the image sensor 300. In the optical system 1000, at least two lenses closest to the object may be made of glass. Three or more lenses, for example, three to five lenses, closest to the object may be made of glass. Since the glass lenses have a smaller rate of contraction and expansion due to temperature change than the plastic lenses, the glass lenses may be placed in a region adjacent to the outside within the lens barrel.

Each of the lenses 121-127 may have an object-side surface and a sensor-side surface. The optical system may have a larger number of lenses having an aspherical sensor-side surface and an aspherical object-side surface than the number of plastic lenses. The optical system may have a smaller number of lenses having a spherical sensor-side surface and a spherical object-side surface than a lens having aspherical surfaces on both sides. Since the optical system 1000 has more aspherical lenses than spherical lenses, it may correct various aberrations. In the optical system 1000, a lens having a maximum refractive index may be positioned adjacent to the first lens group LG1 or the object. The maximum refractive index may be 1.7 or more. The color dispersion of light incident by the lens having the maximum refractive index may be increased, and the center thickness may be thinner than the edge thickness. In addition, since the lens having the maximum refractive index is positioned on the object side, the radius of curvature of the second and subsequent lenses may be easily changed, and the center thickness may be increased.

In the optical system 1000, the lens having the maximum effective diameter may be a lens close to the object side, or one of the lenses between the two lenses on the object side and the two lenses on the sensor side. Preferably, the lens having the maximum effective diameter may be positioned between lenses made of glass. The effective diameter may be the diameter of the effective region where effective light is incident from each lens. The effective diameter is the length in the direction X and Y orthogonal to the optical axis, and is the average of the effective diameter of the object-side surface of each lens and the effective diameter of the sensor-side surface. The embodiment of the invention may reduce the weight of the camera module by further mixing a plastic lens into the optical system 1000, provide a lower manufacturing cost, suppress the deterioration of optical characteristics due to temperature change, and various types of plastic lenses can replace glass lenses, and the polishing and processing of lens surfaces such as aspherical or free-form surfaces may be easily performed.

The TTL may be more than 2 times the ImgH, for example, more than 4 times and less than 12 times. The effective focal length EFL within the optical system 1000 is provided to be 10 mm or more and the FOV is provided to be less than 45 degrees, so that it may be provided as a standard optical system in a vehicle camera module. For example, the optical system and camera module according to the embodiment may be applied to a camera for an ADAS (Advanced driving assistance system) installed inside or outside a vehicle. The condition of TTL/(2*ImgH) may be 2.5 or more or 2.7 or more, and may be, for example, in the range of 2.5 to 5 or 3.5 to 5. By setting the value of TTL/(2*ImgH) to 2.5 or more and 5 times or less, a vehicle lens optical system may be provided. Accordingly, the optical system 1000 can provide an image without exaggeration or distortion for the formed image.

The effective diameter of at least one or all of the plastic lenses within the optical system 1000 may be smaller than the length of the image sensor 300. The number of lenses having an effective diameter larger than the length of the image sensor 300 within the optical system 1000 may be 50% or more or 60% or more, and the number of lenses having an effective diameter smaller than the length of the image sensor 300 may be less than 50% or less than 40%. The optical system 1000 may include at least one cemented lens 134 therein. The cemented lens 145 may be a lens in which at least two lenses having different refractive powers are cemented, and a distance between the two lenses may be less than 0.01 mm. The cemented lens 134 may be a lens in which two lenses having different focal lengths are bonded. The two lenses may be bonded using an adhesive. The effective diameter of at least one lens or all lenses arranged on the object side based on the cemented lens 134 may be larger than the length of the image sensor 300. The effective diameter of at least one lens arranged on the sensor side based on the cemented lens 134 may be smaller than the length of the image sensor 300. In addition, the object-side lens 123 among the cemented lenses 134 may be larger than the length of the image sensor 300, and the sensor-side lens 124 may be larger than the length of the image sensor 300. The lenses between the cemented lens 134 and the first lens 121 may be made of glass. The lenses arranged between the cemented lens 134 and the image sensor 300 may be made of plastic. The lenses between the cemented lens 134 and the first lens 121 may be lenses having spherical surfaces on both sides. The lenses arranged between the above-described cemented lens 134 and the image sensor 300 may be aspherical lenses on both sides. The both side surfaces are the object-side surface and the sensor-side surface. Therefore, by arranging the aspherical lenses between the cemented lens 134 and the image sensor 300, the optical performance may be improved by correcting the curvature aberration and the chromatic aberration.

The optical axis distance between the first lens group LG1 and the second lens group LG2 may be 1 time or less of the optical axis distance of the first lens group LG1, and may be, for example, in the range of 0.1 to 1 time of the optical axis distance of the first lens group LG1. The optical axis distance between the first lens group LG1 and the second lens group LG2 may be 0.2 times or less of the optical axis distance of the second lens group LG2, and may be, for example, in the range of 0.01 to 0.2 times. The sensor-side surface closest to the sensor side of the first lens group LG1 may be convex, and the object-side surface closest to the object of the second lens group LG2 may be convex. The first lens group LG1 may diffuse light incident through the object side, and the second lens group LG2 may refract light diffused through the first lens group LG1 into the region of the image sensor 300.

The first lens group LG1 may have negative (−) refractive power, and the second lens group LG2 may have positive (+) refractive power. The first lens 121 of the first lens group LG1 may have negative (−) refractive power, and the last lens of the second lens group LG2 may have negative (−) refractive power. When the focal length is expressed as an absolute value, the focal length of the first lens group LG1 may be greater than the focal length of the second lens group LG2, for example, 2 times or more, for example, 2 to 10 times. The effective focal length (EFL) of the optical system 1000 may be smaller than the absolute value of the focal length of the first lens group LG1. The EFL may be smaller than the absolute value of the focal length of the first lens group LG1 and greater than the absolute value of the focal length of the second lens group LG2.

The number of lenses having negative (−) refractive power on the optical system 1000 may be equal to or greater than the number of lenses having positive (+) refractive power. The number of lenses having negative (−) refractive power may be 50% or more of the total number of lenses. The average refractive index of the lenses having negative refractive power may be greater than the average of the lenses having positive refractive power. Accordingly, the dispersion value of lenses having positive refractive power may be greater than the dispersion value of lenses having negative refractive power.

The lens portion 100B may be a mixture of glass lenses and plastic lenses. The number of lenses made of plastic may be 60% or less of the total number of lenses, and may be in the range of 30% to 60% or 30% to 50%. Accordingly, when plastic lenses are further arranged in the camera module, the weight of the camera module may be reduced, and the camera module is easy to polish and process due to the plastic material, is resistant to external impacts, has high price competitiveness, and is easy to secure materials. In addition, various aberrations may be corrected by the plastic lens, so that optical performance degradation may be inhibited.

The lens portion 100B may include lenses made of a first material that are continuously aligned along the optical axis OA, and lenses made of a second material that are continuously aligned along the optical axis on the sensor side of the lenses made of the first material. The first material may be a glass material, and the second material may be a plastic material. The lens portion 100B may include a lens of the first material having an aspherical surface continuously aligned along the optical axis OA, lenses of the first material having a spherical surface continuously aligned along the optical axis on the sensor side of the lens having the spherical surface, and lenses of the second material having an aspherical surface continuously aligned along the optical axis on the sensor side of the lenses having the spherical surface. The first material may be a glass material, and the second material may be a plastic material.

The effective diameter of the lens closest to the object side in the lens portion 100B may be larger than the effective diameter of the lens closest to the image sensor 300. Accordingly, the brightness of the optical system may be controlled. The effective diameter may be an average effective diameter of the object-side surface and the sensor-side surface of each lens. By controlling the effective diameter size of each of the lenses, the optical system 1000 can control the incident light to compensate for the resolution and the deterioration of optical characteristics due to temperature changes, improve the chromatic aberration control characteristics, and improve the vignetting characteristics of the optical system 1000. The lens portion 100B may include a first lens 121, a second lens 122, a third lens 123, a fourth lens 124, a fifth lens 125, a sixth lens 126, and a seventh lens 127 aligned from the object side to the sensor side along the optical axis.

In the lens portion 100B, when the focal length is an absolute value, the focal length of the lens closest to the object may be greater than the focal length of the plastic lens. Here, the plastic lens may be at least one lens arranged on the sensor side of the cemented lens, or at least one lens adjacent to the image sensor. The focal length F1 of the first lens 121 may be the largest in the optical system and may be larger than the focal length (absolute value) of the second lens group LG2. That is, the following condition may satisfy: |FLG2|<F1.

When the focal length is expressed as an absolute value, the composite focal length of the lenses of the first material may be smaller than the composite focal length (absolute value) of the lenses of the second material. The first material may be a glass material and the second material. The composite focal length of the first to fourth lenses 121-124 may be smaller than the composite focal length (absolute value) of the fifth to seventh lenses 125-127. Here, the composite focal length of the lenses of the first material or the first to fourth lenses 121-124 may be larger than 0, and the composite focal length of the lenses of the second material or the fifth to seventh lenses 125-127 may be smaller than 0. Accordingly, the optical system 1000 in which the first and second material lenses are laminated may set the focal length.

In the center thickness CT of the lenses, for example, at least two or more of the glass lenses may have a center thickness greater than that of the plastic lenses. If the average of the center thicknesses of the glass lenses in the lens portion 100B is GL_{CT}_Aver and the average of the center thicknesses of the plastic lenses is PL_{CT}_Aver, the following condition may satisfy: GL_{CT}_Aver>PL_{CT}_Aver. In addition, the following condition may satisfy: 1.1<GL_{CT}_Aver/PL_{CT}_Aver<2.

The lens closest to the object in the lens portion 100B may have the largest refractive index, and the maximum refractive index may be 1.7 or more, for example, 1.75 or more. The refractive index of the lens closest to the object may be greater than the refractive index of the plastic lenses. The average of the refractive indices of the plastic lenses in the lens portion 100B may be less than 1.6, and the average of the refractive indices of the glass lenses may be 1.6 or more. In the lens portion 100B, if the average refractive index of the glass material lenses is GLn_Aver and the average refractive index of the plastic lenses is PLn_Aver, the following condition may satisfy: PLn_Aver<GLn_Aver. In addition, the following condition may satisfy: 1<GLn_Aver/PLn_Aver<1.2. In addition, the average refractive index difference may satisfy the following condition: GLn_Aver−PLn_Aver≥0.5. The lens(es) having a high refractive index are positioned on the object side of the plastic lens, thereby increasing color dispersion.

The average Abbe number of the glass material lenses in the lens portion 100B may be greater than the average Abbe number of the plastic lenses. The number of glass lenses having an Abbe number lower than the average Abbe number of the plastic material lenses in the lens portion 100B may be 2 or less, for example, 1. When the average Abbe number of the glass material lenses is GLv_Aver and the average Abbe number of the plastic lenses is PLv_Aver, the following condition may satisfy: PLv_Aver<GLv_Aver. In addition, the following condition may satisfy: 1<GLv_Aver/Plv_Aver<1.5. Lenses with low Abbe numbers can improve color dispersion at a location adjacent to the image sensor 300.

In the lens portion 100B, the number of lenses larger than the average effective diameter of the plastic lenses may be 3 or more, for example, 4 or more. When the average effective diameter of the plastic material lenses is PLca_Aver and the average effective diameter of the glass material lenses is GLca_Aver, the following condition may satisfy: PLca_Aver<GLca_Aver. In addition, the following condition may satisfy: 1<GLca_Aver/PLca_Aver<1.5. In addition, the relationship between the length of the image sensor 300 and the average effective diameter PLca_Aver of the plastic lens may satisfy the following condition: 1≤PLca_Aver/(ImgH*2)<1.5. In addition, the relationship between the average effective diameter of the glass material and the length of the image sensor 300 may satisfy the following condition: 1.1<GLca_Aver/(ImgH*2)<1.5. The difference between the maximum length of the image sensor 300 and the effective diameter of the plastic lens may be arranged not to be large. Accordingly, by arranging the plastic lens with a small effective diameter adjacent to the image sensor 300, the plastic lenses can disperse the color from the center to the periphery of the image sensor 300.

The average effective diameter of the glass materials may be 10 mm or more, for example, in the range of 10 mm to 15 mm. The average effective diameter of the plastic material may be 8 mm or more, for example, in the range of 8 mm to 12 mm. The lens having the minimum effective diameter may be made of plastic material, and the lens having the maximum effective diameter may be made of glass material. The minimum effective diameter within the lens portion 100B may be in the range of 7 mm to 10 mm, and the maximum effective diameter may be in the range of 11 mm to 15 mm. Accordingly, the optical system 1000 may improve the resolution and chromatic aberration control characteristics by controlling the incident light, and may improve the vignetting characteristics of the optical system 1000.

If the radius of curvature is described as an absolute value, the lens surface having the minimum radius of curvature with respect to the optical axis OA within the lens portion 100B may be the object-side surface of the first plastic lens among the plastic lenses. The lens surface having the minimum radius of curvature may be the object-side surface of the plastic lens closest to the glass lens. For example, the object-side surface of the n−2th lens may have the minimum radius of curvature within the lens portion 100B. Accordingly, the effective diameter can refract light into the effective region of plastic lenses smaller than the glass lens. The lens surface having the maximum radius of curvature within the lens portion 100B may be the sensor-side surface or the object-side surface of one of the plastic lenses arranged between the glass lens and the image sensor 300. In the case of two or more plastic lenses, the lens surface having the maximum radius of curvature may be the plastic lens having the smallest Abbe number or the largest refractive index among the plastic lenses, and may be, for example, the object-side surface of the n−1th lens. For example, the object-side surface of the n-th lens may have the maximum radius of curvature within the lens portion 100B.

The length of the image sensor 300 is the maximum length in the diagonal direction orthogonal to the optical axis OA, may be smaller than the effective diameter of the lens closest to the object within the first lens group LG1, and may be larger than the effective diameter of the lens closest to the sensor within the second lens group LG2. Here, the number of lenses having an effective diameter larger than the length of the image sensor 300 may be 4 to 6, and the number of lenses having an effective diameter smaller than the length of the image sensor 300 may be 1 to 3.

In the lenses arranged between the object and the aperture stop ST, the effective diameter of the lens surface tends to increase as it goes from the object side to the aperture stop. In the lens surfaces arranged between the aperture stop and the sensor, the effective diameter of the lens surfaces tends to decrease as it goes from the aperture stop to the sensor side. The meaning that the effective diameter of the lens surfaces tends to increase or decrease does not only mean the case where the effective diameter of the lens surfaces increases or decreases. For example, it also includes the case where the effective diameter of the lens surfaces increases and then decreases as it goes from the aperture stop to the sensor side. The lens surface on which the aperture stop is disposed is designed to have an effective diameter smaller than the effective diameter of the lens surface on the object side or the lens surface on the sensor side of the aperture stop. The lens surface on which the aperture stop is disposed is intended to more efficiently control and guide the amount of light in the optical system. In the case where the aperture stop is disposed on the object-side surface of the second lens as in the third embodiment, the following condition satisfies: effective diameter of the sensor-side surface of the second lens>effective diameter of the sensor-side surface of the first lens>effective diameter of the object-side surface of the second lens. The following condition satisfies: effective diameter of the sensor-side surface of the second lens<effective diameter of the object-side surface of the third lens>effective diameter of the object-side surface of the third lens.

The aperture stop ST may be arranged on the periphery of the object-side surface or the sensor-side surface of the lens closest to the object side among the lenses of the second lens group LG2. Alternatively, the aperture stop may be arranged on the periphery of the object-side surface or the sensor-side surface of the object-side lens of the first lens group LG1. Alternatively, at least one lens selected from among the plurality of lenses may perform the function of an aperture stop. In detail, the object-side or sensor-side surface of one lens selected from among the lenses of the optical system 1000 can serve as an aperture stop for controlling the amount of light.

In the optical system 1000 of the third embodiment, the sum of the refractive indices of the lenses of the lens portion 100B may be 8 or more, for example, in the range of 8 to 15, and the average of the refractive indices may be in the range of 1.58 to 1.7. The sum of the Abbe numbers of each of the lenses may be 220 or more, for example, in the range of 220 to 350, and the average of the Abbe numbers may be 55 or less, for example, in the range of 31 to 55. The sum of the center thicknesses of the entire lenses may be 17 mm or more, for example, in the range of 20 mm to 35 mm, and the average of the center thicknesses may be in the range of 2.8 mm to 5 mm. The sum of the center distances between the lenses on the optical axis OA may be 4.5 mm or more, for example, in the range of 4.5 mm to 9 mm, and may be smaller than the sum of the center thicknesses of the lenses. In addition, the average value of the effective diameter of each lens surface S1-S14 of the lens portion 100B may be provided as 8 mm or more, for example, in the range of 8 mm to 15 mm.

In the optical system according to the third embodiment, the field of view (diagonal FOV) may be 50 degrees or less, for example, in the range of 20 degrees to 50 degrees. The F number of the optical system or the camera module may be 2.4 or less, for example, in the range of 1.4 to 2.4 or in the range of 1.5 to 1.8. In the optical system according to the third embodiment of the invention, the maximum field of view (diagonal FOV) may be 50 degrees or less, for example, in the range of 20 degrees to 50 degrees. The vehicle optical system may have a horizontal field of view FOV_H in the Y-axis direction that is greater than 20 degrees and less than 40 degrees, for example, in the range of 25 degrees to 35 degrees. In addition, the vertical field of view is provided at a smaller angle than the horizontal field of view, and may be less than 20 degrees, for example, in the range of 10 to 20 degrees. At this time, the sensor length in the horizontal direction Y may be 8.064 mm±0.5 mm, and the sensor height in the vertical direction X may be 4.54 mm±0.5 mm. The horizontal field of view FOV_H is a field of view based on the horizontal length of the sensor. Accordingly, it is possible to suppress the change in the focus position due to temperature change, and it may be provided as a vehicle camera in which various aberrations are well corrected.

Since the third embodiment is an optical system applied to a vehicle camera, even if it is designed using a plastic lens and a glass lens together, the first lens 121 may be provided as a glass material. This has the advantage that the glass material is more resistant to scratches than the plastic material and is not sensitive to external temperature. In order to more effectively inhibit scratches caused by foreign substances or when placed inside a vehicle, a glass lens is used as the first lens 121, and the object-side surface of the first lens 121 may have a concave shape so as not to come into contact with external structures. If the object-side surface of the first lens 121 is designed to have a convex shape, scratches may occur due to contact with external structures. For driver monitoring during vehicle operation, front/rear photography of the vehicle, lane detection, and detection of unexpected objects around the vehicle, the field of view may be more than 20 degrees and less than 40 degrees, for example, in the range of 25 degrees to 35 degrees. This horizontal field of view may be an angle preset for an advanced driver assistance system (ADAD). The optical system 1000 according to the third embodiment may further include a reflective member (not shown) for changing the path of light. The reflective member may be implemented as a prism that reflects incident light of the first lens group LG1 toward the lenses. Hereinafter, the optical system according to the third embodiment will be described in detail.

Referring to FIGS. 21 to 24, the lens portion 100B may include a first lens 121 to a seventh lens 127. The first lens 121 may be a first lens group LG1, and the second to seventh lenses 122, 123, 124, 125, 126, and 127 may be a second lens group LG2. The aperture stop ST may be disposed around the object-side surface of the second lens 122.

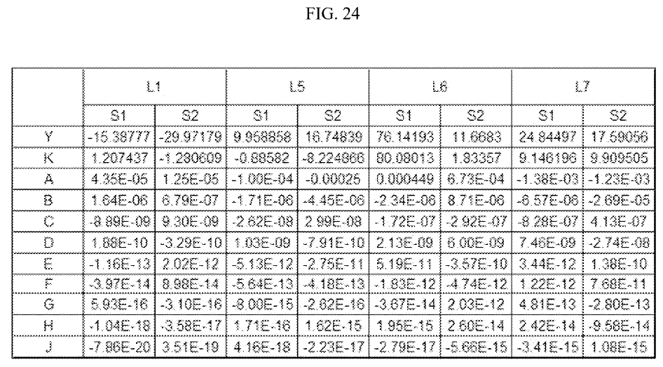

The first lens 121 may have positive (+) or negative (−) refractive power on the optical axis OA. The first lens 121 may have negative (−) refractive power. The first lens 121 may include a plastic material or a glass material, and may be, for example, a glass material. The first lens 121 made of a glass material may reduce changes in the center position and the radius of curvature due to temperature changes in the surrounding environment, and may protect the incident side surface of the optical system 1000. The first surface S1 of the first lens 121 may be concave on the optical axis, and the second surface S2 may be convex. The first lens 121 may have a meniscus shape convex toward the sensor. Differently, the first surface S1 may have a convex shape on the optical axis OA, and the second surface S2 may have a concave shape. The first lens 121 may be made of a glass material and may have an aspherical surface. The aspherical coefficients of the first and second surfaces S1 and S2 may be provided as S1 and S2 in L1 of FIG. 24. The first lens 121 may be manufactured as a lens having an aspherical surface by injection molding a glass material. Since the first lens 121 is provided as an aspherical glass material, the glass material having high transmittance and refractive index has an aspherical surface, so that the number of lenses in the optical system may be reduced. The number of lenses made of an aspherical glass material in the optical system 1000 may be smaller than the number of plastic lenses. The effective radius r11 of the first lens 121 may be larger than the effective radius of the plastic lenses. Alternatively, at least one of the object-side surface and the sensor-side surface of the first lens 121 may have a free surface, i.e., a non-rotationally symmetrical surface.

Since the first surface S1 of the first lens 121 is concave and the second surface S2 is convex, the incident light may be refracted in a direction away from the optical axis OA, and the distance between the first and second lenses 121 and 122 may be reduced. In addition, the effective diameter of the sensor-side surface of the second lens 122 may be designed to be larger than the effective diameter of the object-side surface by the shape of the lens surface of the first lens 121. The first surface S1 of the first lens 121 may be provided without a critical point from the optical axis OA to the end of the effective region, i.e., the edge. The second surface S2 of the first lens 121 may be provided without a critical point.

The refractive index Nd1 of the first lens 121 may satisfy the following condition: Nd1>1.7 or Nd1>1.75. Since the refractive index Nd1 of the first lens 121 is the largest within the lens portion 100B, the radius of curvature of the first and second lenses 121 and 122 may be increased, and lens manufacturing may be facilitated. If the refractive index Nd1 of the first lens 121 is smaller than the above condition, the lens surface must be formed sharply concave or convex in order to increase the refractive power of the first and second lenses 121 and 122, and in this case, lens manufacturing is not easy, the lens defect rate increases, and it can cause a decrease in yield.

The second lens 122 may be arranged between the first lens 121 and the third lens 123. The second lens 122 may have positive (+) refractive power. The second lens 122 may be provided with a glass material. On the optical axis OA, the third surface S3 of the second lens 122 may be convex, and the fourth surface S4 may be convex. The first lens 121 may have a shape in which both sides are convex. The second lens 122 may be made of glass and may be spherical, and the third surface S3 and the fourth surface S4 may be spherical.

Since both sides of the second lens 122 are provided convexly, the TTL and the number of lenses of the optical system may be minimized, and light may be effectively refracted. The second lens 122 may satisfy the following condition: L2R1>| L2R2|. When this condition is satisfied, light is efficiently refracted by the fourth surface S4, and the effective diameter of the fourth to seventh lenses 124 to 127 may be guided so as not to increase, and the TTL may be reduced. If the following condition satisfies: L2R1<|L2R2|, a lot of aberration may occur on the object-side surface of the second lens 122, the light refractive efficiency may decrease on the sensor-side surface, the effective diameter of the rear lenses may increase, and the TTL may also increase.

Since the first lens 121 having a large refractive index and a small Abbe number and the second lens 122 having a small refractive index and a large Abbe number are laminated, the chromatic aberration of the optical system may be corrected. In addition, in order to reduce aberration caused by the spherical refractive surface of the second lens 122, the refractive surface of the first lens 121 may be provided as an aspherical surface.

The aperture stop ST may be disposed around the object-side third surface S3 of the second lens 122. Since the second lens 122 adjacent to the sensor side of the aperture stop has a positive refractive power (F2>0), the second lens 122 may refract incident light in the direction of the optical axis, and may suppress an increase in the effective diameter of the sensor-side or rear-side lenses of the second lens 122. Accordingly, the yield by weight of the optical system may be inhibited from being lowered by the second lens 122 and the production efficiency may be improved. Here, the composite focal length of the second to seventh lenses 122-127 arranged on the sensor side of the aperture stop may have a positive value, and the TTL may be reduced within the field of view range.

The third lens 123 may have positive (+) refractive power. The third lens 123 may be provided with a glass material. The fifth surface S5 of the third lens 123 on the optical axis may be convex, and the sixth surface S6 may be convex. The third lens 123 may have a shape in which both sides are convex on the optical axis OA. Differently, the third lens 123 may have a meniscus shape that is convex on the object side or the sensor side. Or, the third lens 123 may have a shape in which both sides are concave on the optical axis. The third lens 123 may be made of glass and may be spherical, and the fifth surface S5 and the sixth surface S6 may be spherical.

The fourth lens 124 may have positive (+) or negative (−) refractive power on the optical axis OA. The fourth lens 124 may have negative (−) refractive power that is different from the refractive power of the third lens 123. The fourth lens 124 may include a plastic or glass material. For example, the fourth lens 124 may be provided as a glass material. The seventh surface S7 on the object side of the fourth lens 124 in the optical axis may be concave, and the eighth surface S8 on the sensor side may be concave. The fourth lens 124 may be concave on both sides. In this way, the fourth lens 124 may have a convex meniscus shape toward the object side or the sensor side. In this way, the fourth lens 124 may have a shape in which both sides are convex on the optical axis OA. The fourth lens 124 may be made of glass and may have a spherical surface, and the seventh surface S7 and the eighth surface S8 may be spherical.

The third lens 123 and the fourth lens 124 may be bonded. The bonding surface between the third lens 123 and the fourth lens 124 may be defined as the sixth surface S6. The sixth surface S6 may be the same surface as the seventh surface of the fourth lens 124. The object-side surface of the cemented lens 134 may be convex, and the sensor-side surface may be concave. The distance between the third and fifth lenses 123 and 124 may be less than 0.01 mm and may be bonded with an adhesive. The distance between the third and fourth lenses 123 and 124 may be less than 0.01 mm from the optical axis OA to the end of the effective region. The third and fourth lenses 123 and 124 may have opposite refractive powers. The composite refractive power of the third and fourth lenses 123 and 124 may have positive refractive power.

The product of the refractive power of the object-side third lens 123 of the cemented lens 134 and the refractive power of the sensor-side fourth lens 124 may be less than 0. The product of the focal length of the object-side third lens 123 of the cemented lens 134 and the focal length of the sensor-side fourth lens 124 may be less than 0. Accordingly, the aberration characteristics of the optical system may be improved. If the refractive powers of the two lenses of the cemented lens 134 are the same, there is a limit to the improvement of aberration.

The composite refractive power of the cemented lens 134 has a positive refractive power, and the second lens 122 on the object side and the sixth lens 126 on the sensor side based on the cemented lens 134 may have positive refractive power. Accordingly, the second lens 122, the cemented lens 134, and the fifth lens 125 can refract some of the incident light in the direction of the optical axis, and can mutually correct chromatic aberration. The effective diameter of the third lens 123 may be larger than the diagonal length of the image sensor 300. The effective diameter of the third lens 123 is the average of the effective diameters of the seventh surface S7 and the sixth surface S6, and may be larger than the diagonal length of the image sensor 300. The effective diameter of the fourth lens 124 may be smaller than that of the third lens 123 and larger than the diagonal length of the image sensor 300.

If the effective diameter of the fifth surface S5 of the third lens 123 is CA31 and the effective diameter of the sixth surface S6 is CA32, the effective diameters of the fifth and sixth surfaces S5 and S6 may satisfy the following condition: 0.5<CA31/CA32<1. If the effective diameter of the seventh surface S8 of the fourth lens 124 is CA41 and the effective diameter of the eighth surface S8 is CA42, the effective diameters of the seventh and eighth surfaces may satisfy the following condition: 1<CA41/CA42<1.5. The cemented lens 134 is bonded with glass lenses having different refractive indices and has a spherical refractive surface. If the lenses disposed on the sensor side than the cemented lens 134 are aspherical lenses or plastic lenses, spherical aberration may be compensated. In addition, since the lenses disposed on the sensor side than the cemented lens 134 are plastic lenses and are disposed as lenses with small effective diameters, light traveling through the plastic lens to the image sensor 300 may be effectively guided. Since the position of the cemented lens 134 is located in the middle or in front of the middle in the lens portion 100B, chromatic aberration correction may be more efficient.

The fifth lens 125 may have positive (+) refractive power. The fifth lens 125 may include a plastic or glass material. For example, the fifth lens 125 may be provided with a plastic material. On the optical axis OA, the object-side ninth surface S9 of the fifth lens 125 may be convex, and the sensor-side tenth surface S10 may be concave. Alternatively, the fifth lens 125 may have a convex shape on both sides. The fifth lens 125 may be made of a plastic material and may have an aspherical surface. At least one of the ninth surface S9 and the tenth surface S10 may be aspherical, for example, both the ninth surface S9 and the tenth surface S10 may be aspherical. Aspherical coefficients of the ninth surface and the tenth surface S10 may be provided as L5S1 and l5S2 of FIG. 24. At least one or both of the ninth and tenth surfaces S9 and S10 of the fifth lens 125 may be provided without a critical point from the optical axis OA to the end of the effective region.

The sixth lens 126 may have positive (+) or negative (−) refractive power on the optical axis OA. The sixth lens 126 may have negative (−) refractive power. The sixth lens 126 may include a plastic or glass material. For example, the sixth lens 126 may be provided with a plastic material. The eleventh surface S11 on the object side of the sixth lens 126 on the optical axis OA may be convex, and the twelfth surface S12 on the sensor side may be concave. Differently, the sixth lens 126 may have a convex shape on both sides. Alternatively, the sixth lens 126 may have a convex meniscus shape toward the sensor. At least one or both of the eleventh surface S11 and the twelfth surface S12 may be aspherical. The aspherical coefficients of the eleventh and twelfth surfaces S11 and S12 may be provided as L1 and L2 of L6 of FIG. 24. Alternatively, at least one of the object-side surface and the sensor-side surface of the sixth lens 126 may have a free-form surface, i.e., a non-rotationally symmetrical surface.

The eleventh and twelfth surfaces S11, S12 of the sixth lens 126 may be provided without a critical point from the optical axis OA to the end of the effective region. When the twelfth surface S12 has a critical point, it may be located at 70% or more of the effective radius r62 from the optical axis OA, or in a range of 70% to 90%, or in a range of 75% to 85%.

The seventh lens 127 may have negative (−) refractive power. The seventh lens 127 may include a plastic or glass material. For example, the seventh lens 127 may be made of a plastic material. The object-side thirteenth surface S13 of the seventh lens 127 on the optical axis may be convex, and the sensor-side fourteenth surface S14 may be concave. The seventh lens 127 may have a meniscus shape convex toward the object side. Alternatively, the thirteenth surface S13 may have a convex shape and the fourteenth surface S14 may have a concave shape in the optical axis OA. At least one surface among the thirteenth surface S13 and the fourteenth surface S14 may be aspherical. For example, both the thirteenth surface S13 and the fourteenth surface S14 may be aspherical. Aspherical coefficients of the thirteenth and fourteenth surfaces S13 and S14 may be provided as S1 and S2 of L7 of FIG. 24. Alternatively, at least one of the object-side surface and the sensor-side surface of the seventh lens 127 may have a free surface, i.e., a non-rotationally symmetrical surface.

The seventh lens 127 may be a plastic lens that is closest to the image sensor 300. In addition, by arranging two or more of the plastic lenses adjacent to the image sensor 300, aberrations such as spherical aberration and chromatic aberration may be improved by the lens surface having an aspherical surface, and the influence on the resolution may be controlled. In addition, by arranging the plastic lens as the lens adjacent to the image sensor 300, it may be insensitive to the assembly tolerance compared to the glass lens. In other words, being insensitive to the assembly tolerance means that even if the assembly is slightly different from the design during assembly, it may not significantly affect the optical performance. In addition, by providing three lenses 125, 126, and 127 adjacent to the image sensor 300 as plastic materials, the optical performance may be improved by the lens surface having an aspherical surface, and for example, aberration characteristics may be improved and resolution deterioration may be inhibited.

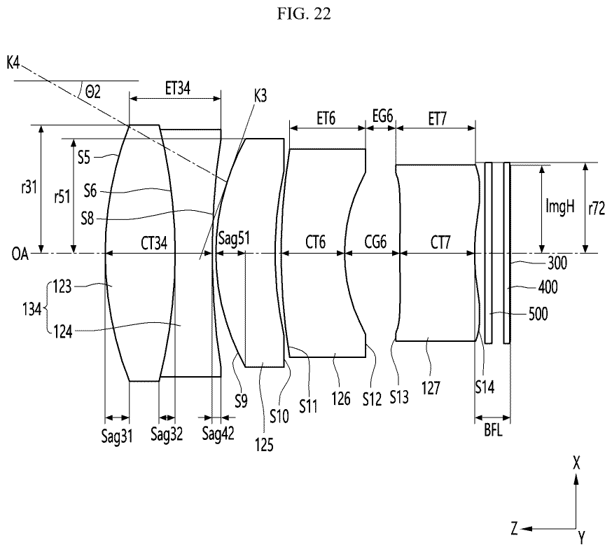

Referring to FIG. 22, BFL is an optical axis distance from the image sensor 300 to the center of the sensor-side surface of the seventh lens 127. At least one or both of the thirteenth surface S13 and the fourteenth surface S14 of the seventh lens 127 may have a critical point. The thirteenth surface S13 of the seventh lens 127 may have a first critical point P1 from the optical axis OA to an end of the effective region. The first critical point P1 of the thirteenth surface S13 may be located at 55% or more of the effective radius from the optical axis OA, or in a range of 55% to 75%, or in a range of 60% to 70%. The first critical point of the thirteenth surface S13 may be located at a distance of 2.2 mm or more from the optical axis OA, for example, in a range of 2.2 mm to 3.5 mm or a distance of 2.5 mm to 3.2 mm. As another example, the thirteenth surface S13 may be provided without a critical point. The thirteenth surface S13 having such a first critical point P1 may refract incident light to the center and the periphery, and may improve aberration. The first and second critical points P1 and P2 may be points at which signs of gradient values with respect to the optical axis OA and the direction perpendicular to the optical axis OA change from positive (+) to negative (−) or from negative (−) to positive (+), and may mean points at which the gradient value is 0. In addition, the first and second critical points P1 and P2 may be points where the slope value of the tangent passing through the lens surface increases and decreases, or points where it decreases and then increases.

The fourteenth surface S14 of the seventh lens 127 may have at least one second critical point P2 from the optical axis OA to the end of the effective region. The second critical point P2 of the fourteenth surface S14 may be located at a distance of 60% or more of the effective radius r72 from the optical axis OA, or in a range of 60% to 80% or in a range of 65% to 75%. The second critical point P2 of the fourteenth surface S14 may be located at a distance of 2.9 mm or more from the optical axis OA, for example, in a range of 2.9 mm to 3.9 mm or in a range of 3.1 mm to 3.7 mm. Accordingly, the second critical point P2 is disposed closer to the edge than the first critical point P1, so that the seventh lens 127 can refract the incident light to the periphery of the image sensor 300.

The effective radius r51 of the ninth surface S9 of the fifth lens 125 made of the plastic material may be smaller than the radius of curvature r31 of the fifth surface S5 of the third lens 123. The effective radius r71 of the fourteenth surface S14 of the seventh lens 127 may be smaller than the effective radius r51 of the ninth surface S9. The average effective radius of the thirteenth and fourteenth surfaces S13 and S14 of the seventh lens 127 is arranged to be smaller than ImgH, which is ½ of the diagonal length of the image sensor 300, so that light may be refracted to the periphery of the image sensor 300 by the fourteenth surface S14 having the second critical point P2.

A tangent line K3 passing through an arbitrary point of the ninth surface S9 of the fifth lens 125 and a normal line K4 perpendicular to the tangent line K3 may have a predetermined angle θ2 with the optical axis OA or an axis parallel thereto. The maximum tangent angle θ2 on the ninth surface S14 may be 45 degrees or less, for example, a range of 5 degrees to 43 degrees or a range of 13 degrees to 33 degrees. The angle between the normal line perpendicular to the tangent passing through any point on each of the thirteenth surface S13 and the fourteenth surface S14 of the seventh lens 127 and the optical axis or the axis parallel thereto may be 10 degrees or less. The seventh lens 127 has a low refractive index of less than 1.6, a high Abbe number of 45 or more, and a focal length whose absolute value is set to the largest, so that the incident light may be refracted toward the image sensor 300. Accordingly, the seventh lens 127 can compensate for aberration occurring between plastic lenses and improve aberration by the aspherical surface. The angle between the normal line perpendicular to the tangent passing through any point on the eleventh surface S11 of the sixth lens 126 and the optical axis may be 25 degrees or less, and may be greater than the angle on the thirteenth and fourteenth surfaces S13 and S14.

The angle between the normal line perpendicular to the tangent passing through any point on the twelfth surface S12 of the sixth lens 126 and the optical axis may be 10 degrees or more, for example, in the range of 10 degrees to 43 degrees. Since the sixth lens 126 has a higher refractive index than the fifth and seventh lenses 125 and 127 and the radius of curvature of the twelfth surface S12 is smaller than the radius of curvature of the eleventh surface S11, the twelfth surface S12 can refract light incident through the eleventh surface S11 toward the image sensor 300. The difference in the radius of curvature between the twelfth surface S12 and the eleventh surface S11 may be the largest in the optical system.

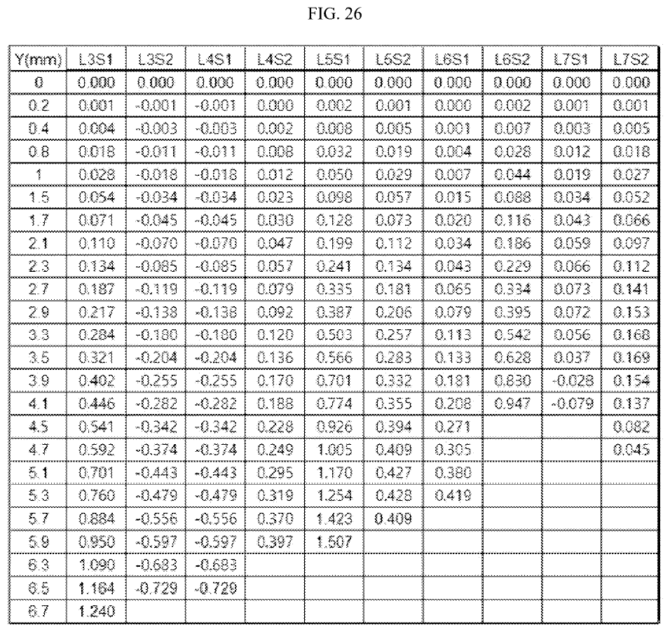

As shown in FIG. 22 and FIG. 26, Sag31 represents a height from the center of the fifth surface S5 of the third lens 123 to the lens surface in the direction X and Y orthogonal to the optical axis OA, and the maximum value of Sag31 may be the height at the edge of the fifth surface S5. Sag32 represents a height from the center of the sixth surface S6 of the third lens 123 to the lens surface in the direction X and Y orthogonal to the optical axis OA, and the maximum value of Sag32 may be the height at the edge of the sixth surface S6. Sag42 represents a height from the center of the eighth surface S8 of the fourth lens 124 to the lens surface in the direction X and Y orthogonal to the optical axis OA, and the maximum value of Sag42 may be the height at the edge of the eighth surface S8. Sag51 represents the height from the center of the ninth surface S9 of the fifth lens 125 to the lens surface in the direction X and Y orthogonal to the optical axis OA, and the maximum value of Sag51 may be the height at the edge of the ninth surface S9. Sag52 (not shown) represents the height from the center of the tenth surface S10 of the fifth lens 125 to the lens surface in the direction X and Y orthogonal to the optical axis OA, and the maximum Sag value is the height at the edge. The maximum Sag values may satisfy the following: The following condition may satisfy: Max_Sag42<Max_Sag32<Max_Sag31.

The following condition may satisfy: Max_Sag52<Max_Sag31<Max_Sag51.

The difference between Max_Sag42 and Max_Sag52 may be 0.3 or less, and the difference between Max_Sag51 and Max_Sag31 may be 0.5 or less. By setting the Sag value between the adjacent glass lens and the plastic lens, the optical loss between the glass lens and the plastic lens may be reduced.

In FIG. 26, if the Sag value is positive, the lens surface is located on the sensor side based on a straight line orthogonal to the optical axis OA, and if the Sag value is negative, the lens surface is located on the object side based on a straight line orthogonal to the optical axis OA. In addition, when comparing the object-side surface and the sensor-side surface of each lens, the object-side surface and the sensor-side surface of the seventh lens 127 may be the surfaces with the smallest difference between the maximum and minimum Sag values. This means that the distance between the object-side surface and the sensor side of the seventh lens 127 is constant, and the average of the curvature radii may be larger than the average of the curvature radii of other lenses.

As shown in FIGS. 21 and 22, the center thickness of the first to seventh lenses 121 to 127 is represented by CT1 to CT7, the edge thickness at the end of the effective region of each lens is represented by ET1 to ET7, the center distance (center gap) between two adjacent lenses is represented by CG1 to CG6, and the edge distance between the edges of each lens is represented by EG1 to EG6. Here, the center thickness of the cemented lens 134 is CT34, and the edge thickness is represented by ET34.

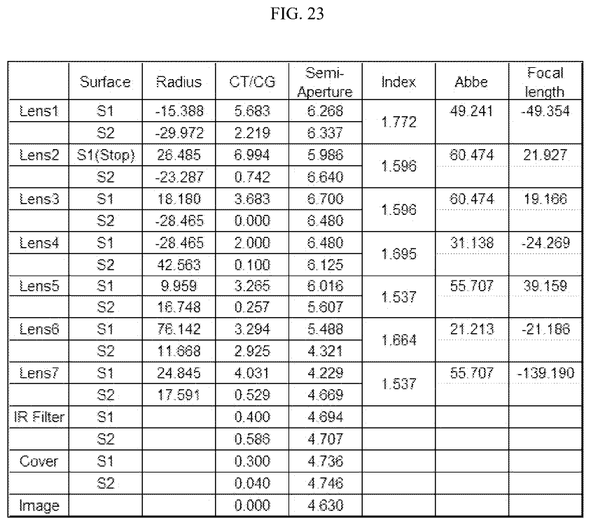

FIG. 23 is an example of lens data of the optical system of the third embodiment of FIG. 21. As shown in FIG. 23, the radius of curvature, the thickness of the lens, the center distance between the lenses, the refractive index at the d-line, the Abbe number, and the size of the effective diameter may be set on the optical axis OA of the first to seventh lenses 121 to 127.

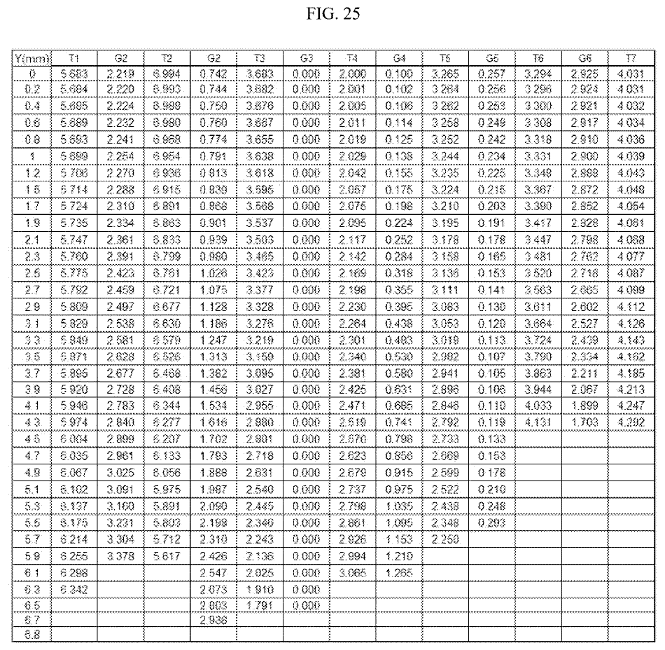

As shown in FIG. 24, among the lenses of the lens portion 100B of the third embodiment, the lens surfaces of the first, fifth, sixth, and seventh lenses 121, 125, 126, and 127 may include aspherical surfaces having a 30th-order aspherical coefficient. For example, the first, fifth, sixth, and seventh lenses 121, 125, 126, and 127 may include lens surfaces having a 30th-order aspherical coefficient. As shown in FIG. 25, the thicknesses T1-T7 of the first to seventh lenses 121-127 and the distances G1-G6 between adjacent two lenses may be set, and the thicknesses T1-T7 of each lens in the Y-axis direction may be expressed at intervals of 0.1 mm or 0.2 mm or more from the optical axis, and the distances G1-G6 between each lens may be expressed at intervals of 0.1 mm or 0.2 mm or more from the optical axis.

Referring to FIGS. 23 and 25, when comparing the absolute values of the curvature radii of each lens, the curvature radii of the eleventh surface S11 of the sixth lens 126 on the optical axis OA may be the largest among the lenses, and the curvature radii of the ninth surface S9 of the fifth lens 125 may be the smallest among the lenses. The difference between the maximum curvature radii and the minimum curvature radii may be 5 times or more, for example, 5 to 15 times. The difference between the curvature radii of the object-side surface and the sensor-side surface of each of the first to fourth lenses 121 to 124 made of glass may be 40 or less or 30 or less. Accordingly, spherical aberration between the lenses made of glass may be minimized.

Since the curvature radii of the ninth surface S9 of the fifth lens 125 are arranged to be the smallest, light incident through the glass lenses may be refracted toward the region of the image sensor 300. The difference in the radius of curvature of the object-side surface and the sensor-side surface of the sixth lens 126 is more than 40, and may be the largest within the lens portion 100B. The sixth lens 126 may compensate for the aberration occurring between the fifth lens 125 and the seventh lens 127 made of plastic. Here, the radius of curvature of each lens is the average of the radius (absolute value) of curvature of the object-side surface and the sensor-side surface of each lens.

When comparing the center thicknesses of each lens, the center thicknesses CT1, CT2, and CT34 of the first lens 121, the second lens 123, and the cemented lens 134 may be larger than the center thicknesses CT5, CT6, and CT7 of the fifth to seventh lenses 125, 126, and 127. In other words, the center thickness of the plastic material may be larger than the center thicknesses of the glass lenses that are spaced apart from each other. Accordingly, the weight reduction and optical performance such as aberration of the camera module may be improved by the aspheric surface and thin center thickness of the plastic lens. Here, the center thickness of the fourth lens 124 of the cemented lens 134 may be thinner than the center thickness of the plastic lenses.

The edge thicknesses ET1, ET2, and ET34 of the first lens 121, the second lens 123, and the cemented lens 134 may be greater than the edge thicknesses ET5, ET6, and ET7 of the fifth to seventh lenses 125, 126, and 127. That is, the edge thickness of the plastic material may be greater than the edge thicknesses of the glass lenses that are spaced apart from each other. Accordingly, the weight reduction and optical performance such as aberration of the camera module may be improved by the aspheric surface and thin edge thickness of the plastic lens. Here, the edge thickness of the third lens 124 of the cemented lens 134 may be thinner than the center thickness of the plastic lenses.

The center thickness CT2 of the second lens 122 is the largest among the lenses, and the center thickness CT5 of the fourth lens 124 is the smallest among the lenses. Excluding the cemented lens, any one of the fifth and sixth lenses 125 and 126 among the lenses may have the minimum center thickness. Among the spaced lenses, the maximum center thickness may be at least twice the minimum center thickness, and the difference between the maximum center thickness and the minimum center thickness may be at least 2 mm. That is, even if the plastic material lenses provide a thin center thickness, the optical performance may not be degraded, and the thickness of the camera module may be provided slimly.

When explaining the center distance CG between the lenses, the center distance CG6 between the sixth lens 126 and the seventh lens 127 is maximum and is greater than the center distance CG1 between the first and second lenses 121 and 122. The center distance between the fourth and fifth lenses 124 and 125 may be minimum. Here, the minimum center distance excludes the bonding surface of the cemented lens 145. The difference between the maximum center distance and the minimum center distance may be 1.5 mm or more, for example, in the range of 1.5 mm to 2.9 mm. In addition, by providing the maximum center distance between the lenses to be 70% or less of the maximum center thickness, for example, in the range of 30% to 70%, it is possible not to increase the thickness of the camera module using the plastic lens having a thin thickness without increasing the center distance compared to the center thickness of each lens.

In terms of the effective diameter, the lens having the maximum effective diameter may be arranged between the first lens 121 closest to the object and the seventh lens 127 closest to the image sensor 300. The lens having the maximum effective diameter may be a glass lens. The lens having the maximum effective diameter may be arranged between the first lens 121 and the plastic lens. The lens having the maximum effective diameter may be arranged between the glass lenses, and may be, for example, the third lens. Here, the effective diameter is an average of the effective diameters of the object-side surface and the sensor-side surface of each lens. The lens surface having the maximum effective diameter may be the third surface S3 of the third lens 123 or the object-side surface of the cemented lens 134. The lens having the minimum effective diameter may be any one of the plastic lenses, and may be, for example, the seventh lens adjacent to the image sensor 300. For example, the effective diameter of the seventh lens 127 may be the minimum within the lens portion 100B. The lens surface having the minimum effective diameter may be the thirteenth surface S13 of the seventh lens 127. The effective diameter of each of the lenses made of glass may be larger than the effective diameter of each of the lenses made of plastic. For example, the effective diameter of each of the first to fourth lenses 121-124 may be larger than the effective diameters of the fifth, sixth, and seventh lenses 125, 126, and 127. The effective diameters of the first to fourth lenses 121-124 may be larger than the diagonal length of the image sensor 300. The average effective diameter of the seventh lens 127 may be smaller than the diagonal length of the image sensor 300. Accordingly, the lens made of plastic may guide light incident through the lens made of glass to the image sensor 300. Here, the average of the center thicknesses of the first to seventh lenses 121-127 may be greater than the center thickness of each of the plastic lenses, for example, the fifth, sixth, and seventh lenses 125, 126, and 127. The average of the effective diameters of the first to seventh lenses 121-127 may be greater than the effective diameters of each of the plastic lenses, for example, the fifth, sixth, and seventh lenses 125, 126, and 127.

In terms of the refractive index, the refractive index of the first lens 121 may be the maximum among the lenses and may be greater than 1.7, for example, greater than 1.75. Either one or both of the fifth and seventh lenses 125 and 127 may have the minimum refractive index among the lenses. The difference between the maximum refractive index and the minimum refractive index may be 0.2 or more. By providing a high refractive index lens made of glass closest to an object, and providing a low refractive index lens made of plastic as the lens closest to the glass lens and the lens adjacent to the image sensor 300, the incidence efficiency is increased, and the refractive power between the glass lens and the plastic lens may be adjusted to guide it to the image sensor 300. When comparing the Abbe numbers, the Abbe number of one or both of the second and third lenses 122 and 123 is the largest among the lenses and may be 57 or more. The Abbe number of the sixth lens 126 is the smallest among the lenses. The difference between the maximum refractive index and the minimum Abbe number may be 36 or more. By making the Abbe number of the second lens 122 adjacent to the aperture stop the largest and providing the Abbe number of the sixth lens 127 with a low refractive index adjacent to the image sensor 300 the smallest, the color dispersion of light traveling between the glass lenses may be controlled and the color dispersion between the glass and plastic lenses may be increased to guide it to the image sensor 300.

The focal lengths F1, F4, F6, and F7 of the first, fourth, sixth, and seventh lenses 121, 124, 126, and 127 have negative refractive power, and the focal lengths F2, F3, and F5 of the second, third, and fifth lenses 122, 123, and 125 may have positive refractive power. In addition, the fifth lens 125 and the sixth lens 126, which are adjacently arranged lenses, may satisfy the following conditions.

Refractive index of lens with positive refractive power<Refractive index of lens with negative refractive power Condition 1:

Dispersion of lens with positive refractive power>Dispersion of lens with negative refractive power Condition 2:

Here, among the plastic lenses, the fifth lens 125 has positive refractive power and the sixth lens 126 has negative refractive power, so according to the conditions 1 and 2, the refractive index of the fifth lens is smaller than the refractive index of the sixth lens, and the dispersion value of the fifth lens is larger than the dispersion value of the sixth lens. The chromatic aberration occurring in the plastic lens may be corrected by the plastic lens. In addition, by satisfying the refractive index difference between the fifth lens 125 and the sixth lens 126, which are plastic lenses arranged in succession, of 0.1 or more and 0.15 or less and the Abbe number difference of 20 or more and 60 or less, the chromatic aberration occurring in the plastic lens may be compensated by the plastic lens. The optical system generates chromatic aberration and corrects chromatic aberration by using a cemented lens or two lenses arranged in series. The lens contracts and expands repeatedly as the temperature changes from low to high. Since the lens characteristics of lenses of the same material change the same amount according to the temperature change, it is effective to correct chromatic aberration between lenses of the same material even when the temperature changes.

In the third embodiment, the chromatic aberration occurring in a glass lens is corrected by the third lens 123 and the fourth lens 124, and the chromatic aberration occurring in a plastic lens is corrected by using the fifth lens 125 and the sixth lens 126.

The refractive index difference between the third lens 123 and the fourth lens 124 is 0.1 or more and 0.15 or less, and the Abbe number difference satisfies the range of 20 to 60, so that the chromatic aberration occurring in the plastic lens may be compensated for by the plastic lens. The refractive index difference is rounded to the third decimal place, and the Abbe number difference is rounded to the first decimal place, and the values are compared. In addition, by arranging glass lenses with relatively high Abbe numbers on the object side of the plastic lenses, color dispersion by the glass lenses may be reduced and color dispersion by the plastic lenses may be increased.

When comparing the focal lengths in absolute values, the focal length of the seventh lens 127 is the largest among the lenses, and may be 55 or more or 100 or more. Among the lenses except for the cemented lens 134, the lens having the minimum focal length may be the sixth lens 126. The difference between the maximum focal length and the minimum focal length may be 50 or more or 80 or more. Accordingly, it may have improved MTF characteristics, aberration control characteristics, resolution characteristics, etc. in the field of view range set in the optical system, and may have good optical performance in the periphery of the field of view. The sensor-side surface of the seventh lens 127 has a critical point. The critical point is the point where the trend of the Sag value changes. In other words, it is the point where the Sag value increases and then decreases, or the point where the Sag value decreases and then increases. Referring to FIG. 26, it may be seen that the sensor-side surface of the seventh lens 127 has a critical point between the 3.5 mm point and the 3.9 mm point in the direction perpendicular to the optical axis from the optical axis. The sag value of the sensor-side surface of the seventh lens 127 increases from the optical axis to the 3.5 mm point in the direction perpendicular to the optical axis, and then decreases from the 3.5 mm point to the 3.9 mm point. If the critical point exists on the sensor-side surface of the seventh lens 127, that is, on the sensor-side surface of the last lens, that is, on the lens surface closest to the sensor, the TTL may be reduced, making it easy to miniaturize and lighten the optical system.

The thickness T1 of the first lens 121 may have a difference between the maximum thickness and the minimum thickness of 1 or more times, for example, 1 to 1.5 times, and the center thickness CT1 may be minimum and the edge thickness ET1 may be maximum. The thickness T2 of the second lens 122 may be at least 1.2 times the minimum thickness, for example, in a range of 1.2 to 1.8 times. The second lens 122 may have a maximum center thickness CT2 and a minimum edge thickness ET2. The thickness T3 of the third lens 123 may be at least 1.5 times the minimum thickness, for example, in a range of 1.5 to 2.5 times. The maximum thickness of the fourth lens 124 may be at least 1.2 times the minimum thickness, for example, in a range of 1.2 to 1.8 times, and may be smaller than the difference between the maximum thickness and the minimum thickness of the third lens 123.

The center thickness CT34 of the cemented lens 134 may be greater than the edge thickness ET34. The center thickness CT34 of the cemented lens 134 is the distance from the center of the object-side fifth surface S5 of the third lens 123 to the center of the eighth surface S8 of the fourth lens 124, and the edge thickness ET34 is the distance from the end of the effective region of the fifth surface S5 to the eighth surface S8 in the optical axis direction. The maximum thickness of the cemented lens 134 is the center portion, the minimum thickness is the edge portion, and the maximum thickness may be 1 or more times the minimum thickness, for example, 1 to 1.5 times the range.

The maximum thickness of the fifth lens 125 is the center portion, the minimum thickness is the edge portion, and the maximum thickness may be 1.2 or more times the minimum thickness, for example, 1.2 to 1.8 times the range. The maximum thickness of the sixth lens 126 is at the edge portion, the minimum thickness is at the center portion, and the maximum thickness is at least 1 time the minimum thickness, for example, in the range of 1 to 1.5 times. The maximum thickness of the seventh lens 127 is at the edge portion, the minimum thickness is at the center portion, and the maximum thickness is at least 1 time the minimum thickness, for example, in the range of 1 to 1.5 times. Excluding the cemented lens 134, the difference between the maximum thickness and the minimum thickness of the fifth lens 125 may be the largest among the lenses. The difference between the maximum thickness and the minimum thickness of the seventh lens 127 may be the smallest among the lenses. Here, since the difference between the maximum thickness and the minimum thickness of each lens is 2.5 times or less, the TTL may not be increased.

Among the distances G1-G6 between the lenses, the first distance G1 between the first and second lenses 121 and 122 may be the largest at the edge portion and the smallest at the center portion. The second distance G2 between the second and third lenses 122 and 123 may be maximum at the edge portion and minimum at the center portion. The fourth distance G4 between the fourth and fifth lenses 124 and 125 may be maximum at the edge portion and minimum at the center portion, and the difference between the minimum and maximum distances may be the largest. The fifth distance G5 between the fifth and sixth lenses 125 and 126 may be maximum at the edge portion and minimum at the center portion, and the difference between the maximum and minimum gaps may be the smallest. The sixth distance G6 between the sixth and seventh lenses 126 and 127 may be maximum at the center portion and minimum at the edge portion.

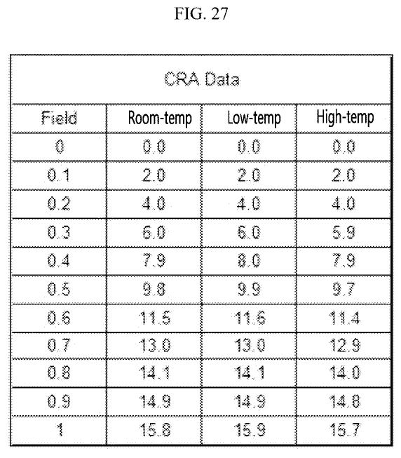

As shown in FIG. 27, CRA in the optical system and camera module of FIG. 21 may be 10 degrees or more, for example, 10 to 35 degrees, or 10 to 25 degrees, at the end of the diagonal length of the image sensor, which is 1.0 field. In addition, the angle difference of the chief ray from low temperature (−40 degrees) to high temperature (95 degrees) may be 1 degree or less. Accordingly, even if the temperature changes from low temperature to high temperature, the angle difference of the chief ray may not be large and stable optical performance may be achieved.

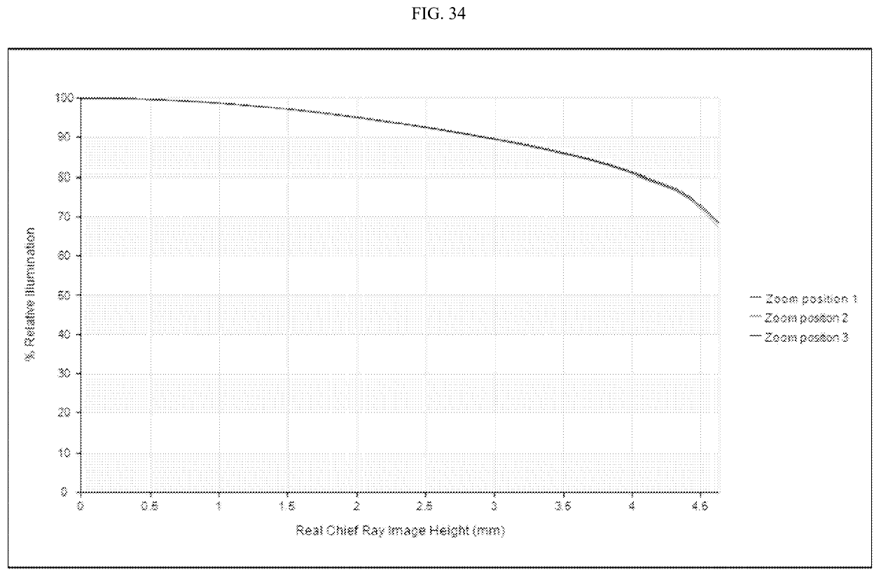

As shown in FIG. 34, a graph showing the ratio of the ambient light or the relative illumination according to the image height in the optical system according to the third embodiment shows that the ratio of the ambient light is 70% or more, for example, 75% or more, from the center of the image sensor to the end of the diagonal. That is, it may be seen that the difference in the ambient illuminance (Zoom position 1, 2, 3) according to the temperature of room temperature, low temperature, and high temperature is almost no difference up to 4.5 mm from the optical axis.

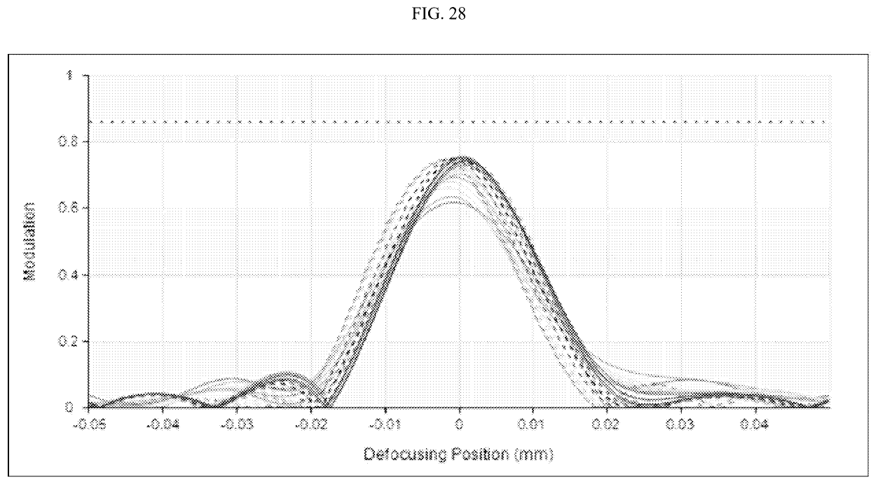

FIGS. 28 to 30 are graphs showing the diffraction MTF at room temperature, low temperature, and high temperature in the optical system of FIG. 21, and are graphs showing the modulation of the luminance according to the spatial frequency. As shown in FIGS. 28 to 30, in the third embodiment of the invention, the deviation of the MTF with respect to the low temperature or high temperature based on the room temperature may be less than 10%, that is, 7% or less.

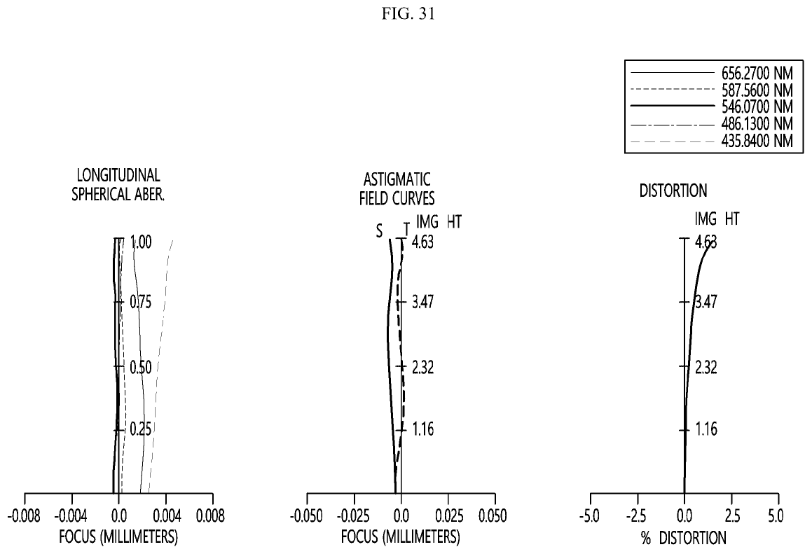

FIGS. 31 to 33 are graphs showing the aberration characteristics at room temperature, low temperature, and high temperature in the optical system of FIG. 21. These are graphs measuring spherical aberration (Longitudinal Spherical Aberration), astigmatic field curves, and distortion from left to right in the aberration graphs of FIGS. 31 to 33. In FIGS. 31 to 33, the X-axis may represent a focal length (mm) and a distortion degree (%), and the Y-axis may represent the height of the image. In addition, the graph for spherical aberration is a graph for light in wavelength bands of about 435 nm, about 486 nm, about 546 nm, about 587 nm, and about 656 nm, and the graphs for astigmatism and distortion are graphs for light in wavelength bands of about 546 nm. In the aberration diagrams of FIGS. 31 to 33, the closer each curve at room temperature, low temperature, and high temperature is to the Y-axis, the better the aberration correction function may be interpreted. It may be seen that the optical system 1000 according to the third embodiment has measurement values close to the Y-axis in almost all areas. That is, the optical system 1000 according to the third embodiment has improved resolution and may have good optical performance not only in the center of the FOV but also in the periphery. Here, the low temperature is −20 degrees or lower, for example, in the range of −20 to −40 degrees, the room temperature is in the range of 22 degrees±5 degrees or in the range of 18 degrees to 27 degrees, and the high temperature may be in the range of 85 degrees or higher, for example, in the range of 85 degrees to 105 degrees. Accordingly, it may be seen that the decrease in the luminance ratio (modulation) from the low temperature to the high temperature of FIGS. 31 to 33 is less than 10%, for example, 5% or lower, or is almost unchanged.

Table 4 compares the changes in optical characteristics such as EFL, BFL, F number F #, TTL, and FOV at room temperature, low temperature, and high temperature in the optical system according to the third embodiment, and it may be seen that the change rate of optical characteristics at low temperature is 5% or less, for example, 3% or less, based on room temperature, and it may be seen that the change rate of optical characteristics at low temperature is 5% or less, for example, 3% or less, based on room temperature.

TABLE 4

| | | | | Low | High |
|---|---|---|---|---|---|
| | | | | temperature/ | temperature/ |
| | Room | Low | High | Room | Room |
| | temperature | temperature | temperature | temperature | temperature |
| EFL(F) | 15.332 | 15.282 | 15.394 | 99.67% | 100.40% |
| BFL | 1.855 | 1.853 | 1.858 | 99.89% | 100.13% |
| F# | 1.600 | 1.595 | 1.607 | 99.66% | 100.41% |
| TTL | 37.049 | 36.987 | 37.123 | 99.83% | 100.20% |
| FOV | 33.100 | 33.186 | 32.998 | 100.26% | 99.69% |

Therefore, as shown in Table 4, the change in optical characteristics according to the temperature change from low temperature to high temperature, for example, the change rate of effective focal length (EFL), TTL, BFL, F number, and FOV is 10% or less, that is, 5% or less, for example, in the range of 0 to 5%. This means that even if at least one or two or more plastic lenses are used, the temperature compensation for the plastic lenses may be designed to inhibit the reliability of the optical characteristics from deteriorating. The optical system of the third embodiment disclosed above can effectively control aberration characteristics such as chromatic aberration and distortion aberration, and may have good optical performance not only at the center but also at the periphery of the FOV.

The optical system 1000 according to the third embodiment disclosed above may satisfy at least one or two or more of the mathematical equations described below. Accordingly, the optical system 1000 according to the third embodiment has improved optical characteristics, can effectively control aberration characteristics such as chromatic aberration and distortion aberration, and may have good optical performance not only at the center of the FOV but also at the periphery. The optical system 1000 may have improved resolution. In addition, the thickness of the lens on the optical axis OA and the spacing of adjacent lenses on the optical axis OA described in the Equations can refer to the third embodiment disclosed above.

$$0.5 < CT 1 / ET 1 < 1 \qquad [ Equation 1 ]$$

In Equation 1, by setting the center thickness CT1 and edge thickness ET1 of the first lens 121, it is possible to set factors affecting the field of view of the optical system, and to set factors affecting the effective focal length (EFL), and preferably, it may satisfy: 0.6≤CT1/ET1<1.

$$0.2 < CT 1 / CA 11 < 0.8 \qquad [ Equation 2 ]$$

In Equation 2, the center thickness CT1 of the first lens 121 and the effective diameter CA11 of the object-side surface S1 of the first lens 121 may be set, and if this is satisfied, the strength and optical characteristics of the injection-molded lens made of glass may be inhibited from being deteriorated. If it is lower than the range of Equation 1, the lens may be damaged or injection molding may be difficult, and if it is larger than the above range, the TTL may increase and the weight of the optical system may become heavy. Preferably, it may satisfy: 0.3<CT1/CA11<0.5.

$$Po 1 < 0 \qquad [ Equation 3 ]$$

In Equation 3, Po1 means the power of the first lens 121, and may be set to have a short effective focal length compared to the TTL in the optical system for the performance of the optical system.

$$F 5 ⋆ F 6 ⋆ F 7 > 0 and F 5 ⋆ F 7 < 0 \qquad [ Equation 3 - 1 ]$$

In Equation 3-1, F5, F6, and F7 may be the focal lengths of the fifth, sixth, and seventh lenses 125, 126, and 127, and the product of the focal lengths of the plastic lenses can mix the negative and positive refractive powers so that they can mutually compensate. Accordingly, the aberrations occurring in the plastic lenses may be mutually canceled out.

$$1.7 << Nd 1 < 2.2 \qquad [ Equation 4 ]$$

Equation 4 sets the refractive index of the first lens high, so that it can control the factors affecting the reduction of the third-order aberration (Seidel aberration) of the optical system, and can reduce the aberrations that may occur when the TTL is somewhat longer. Equation 4 may satisfy: 1.75<Nd1<2.1. If it is designed to be lower than the lower limit of Equation 4, the performance of reducing aberration may be obtained, and since the refractive power of the first lens is weakened, light cannot be collected efficiently, so the performance of the optical system can deteriorate. If it is designed to be higher than the upper limit of Equation 4, there is a disadvantage in that it becomes difficult to obtain materials. In addition, if the refractive index of the first lens 121 is designed to be lower than the lower limit of Equation 4, in order to increase the refractive power of the first and second lenses, the radius of curvature of the first and second lenses must be increased, and in this case, lens manufacturing becomes more difficult, the lens defect rate increases, and the yield can decrease.

$$1.6 \leq Aver ( Nd 1 : Nd 7 ) \leq 1.7 \qquad [ Equation 4 - 1 ]$$

In Equation 4-1, Aver(Nd1:Nd7) is the average of the refractive index values of the d-line of the first to seventh lenses. When the optical system 1000 according to the third embodiment satisfies the Equation 4-1, the optical system 1000 may set the resolution and suppress the influence on the TTL.

$$1 < GLn\_Aver / PLn\_Aver < 1.2 \qquad [ Equation 4 - 2 ]$$

GLn_Aver is the average of the refractive indices of the lenses of the glass material within the lens portion 100B, and PLn_Aver is the average of the refractive indices of the plastic lenses. The lens(es) having a high refractive index are positioned on the object side of the plastic lens, thereby increasing the color dispersion.

$$20 < FOV\_H < 40 \qquad [ Equation 5 ]$$

Equation 5 may satisfy: 25≤FOV_H≤35, or a range of 29.2 degrees±3 degrees, and the length of the image sensor in the horizontal direction is based on 8.064 mm±0.5 mm. In addition, if Equation 5 is satisfied, when the temperature changes from room temperature to high temperature, the change rate of the effective focal length and the change rate of the field of view may be set to 5% or less, for example, 0 to 5%. In addition, even if two or more, for example, three or more, plastic lenses are mixed and used in the optical system 1000, the deterioration of the optical characteristics may be inhibited through temperature compensation of the plastic lenses.

$$L 1 R 1 < 0 \qquad [ Equation 6 ]$$

If Equation 6 is satisfied, the shape of the optical system may be limited. The object-side surface of the first lens 121 is formed concavely, so that when it comes into contact with an external structure, surface damage may be inhibited, and the incident light may be refracted in a direction away from the optical axis. Accordingly, the gap between the first and second lenses 121 and 122 may be reduced, or the effective diameter of the second lens 122 may be increased.

$$L 1 R 2 < 0 \qquad [ Equation 6 - 1 ]$$

$$L 2 R 1 > 0 , L 2 R 2 < 0 \qquad [ Equation 6 - 2 ]$$

Since the first lens 121 has a convex meniscus shape toward the sensor side, it can refract light to the edge of the second lens 122 with a large effective diameter. In addition, since the second lens has a convex shape on both sides, it can refract light so that the effective diameter of the third lens 123 is not large, and the number of lenses may be reduced. In addition, since the following condition satisfies: L2R1>L2R2, light may be controlled so that the effective diameters of the sensor-side lenses, i.e., the third to seventh lenses 123 to 127, are not large, and TTL may be reduced. If the following condition satisfies: L2R1<L2R2, there is a problem that aberration occurs between the object-side surfaces of the first lens and the second lens, or the effective diameter of the sensor-side lenses increases, or TTL increases.

$$1 < L 7 S 2 \_max \_sag to Sensor < 3 \qquad [ Equation 7 ]$$

In Equation 7, L7S2_max_sag to Sensor may be a straight-line distance from the maximum Sag value of the seventh lens 127 to the image sensor 300, and if this is satisfied, TTL may be reduced and conditions for manufacturing a camera module may be set. In addition, L7S2_max_sag to Sensor may set a space where a filter 500 and a cover glass 400 located between the image sensor 300 and the seventh lens 127 may be placed. If the range of Equation 7 is smaller than the lower limit, the space for placing circuit structures such as filters and image sensors becomes more restricted, and the process of assembling circuit structures such as filters and image sensors into the optical system may become difficult. When the range of Equation 7 is larger than the upper limit, the process of assembling circuit structures such as filter and image sensor into the optical system is easy, but the TTL becomes long, making it difficult to miniaturize the optical system. That is, Equation 7 may set the minimum distance between the image sensor 300 and the last lens, and preferably satisfies: 1<L7S2_max_sag to Sensor≤BFL. In addition, when the last lens does not have a point P2 that protrudes further toward the image sensor than the center of the sensor-side surface, the value of Equation 6 may be equal to BFL. The BFL is the optical axis distance from the image sensor 300 to the center of the sensor-side surface of the last lens. In detail, if it may satisfy: 1.5<L7S2_max_sag to Sensor<2.0, the manufacturing convenience and TTL reduction are easier.

$$1 < CT 1 / CT 7 < 3 \qquad [ Equation 8 ]$$

If Equation 8 is satisfied, the aberration characteristics may be improved and the influence on the reduction of the optical system may be set. Preferably, Equation 8 may satisfy: 1<CT1/CT7<2. In Equation 8, the object-side lens and the sensor-side lens of the optical system may be set to be a glass lens and a plastic lens, and the difference in their center thickness may be limited. Accordingly, the chromatic aberration of the optical system may be improved, and good optical performance may be achieved at the set field of view and TTL may be controlled.

$$1 < CT 1 / CT 6 < 3 \qquad [ Equation 9 ]$$

In Equation 9, the center thickness CT1 and CT6 of the first and sixth lenses 121 and 126 may be set. If the optical system satisfies Equation 9, the aberration characteristics may be improved and the influence on the reduction of the optical system may be set. Preferably, the following condition may satisfy: 1<CT1/CT6<2. Equation 9 sets the difference in the center thickness of the first and sixth lenses, so that the chromatic aberration of the optical system may be improved.

$$1 < CT 34 / CT 5 < 5 \qquad [ Equation 10 ]$$

In Equation 10, CT34 is the center thickness of the third and fourth lenses, for example, the center thickness of the cemented lens 134. When the optical system satisfies Equation 10, the thickness of the cemented lens and the adjacent fifth lens 125 may be set, so that the aberration characteristics may be improved, and preferably, it may satisfy: 1<CT34/CT5<4 or 1.2<CT34/CT5≤3. The CT34 may be greater than the center thickness CT1-CT7 of each of the first to seventh lenses. Here, the following condition may satisfy: CT34>ET34.

$$0 < L 2 R 1 / L 4 R 2 < 1 \qquad [ Equation 11 ]$$

If the optical system 1000 satisfies Equation 11, the optical system 1000 may have improved aberration characteristics.

$$0 < CT 45 - ET 45 < 2 \qquad [ Equation 12 ]$$

ET45 is an optical axis distance from the end of the effective region of the object-side surface of the fourth lens 124 to the end of the effective region of the sensor-side surface of the fifth lens 125. If the optical system satisfies Equation 12, the center thickness and edge thickness of the cemented lens may be set to improve the aberration characteristics, and preferably, 1≤CT45/ET45<1.5 may be satisfied. The ET45 may be greater than the edge thickness ET1-ET7 of each of the first to seventh lenses.

$$0 < CA 11 / CA 31 < 2 \qquad [ Equation 13 ]$$

CA11 means the effective diameter of the first surface S1 of the first lens 121, and CA31 means the effective diameter of the fifth surface S5 of the third lens 123. When Equation 13 is satisfied, the optical system 1000 can control the incident light and set the factor affecting the aberration, and preferably, 0.5<CA11/CA31<1.5 may be satisfied.

$$0 < CA 72 / CA 42 < 2 \qquad [ Equation 14 ]$$

In Equation 14, CA42 means the effective diameter of the eighth surface S8 of the fourth lens 124, and CA72 means the effective diameter of the fourteenth surface S14 of the seventh lens 127. When Equation 14 is satisfied, the optical system 1000 can control the incident light path and set factors for performance changes according to CRA and temperature. Preferably, Equation 14 may satisfy: 0.5<CA72/CA42<1.

$$0 < CA 12 / CA 21 < 2 \qquad [ Equation 15 ]$$

In Equation 15, CA12 means the effective diameter of the second surface S2 of the first lens 121, and CA21 means the effective diameter of the third surface S3 of the second lens 122. When Equation 15 is satisfied, the optical system 1000 can control the light traveling to the first lens group LG1 and the second lens group LG2, and set factors affecting the decrease in lens sensitivity. Equation 15 preferably satisfies: 0.5<CA12/CA21<1.5.

$$0.5 < CA 31 / CA 42 < 2 \qquad [ Equation 16 ]$$

In Equation 16, CA31 means the effective diameter of the fifth surface S5 of the third lens 123, and CA42 means the effective diameter of the eighth surface S8 of the fourth lens 124. When the optical system 1000 satisfies Equation 16, the size of the cemented lens arranged on the object side of the plastic lens(es) may be set. Equation 16 preferably satisfies: 0.8≤CA31/CA42<1.5.

$$L 3 R 1 > L 3 R 2 \qquad [ Equation 17 ]$$

Since both sides of the third lens 123 are provided as convex, the effective diameters of the fifth to seventh lenses 125 to 127 may be reduced, and light may be refracted efficiently. Accordingly, the effective diameter size of the third lens, which is positioned closer to the object side than the plastic lens(es), may be set, so that light incident through the cemented lens may be effectively guided to the plastic lens. The effective diameter size is designed to gradually decrease from the fourth lens portion to the sixth lens made of plastic, so that light may be refracted and guided to the sixth lens, which has a relatively small effective diameter.

$$CA 4 > CA\_PL 1 \qquad [ Equation 17 - 1 ]$$

In Equation 17-1, the CA4 is the effective diameter (average effective diameter) of the fourth lens 124, and CA_PL1 may be the effective diameter (average effective diameter) of the plastic lens closer to the object side than the sensor when two plastic lenses are present.

$$2 < L 2 R 1 / ( CA 21 / 2 ) < 5 \qquad [ Equation 18 ]$$

When the second lens 122 with both convex surfaces satisfies Equation 18, the optical system 1000 can improve chromatic aberration. When it is smaller than the lower limit value of Equation 18, the occurrence of aberration by the third surface increases, and when it is larger than the upper limit value, the occurrence of aberration on the third surface decreases, but since the radius of curvature of the fourth surface must be smaller, the occurrence of aberration on the fourth surface increases, and there is a problem of affecting the aberration of the third to seventh lenses. Preferably, if the range of 4<L2R1/(CA21/2)<5 is satisfied, the radius of curvature of the fourth surface may be designed to be large while reducing the aberration occurring in the third surface, making it easy to manufacture the second lens 122. The aberration occurring in the optical system may be reduced, making the manufacture of the second lens 122 easier, and increasing the yield.

$$CA 3 > CA 4 > CA 5 > CA 6 \qquad [ Equation 18 - 1 ]$$

$$CA 41 > ( ImgH * 2 ) \qquad [ Equation 18 - 2 ]$$

$$CA 51 > ( ImgH * 2 ) \qquad [ Equation 18 - 3 ]$$

$$CA 71 > ( ImgH * 2 ) \qquad [ Equation 18 - 4 ]$$

In Equations 18-1 to 18-4, CA3, CA4, CA5, and CA6 are effective diameters (average effective diameters) of the third to sixth lenses 123-126, and ImgH is half of the diagonal length of the image sensor 300. Accordingly, the light path may be set from the third lens 123 to the region of the image sensor 300 by the effective diameter of the sixth lens 126. The fifth and sixth lenses 125 and 126 are plastic lenses with aspherical surfaces, and the third and fourth lenses 123 and 124 are glass lenses with curved surfaces, so that aberrations between the lenses may be mutually compensated. Equation 18 can further satisfy Equation 18-5.

$$1 \leq Last\_GL \_CAS1 / Last\_GL \_CAS2 \leq 1.4 \qquad [ Equation 18 - 5 ]$$

In Equation 18-5, Last_GL_CAS1 represents the effective diameter CAS1 of the object-side surface of the last glass lens GL in the optical system, and Last_GL_CAS2 represents the effective diameter CAS2 of the sensor-side surface of the last glass lens GL in the optical system.

$$1 < CA\_GL \_AVER / CA\_PL \_AVER < 1.5 \qquad [ Equation 19 ]$$

In Equation 19, CA_GL_AVER represents the average effective diameter of glass lenses, and CA_PL_AVER represents the average effective diameter of plastic lenses. In Equation 19, by setting the effective diameter size of the glass lens and the effective diameter size of the plastic lens located on the object side compared to the plastic lens, the path of the incident light may be effectively guided. Equation 19 preferably satisfies: 1.1<CA_GL_AVER/CA_PL_AVER<1.4. Here, it may satisfy: nGL>nPL. The nGL is the number of lenses made of glass material, and nPL is the number of plastic lenses. In addition, the following condition may satisfy: nGL−nPL=0 or 1.

$$1 \leq GL\_CA 1 \_AVER / PL\_CA 1 \_AVER \leq 1.6 \qquad [ Equation 20 ]$$

In Equation 20, GL_CA1_AVER is the effective diameter average of the object-side surfaces of the glass lenses, for example, the effective diameter average of the object-side surfaces of the first to fourth lenses. PL_CA1_AVER is the effective diameter average of the object-side surfaces of the plastic lenses, for example, the effective diameter average of the object-side surfaces of the fifth, sixth, and seventh lenses. Since the effective diameter size of the plastic lens is designed to be relatively small compared to that of the glass lens, Equation 20 may be satisfied. This is because the effective diameter of the sensor-side surface of the fifth lens, which is the lens closest to the plastic lens, is designed to be small and the radius of curvature is small, so that light passing through the glass lens may be guided to the effective region of the plastic lens, which has a relatively small effective diameter. Equation 20 preferably satisfies: 1.1≤GL_CA1_AVER/PL_CA1_AVER≤1.4.

$$CA 567 < CA 34 \qquad [ Equation 21 ]$$

In Equation 21, CA567 means the average effective diameter of the fifth to seventh lenses 125-127, and CA34 means the average effective diameter of the third and fourth lenses 123 and 124. When Equation 21 is satisfied, the optical system can guide light to the center and periphery of the image sensor 300 by setting the effective diameter size of the plastic lenses arranged between the fourth lens 124 and the image sensor 300 to be smaller than the effective diameters of the third and fourth lenses 123 and 124, thereby improving chromatic aberration.

$$CG 2 < CG 1 < C G 6 \qquad [ Equation 22 ]$$

In Equation 22, CG1 may be the center distance between the first and second lenses, CG2 may be the center distance between the second and third lenses, and CG6 may be the center distance between the sixth and seventh lenses. If Equation 22 is satisfied, the center distance between glass lenses having relatively thick thicknesses may be reduced, thereby reducing TTL and improving optical performance in the peripheral part of the FOV.

$$G 3 < 0.01 or CG 3 < 0.01 \qquad [ Equation 22 - 1 ]$$

In Equation 22-1, G3 and CG3 may set the distance and center distance between the third lens 123 and the fourth lens 124. If Equation 22-1 is satisfied, the third and fourth lenses may be set as cemented lenses. Here, preferably, the following condition may satisfy: CT34<CT2.

$$1 < CT 7 / CG 6 < 3 \qquad [ Equation 23 ]$$

In Equation 23, CG6 is the center distance or optical axis distance between the sixth and seventh lenses 126 and 127. In Equation 23, by setting the center thickness CT7 of the seventh lens 127 and the center distance between the sixth and seventh lenses, the optical performance in the peripheral part of the field of view may be improved. Equation 23 preferably satisfies: 1.1<CT7/CG6<2.

$$( CG 5 + CG 6 ) < CT 34 < 2 ( CG 5 + CG 6 ) \qquad [ Equation 24 ]$$

In Equation 24, CT34 is the center thickness of the cemented lens 134. By arranging the center thickness of the cemented lens to be larger than the sum of the center distance CG5 between the fifth and sixth lenses and the center distance CG6 between the sixth and seventh lenses, the resolution and chromatic aberration may be improved and the center distances may be reduced.

$$4 ( CG 2 + CG 5 ) < CT 2 < 8 ( CG 2 + CG 5 ) \qquad [ Equation 25 ]$$

In Equation 25, CT2 is the center thickness of the second lens 122, and CG2 is the center distance or optical axis distance between the second and third lenses. By arranging the center thickness of the second lens to be larger than 4 times the sum of the center distance CG2 between the second and third lenses and the center distance CG5 between the fifth and sixth lenses, the chromatic aberration may be improved and the center distances may be reduced.

$$1 < CT 2 / CT 1 < 4 \qquad [ Equation 26 ]$$

In Equation 26, by setting the center thickness CT2 of the second lens to be thicker than the center thickness CT1 of the first lens, the factors affecting the aberration may be controlled. Preferably, Equation 26 may satisfy: 1.1<CT2/CT1<2.

$$1 < L 7 R 1 / CT 7 < 100 \qquad [ Equation 27 ]$$

In Equation 27, L7R1 means the radius of curvature of the thirteenth surface of the seventh lens. In Equation 27, by setting the radius of curvature L7R1 of the object-side surface of the seventh lens and the center thickness of the seventh lens, the refractive power of the seventh lens may be controlled. Accordingly, good optical performance may be achieved at the center and periphery of the field of view. Preferably, Equation 27 may satisfy: 1<L7R1/CT7<30.

$$0 < L 5 R 2 / L 7 R 1 < 10 \qquad [ Equation 28 ]$$

In Equation 28, L5R2 means the radius of curvature of the tenth surface of the fifth lens. In Equation 28, by setting the radius of curvature of the sensor-side surface of the fifth lens and the radius of curvature of the object-side surface of the seventh lens, the refractive power of the fifth and seventh lenses may be controlled. Accordingly, good optical performance may be achieved at the center and periphery of the field of view. Preferably, Equation 28 may satisfy: 0<L5R2/L7R1<1.

$$0 < L 3 R 1 * L 4 R 2 \qquad [ Equation 29 ]$$

In Equation 29, L4R1 is the radius of curvature of the object-side surface of the fourth lens, and L5R2 is the radius of curvature of the sensor-side surface of the fifth lens. If Equation 29 is satisfied, the refractive power of the cemented lens may be controlled to control the light path incident on the plastic lens. Equation 29 may satisfy: 500<L4R1*L5R2.

$$1 < L 6 R 1 / L 5 R 2 < 10 \qquad [ Equation 30 ]$$

In Equation 30, L6R1 is the radius of curvature of the object-side surface of the sixth lens. In Equation 30, by setting the radius of curvature of the sensor-side surface of the fifth lens and the sensor-side surface of the sixth lens, the refractive surface of the plastic lens may be adjusted to effectively refract light toward the image sensor. Equation 30 preferably satisfies: 1<L6R1/L5R2<6.

$$1 < L 6 R 2 / L 6 R 1 < 1 \qquad [ Equation 31 ]$$

In Equation 31, L6R1 and L6R2 mean the radii of curvature of the object-side surface and the sensor-side surface of the sixth lens. In Equation 31, by setting the radii of curvature of the object-side surface and the sensor-side surface of the sixth lens, the plastic lens can effectively refract the incident light toward the image sensor. Equation 31 preferably satisfies: 0<|L6R2/L6R1|<0.5. Here, the following conditions may satisfy: L6R1>0, L6R2>0, and L6R1>L6R2.

$$1 < L 7 R 1 / L 7 R 2 < 3 \qquad [ Equation 31 - 1 ]$$

In Equation 31-1, L7R1 and L7R2 mean the radii of curvature of the object-side surface and the sensor-side surface of the seventh lens. In Equation 31-1, by setting the radii of curvature of the object-side surface and the sensor-side surface of the seventh lens, light may be refracted to the image sensor through the plastic lens. Equation 31-1 may preferably satisfy: 1<L7R1/L7R2<2. Here, the following conditions may satisfy: L7R1>0, L7R1>0, and L7R2<L7R1.

$$0 < CT\_Max / CG\_Max < 5 \qquad [ Equation 32 ]$$

In Equation 32, the maximum center thickness CT_Max among the lenses and the maximum distance CT_Max between adjacent lenses may be set. If Equation 32 is satisfied, the optical system may have good optical performance at the focal length at the set field of view and can reduce TTL. Preferably, it may satisfy: 1<CT_Max/CG_Max<3.

$$2 < Σ C T / Σ C G < 6 \qquad [ Equation 33 ]$$

If Equation 33 is satisfied, the optical system may have good optical performance at the focal length at the set field of view and can reduce TTL. Preferably, it may satisfy: 3<ΣCT/ΣCG<5.

$$10 < Σ Nd < 30 \qquad [ Equation 34 ]$$

If Equation 34 is satisfied, the optical system 1000 in which a plastic lens and a glass lens are mixed can control TTL and have improved resolution. Also, when the number of lenses made of glass material is greater than the number of lenses made of plastic material, and when the number of lenses made of glass material with relatively thick thickness is greater, the sum of TTL and refractive index may be set. Equation 34 may preferably satisfy: 10<ΣNd<20.

$$10 < Σ Abb / Σ Nd < 50 \qquad [ Equation 35 ]$$

When Equation 35 is satisfied, the optical system 1000 may have improved aberration characteristics and resolution. By setting the sum of Abbe numbers and the sum of refractive indices of lenses in Equation 35, the optical characteristics may be controlled, and preferably, it may satisfy: 10<ΣAbb/ΣNd<40.

$$Distortion < 2 \qquad [ Equation 36 ]$$

Distortion means the maximum value or the absolute value of the maximum value in the region from the center (0.0 F) to the diagonal end (1.0 F) based on the optical characteristics detected by the image sensor 300. When the optical system 1000 satisfies Equation 36, the optical system 1000 can improve the distortion characteristics and set conditions for image processing. Preferably, Distortion≤1 may be satisfied.

$$0 < Σ C T / Σ E T < 2 \qquad [ Equation 37 ]$$

ΣCT is the sum of the center thicknesses of the lenses, and ΣET is the sum of the edge thicknesses of the effective regions of the lenses. When Equation 37 is satisfied, the optical system may have good optical performance at the focal length at the set field of view and can reduce the TTL. Equation 37 preferably satisfies: 0.5<ΣCT/ΣET<1.5.

$$0.5 < C A 21 / CA\_min < 2 \qquad [ Equation 38 ]$$

If Equation 38 is satisfied, the optical system can control incident light, maintain optical performance, and provide a slimmer module. Equation 38 preferably satisfies: 1<CA21/CA_min<2.

$$1 < CA\_max / CA\_min < 5 \qquad [ Equation 39 ]$$

If Equation 39 is satisfied, the optical system may set a size for a slim and compact structure while maintaining optical performance. Equation 39 preferably satisfies: 1<CA_max/CA_min<2.

$$1 < CA\_max / CA\_Aver < 3 \qquad [ Equation 40 ]$$

If Equation 40 is satisfied, the optical system may set a size for a slim and compact structure while maintaining optical performance. Equation 40 may preferably satisfy: 1<CA_max/CA_Aver<1.5.

$$0.5 < CA\_min / CA\_Aver < 2 \qquad [ Equation 41 ]$$

If Equation 41 is satisfied, the optical system may set a size for a slim and compact structure while maintaining optical performance. Equation 41 may preferably satisfy: 0.5<CA_min/CA_Aver<1.

$$1 < CA\_max / ( 2 * ImgH ) < 3 \qquad [ Equation 42 ]$$

Equation 42 may be set to the maximum effective diameter CA_Max and the length (2*ImgH) of the image sensor, and if this is satisfied, the optical system can maintain good optical performance and set the size for a slim and compact structure. Preferably, Equation 42 may satisfy: 1<CA_max/(2*ImgH)<2.

$$1 < TD / CA\_max < 4 \qquad [ Equation 43 ]$$

TD is an optical axis distance from the center of the object-side surface of the first lens to the center of the sensor-side surface of the last lens. If Equation 43 is satisfied, the total optical axis distance and the maximum effective diameter of the lenses may be set, and the size for good optical performance may be set. Equation 43 may preferably satisfy: 2<TD/CA_max<3.

$$TD > SD \qquad [ Equation 43 - 1 ]$$

The SD is the distance from the position of the aperture stop to the center of the sensor-side surface of the last lens.

$$1 < F / CA 51 < 10 \qquad [ Equation 44 ]$$

In Equation 44, F means a range of 30 mm or more, for example, 30 mm to 44 mm. Equation 44 sets a relationship between the effective focal length and the effective diameter of the object-side surface of the plastic lens, so that the influence on the optical system reduction, for example, TTL, may be controlled. Equation 44 preferably satisfies: 1<F/CA61<2.

$$0 < F / \vert L 1 R 1 \vert < 2 \qquad [ Equation 45 ]$$

In Equation 45, the effective focal length of the optical system and the radius of curvature of the object-side surface of the first lens may be set, so that the influence on the incident light and TTL may be controlled. Equation 45 preferably satisfies: 0.5≤F/|L1R1|<1.

$$Max\_th / Min\_th < 5 \qquad [ Equation 46 ]$$

In Equation 46, Max_th is the thickness of the thickest region of the lens, and Min_th is the thickness of the thinnest region of the lens. Max_th/Min_th is the ratio of the thickest thickness and the thinnest thickness of each lens. The thickest thickness of the lens, Max_th, may be the center thickness CT of the lens, and the thinnest thickness of the lens, Min_th, may be the edge thickness ET of the lens, but the opposite case is also possible. The thickest thickness of the lens, Max_th, may be the edge thickness ET of the lens, and the thinnest thickness of the lens, Min_th, may be the center thickness CT of the lens. The edge thickness ET means the thickness at the end of the effective diameter. When Equation 46 is satisfied, the optical system can control the influence on the effective focal length. Preferably, the following condition may satisfy: 3.5<Max_th/Min_th≤4.5. Here, the ratio of the maximum thickness and the minimum thickness of the plastic lens may satisfy the following conditions. Max_PL_th is the thickness value of the thickest region of the plastic lens, and Min_PL_th is the thickness value of the thinnest region of the plastic lens. Max_PL_th may be the center thickness CT of the plastic lens, and Min_PL_th may be the edge thickness ET of the plastic lens. The edge thickness ET means the thickness at the end of the effective diameter. The opposite case is also possible. Max_PL_th may be the edge thickness ET of the plastic lens, and Min_PL_th may be the center thickness CT of the plastic lens. The edge thickness ET means the thickness at the end of the effective diameter.

$$1. < Max\_PL \_th / Min\_PL \_th < 2.5 \qquad Condition 1$$

If it is less than the lower limit of the above condition 1, it is difficult to manufacture the plastic lens. That is, it is manufactured by injecting high-temperature resin and hardening at low temperature, but if the thickness difference is large, the lens may shrink unevenly as it cools at low temperature, which may result in a high surface defect rate. In addition, if it is larger than the range of Condition 1, the plastic lens shrinks and expands as the temperature changes from −40 degrees to 105 degrees, and during this process, the rate of change in the shape of the lens appears significantly, which may deteriorate the performance of the optical system. Preferably, the following condition may satisfy: 1.5<Max_PL_th/Min_PL_th<2.3 or 1.7<Max_PL_th/Min_PL_th<2.2.

$$3 < Max ( EG / CG ) < 20 \qquad [ Equation 46 - 1 ]$$

In Equation 46-1, Max(EG/CG) may set the value at which the ratio of the center distance CG and the edge distance EG between adjacent lenses is the maximum. If Equation 46-1 is satisfied, the optical system can adjust the influence on the effective focal length. Preferably, the following condition may satisfy: 5<Max(EG/CG)≤15.

$$1 < Min ( CT / ET ) < 1.5 \qquad [ Equation 46 - 2 ]$$

Min(CT/ET) may set the value at which the ratio of the center thickness CT and the edge thickness ET of each lens is the minimum. If Equation 46-2 is satisfied, the optical system can adjust the influence on the effective focal length. Preferably, the following condition may satisfy: 1<Min(CT/ET)≤1.2.

$$1 < Min ( EG / CG ) < 2 \qquad [ Equation 46 - 3 ]$$

In Equation 46-3, Min(EG/CG) may set the value at which the ratio of the center distance CG and the edge distance EG between adjacent lenses is the minimum. If Equation 46-2 is satisfied, the optical system can adjust the influence on the effective focal length. Preferably, it may satisfy: 1<Min(EG/CG)≤1.7.

$$0 < EPD / \vert L 1 R 1 \vert < 1 \qquad [ Equation 47 ]$$

EPD means the size (mm) of the entrance pupil diameter of the optical system 1000, and L1R1 means the radius (mm) of curvature of the first surface S1 of the first lens. When the optical system 1000 according to the third embodiment satisfies Equation 47, the optical system 1000 can control the incident light. Preferably, the following condition may satisfy: 0.3<EPD/|L1R1|≤0.9.

$$- 5 < F 1 / F 3 < 0 \qquad [ Equation 48 ]$$

If Equation 48 is satisfied, the resolution may be improved by controlling the refractive power of the first and third lenses, and the TTL and effective focal length (EFL) may be affected.

$$\vert F 3 \vert < F 4 < F 5 \qquad [ Equation 48 - 1 ]$$

$$F 5 > \vert F 6 \vert \qquad [ Equation 48 - 2 ]$$

$$2 * F 5 < \vert F 7 \vert \qquad [ Equation 48 - 3 ]$$

In Equations 48-1 to 48-3, F5 is the focal length of the fifth lens, F4 is the focal length of the fourth lens, F6 is the focal length of the sixth lens, and F7 is the focal length of the seventh lens. Accordingly, the focal lengths of the third and fourth lenses adjacent to the plastic lens may be smaller than the focal lengths of the fifth and seventh lenses. Accordingly, the refractive power of the last glass lens may be controlled to guide it to the effective region of the plastic lens. Here, F1 is −39 mm or less, for example, in the range of −39 mm to −59 mm. F2 is 17 mm or more, for example, in the range of 17 mm to 26 mm. F3 is 15 mm or more, for example, in the range of 15 mm to 24 mm. F4 is −19 mm or less, for example, in the range of −19 mm to −29 mm. F5 is 31 mm or more, for example, in the range of 31 mm to 46 mm. F6 is −16 mm or less, for example, in the range of −16 mm to −25 mm. F7 is −111 mm or less, for example, in the range of −111 mm to −167 mm. The sum of the focal lengths of the second, fourth, fifth, and sixth lenses may be set to 12 mm or more, for example, in the range of 12 mm to 18 mm. The balance of the respective focal lengths of the second, fourth, fifth, and sixth lenses can suppress the difference in pint position due to temperature change. Accordingly, it is possible to suppress the optical characteristics of the imaging lenses from being degraded due to temperature changes.

The aperture stop is arranged on the object side of the second lens 122. The focal length of the lens arranged on the sensor side closer to the aperture stop than the aperture stop is greater than 0. In the third embodiment of the present invention, the focal length F2 of the second lens 122 should be designed to be greater than 0. In this case, the second lens 122 collects light, so that the effective diameter of the third to seventh lenses, which are lenses arranged closer to the sensor than the second lens 122, may be inhibited from increasing. In addition, since the TTL may be inhibited from becoming longer, miniaturization of the optical system is possible. The composite focal length of the lens arranged on the sensor side closer to the sensor than the aperture stop, that is, the lens arranged closer to the sensor than the aperture stop, is designed to be greater than 0. In the third embodiment of the present invention, the composite focal length of the third to seventh lenses is designed to be greater than 0. In this case, the optical system may be miniaturized by reducing the TTL at a horizontal field of view FOV_H of 25 to 35 degrees.

$$Po 3 * Po 4 < 0 \qquad [ Equation 49 ]$$

Po3 is the power value of the third lens, and Po4 is the power value of the fourth lens. That is, the powers of the third and fourth lenses have powers of opposite signs, so that aberration may be improved, and light may be effectively guided by the plastic lens. When the following condition satisfies: Po3*Po4>0, the effect of improving chromatic aberration in the cemented lens is not significant.

$$Po 1 ( Po 3 * Po 4 ) > 0 \qquad [ Equation 49 - 1 ]$$

$$F 34 > 0 \qquad [ Equation 49 - 2 ]$$

$$F 5 * F 6 * F 7 > 0 \qquad [ Equation 49 - 3 ]$$

$$F 5 * F 6 < 0 \qquad [ Equation 49 - 4 ]$$

Po1 is the power value of the first lens, F34 is the composite focal length of the third and fourth lenses, and F5, F6, and F7 are the focal lengths of the sixth, seventh, and eighth lenses. If Equations 49-1 to 49-4 are satisfied, it is easy to improve the aberration of the optical system with the fourth lens and the fifth lens, which are cemented lenses, and the incident light may be effectively guided to the plastic lens.

$$15 < Vd 4 - Vd 5 < 50 \qquad [ Equation 50 ]$$

In Equation 50, Vd4 is the Abbe number of the fourth lens, and Vd5 is the Abbe number of the fifth lens. If Equation 50 is satisfied, the difference in Abbe numbers of at least two lenses forming the cemented lens may be maintained at a certain value or more, and chromatic aberration may be improved. Equation 50 preferably satisfies: 20≤Vd4−Vd5≤40. If the cemented lens is less than the lower limit of Equation 50, it may be insignificant in improving the aberration characteristics of the optical system. Accordingly, if the difference in Abbe numbers between the object-side lens and the sensor-side lens in the cemented lens is 20 or more and 40 or less, the aberration characteristics may be improved.

$$Vd 6 < Vd 5 , F 6 * Vd 6 > F 5 * Vd 5 , Vd 6 < Vd 7 , \vert F 7 * Vd 7 \vert > \vert F 6 * Vd 6 \vert , Vd 7 < Vd 2 , \vert F 7 * Vd 7 \vert > F 2 * Vd 2 , Vd 5 < Vd 3 , F 5 * Vd 5 > F 3 * Vd 3 \qquad [ Equation 50 - 1 ]$$

In Equation 50-1, Vd2, Vd3, Vd5, Vd6, Vd7 are Abbe numbers of the second, third, fifth, sixth, and seventh lenses, and F2, F3, F5, F6, F7 are focal lengths of the second, third, fifth, sixth, and seventh lenses. Accordingly, aberration correction may be performed between plastic lenses and glass lenses.

$$0 < \vert F 1 \vert / F < 10 \qquad [ Equation 51 ]$$

Equation 51 sets the relationship between the focal length F1 and the effective focal length F of the first lens, so that the TTL of the optical system may be set. Preferably, Equation 51 may satisfy: 1<|F1|/F<5.

$$0 < \vert F 4 / F 5 \vert < 1 \qquad [ Equation 52 ]$$

In Equation 52, the relationship between the focal lengths F4 and F5 of the fourth and fifth lenses may be set, so that the refractive power and the optical path of the last glass lens and the first plastic lens adjacent to it may be adjusted, and the resolution may be improved. Equation 52 may preferably satisfy: 0.5<|F4/F5|<0.9.

$$0 < \vert F 4 / F 7 \vert < 1 \qquad [ Equation 53 ]$$

In Equation 53, by setting the relationship between the focal lengths F4 and F7 of the fourth and seventh lenses, the refractive power and optical path of the last glass lens and the last plastic lens may be adjusted, and the resolution may be improved. Equation 53 preferably satisfies: 0<|F4/F7|<0.6.

$$0 < \vert F 6 / F 1 \vert < 1.2 \qquad [ Equation 54 ]$$

In Equation 54, by setting the relationship between the focal lengths F1 and F6 of the 1st and sixth lenses, the refractive power and optical path of the first glass lens and the first plastic lens may be adjusted, and the influence of TTL may be adjusted, and the resolution may be improved. Equation 54 preferably satisfies: 0.1<| F6/F1|<0.6.

$$0 < \vert F 27 \vert / F < 2 \qquad [ Equation 55 ]$$

In Equation 55, the relationship between the composite focal length F27 of the second to seventh lenses and the effective focal length F is set, so that the refractive power of the second to seventh lenses may be controlled to improve the resolution, and the optical system may be provided in a slim and compact size. Equation 55 preferably satisfies: 0.5<|F27/F|<1.5.

$$0 < \vert F 27 < F 6 \vert < 1 \qquad [ Equation 56 ]$$

In Equation 56, the relationship between the composite focal length F27 of the second to seventh lenses and the focal length F6 of the sixth lens is set, so that the composite refractive power of the second to seventh lenses and the refractive power of the plastic lens may be controlled to improve the resolution, and the optical system may be provided in a slim and compact size. Equation 56 preferably satisfies: 0<|F27<F6|<0.8.

$$0 < \vert F 27 < F 7 \vert < 1 \qquad [ Equation 57 ]$$

In Equation 57, the relationship between the composite focal length F27 of the second to seventh lenses and the focal length F7 of the seventh lens is set, so that the refractive power of the second to seventh lenses and the refractive power of the last plastic lens may be adjusted to improve the resolution, and the optical system may be provided in a slim and compact size. Equation 57 preferably satisfies: 0<|F27<F7|<0.5.

$$0 < F 6 / F < 5 \qquad [ Equation 58 ]$$

In Equation 58, the relationship between the focal length F6 of the sixth lens and the effective focal length F is set, so that the refractive power of the first plastic lens and the entire focal length may be adjusted to improve the resolution, and the optical system may be provided in a slim and compact size. Equation 58 preferably satisfies: 1<F6/F<4.

$$F\_LG1 / F\_LG2 < 0 \qquad [ Equation 59 ]$$

In Equation 59, the relationship between the focal length F_LG1 of the first lens group LG1 and the focal length of the second lens group F_LG2 may be set. The focal length of the first lens group may have a negative value, and the focal length of the second lens group may have a positive value. When Equation 59 is satisfied, the optical system 1000 can improve aberration characteristics such as chromatic aberration and distortion aberration. Equation 59 may preferably satisfy: 2<|F_LG1/F_LG2|<7.

$$1 < nGL / nPL < 4 \qquad [ Equation 60 ]$$

In Equation 60, nGL means the number of lenses made of glass, and nPL means the number of lenses made of plastic. In Equation 60, by arranging the number of plastic lenses to be 1 time more than the number of glass lenses, the thickness of the optical system may be reduced and a wider range of refractive powers may be provided through the aspherical surface. Equation 60 preferably satisfies: 1<nGL/nPL<2.

$$CA 7 \leq CA 1 < CA 3 \qquad [ Equation 61 ]$$

In Equation 61, the size relationship of the average effective diameters CA1, CA3, and CA7 of the object-side surface and the sensor-side surface of the first, third, and seventh lenses may be set. When Equation 61 is satisfied, the first and second lens groups may be set, and aberration may be improved through the first lens of the second lens group LG2. The CA3 may have the maximum effective diameter in the optical system.

$$0 < ΣPL\_CT / ΣGL\_CT < 1 \qquad [ Equation 62 ]$$

In Equation 62, ΣPL_CT is the sum of the center thicknesses of the plastic lens(es), and EGL CT is the sum of the center thicknesses of the glass lenses. If Equation 62 is satisfied, the overall TTL may be controlled by setting the relationship between the thickness of the plastic lens and the thickness of the glass lens relative to the TTL. Equation 62 preferably satisfies: 0.3<ΣPL_CT/ΣGL_CT<0.8.

$$0 < ΣPL\_Nd / ΣGL\_Nd < 1.2 \qquad [ Equation 63 ]$$

In Equation 63, ΣPL_Nd is the sum of the refractive index thicknesses of the plastic lens(es) at the d-line, and ΣGL_Nd is the sum of the refractive indices of the glass lenses at the d-line. If Equation 63 is satisfied, the refractive index relationship between the plastic lens and the glass lens may be set to control the overall resolution. Preferably, Equation 63 may satisfy: 0.5<ΣPL_Nd/ΣGL_Nd<1.

$$10 mm < TTL < 45 mm \qquad [ Equation 64 ]$$

TTL means the distance (mm) from the center of the first surface S1 of the first lens 121 to the image surface of the image sensor 300 on the optical axis OA. In Equation 64, the TTL may be set to exceed 10 mm or 20 mm, thereby providing an optical system for a vehicle. Equation 64 may preferably satisfy the following condition: 30 mm<TTL≤40 mm or TD<TTL.

$$2 mm < ImgH < 20 mm \qquad [ Equation 65 ]$$

Equation 65 may set the diagonal size (2*ImgH) of the image sensor 300, and can provide an optical system having a sensor size for a vehicle. Equation 65 may preferably satisfy: 4 mm≤ImgH<6 mm.

$$1 mm < BFL < 3.5 mm \qquad [ Equation 66 ]$$

In Equation 66, BFL is set to be more than 1 mm and less than 3.5 mm, so that the installation space of the filter 500 and the cover glass 400 may be secured, and the assembly of the components may be improved through the distance between the image sensor 300 and the last lens, and the bonding reliability may be improved. Equation 66 preferably satisfies: 1.5 mm≤BFL≤3 mm. When the BFL is less than the range of Equation 68, some of the light that proceeds to the image sensor may not be transmitted to the image sensor, which may be a cause of resolution degradation. When the BFL exceeds the range of Equation 68, stray light may be introduced, which may deteriorate the aberration characteristics of the optical system.

$$3 < BFL / CG 5 < 10 \qquad [ Equation 67 ]$$

In Equation 67, BFL is set to be larger than the distance between lenses, for example, the center distance CG5 between the fifth and sixth lenses, so that the installation space for the filter 500 and the cover glass 400 may be secured, and the assemblability of the components may be improved and the bonding reliability may be improved through the distance between the image sensor 300 and the last lens. Equation 67 may satisfy: 5≤BFL/CG5≤9.

$$CG 2 , CG 4 , CG 5 < BFL \qquad [ Equation 68 ]$$

In Equation 68, BFL is set to be larger than the distance between the lenses, for example, the center distance CG2 between the second and third lenses, the center distance CG4 between the fourth and fifth lenses, and the center distance CG5 between the fifth and sixth lenses, so that the installation space for the filter 500 and the cover glass 400 may be secured, and the assembly of the components may be improved and the bonding reliability may be improved through the distance between the image sensor 300 and the last lens. In addition, the seventh lens, which is the last lens, can disperse the incident light to the effective region of the image sensor, but if the BFL does not satisfy Equation 68, some of the emitted light may not be transmitted to the effective region of the image sensor, thereby lowering the resolution. Here, the CG2 may be the optical axis distance between the lens positioned on the object side and the cemented lens, and may be smaller than the BFL.

$$3 mm < F < 40 mm \qquad [ Equation 69 ]$$

Equation 69 may set the total focal length F to suit the vehicle optical system. Equation 69 may satisfy: 5 mm<F<30 mm.

$$FOV < 45 degrees \qquad [ Equation 70 ]$$

In Equation 70, FOV means the field of view (Degree) of the optical system 1000, and can provide a vehicle optical system of less than 45 degrees. Preferably, the FOV may satisfy: 20 degrees≤FOV≤40 degrees.

$$1 < TTL / CA\_max < 5 \qquad [ Equation 71 ]$$

In Equation 71, CA_max means the largest effective diameter (mm) among the object-side and sensor-side surfaces of the plurality of lenses, and TTL means the distance (mm) from the vertex of the first surface S1 of the first lens to the image surface of the image sensor 300 on the optical axis OA. Equation 71 sets the relationship between the total optical axis length of the optical system and the maximum effective diameter, thereby providing an improved vehicle optical system. Equation 71 may preferably satisfy: 1.5<TTL/CA_max≤4.

$$2 < TTL / ImgH < 10 \qquad [ Equation 72 ]$$

Equation 72 may set the total optical axis length TTL of the optical system and the diagonal length ImgH from the optical axis of the image sensor 300. When the optical system 1000 according to the third embodiment satisfies the Equation 72, the optical system 1000 may have a TTL for application to the vehicle image sensor 300, thereby providing a more improved image quality. The Equation 72 may preferably satisfy: 4<TTL/ImgH<10.

$$0.1 < BFL / ImgH < 1 \qquad [ Equation 73 ]$$

The Equation 73 may set the optical axis distance between the image sensor 300 and the last lens and the length in the diagonal direction from the optical axis of the image sensor 300. When the optical system 1000 according to the third embodiment satisfies Equation 73, the optical system 1000 can secure BFL for applying the size of the vehicle image sensor 300, set the distance between the last lens and the image sensor 300, and have good optical characteristics at the center and periphery of the FOV. Equation 73 may preferably satisfy: 0.2<BFL/ImgH<0.8.

$$5 < TTL / BFL < 30 \qquad [ Equation 74 ]$$

Equation 74 may set the total optical axis length TTL of the optical system, and the optical axis distance BFL (unit: mm) between the image sensor 300 and the last lens. When the optical system 1000 according to the third embodiment satisfies Equation 55, the optical system 1000 can secure BFL. Equation 74 may preferably satisfy: 10<TTL/BFL<25.

$$1 < TTL / F < 3 \qquad [ Equation 75 ]$$

Equation 75 may set the total focal length F and the total optical axis length TTL of the optical system 1000. Accordingly, an optical system for a driver assistance system may be provided. Equation 75 may preferably satisfy: 1.5<TTL/F≤2.8 or 2≤TTL/F≤2.8. When the optical system 1000 according to the third embodiment satisfies Equation 75, the optical system 1000 may have an appropriate focal length in the set TTL range, and provides an optical system that can maintain an appropriate focal length and form an image even when the temperature changes from low temperature to high temperature. If it is below the lower limit of Equation 75, the refractive power of the lenses needs to be increased, making it difficult to correct spherical aberration or distortion aberration. If it is above the upper limit of Equation 75, the effective diameter or TTL of the lenses becomes longer, which may cause a problem of the imaging lens system becoming larger.

$$3 < F / BFL < 10 \qquad [ Equation 76 ]$$

Equation 76 may set the total focal length F of the optical system 1000 and the optical axis distance BFL between the image sensor 300 and the last lens. When the optical system 1000 according to the third embodiment satisfies Equation 76, the optical system 1000 may have a set field of view and an appropriate focal length, and a vehicle optical system may be provided. In addition, the optical system 1000 can minimize the gap between the last lens and the image sensor 300, and thus may have good optical characteristics in the periphery of the FOV. Equation 76 may preferably satisfy: 5<F/BFL<10.

$$1 < F / ImgH < 5 \qquad [ Equation 77 ]$$

Equation 77 may set the overall focal length F (mm) of the optical system 1000 and the diagonal length ImgH from the optical axis of the image sensor 300. This optical system 1000 may have improved aberration characteristics in the size of the vehicle image sensor 300. Equation 77 may preferably satisfy: 2<F/ImgH<4.

$$1 < F / EPD < 5 \qquad [ Equation 78 ]$$

Equation 78 may set the overall focal length F (mm) and the entrance pupil diameter of the optical system 1000. Accordingly, the overall brightness of the optical system may be controlled. Equation 78 can preferably satisfy: 1<F/EPD<3.

$$0 < BFL / TD < 0.3 \qquad [ Equation 79 ]$$

Equation 79 may set the relationship between the optical axis distance TD and the back focal length BFL of the lenses of the optical system 1000. Accordingly, the resolution of the optical system may be maintained and the overall size may be controlled. Equation 79 preferably satisfies: 0<BFL/TD<0.2. When the condition value of BFL/TD is 0.2 or more, the BFL is designed to be large compared to the TD, so the size of the entire optical system becomes large, making it difficult to miniaturize the optical system, and the distance between the seventh lens and the image sensor becomes long, so that an unnecessary amount of light may increase between the seventh lens and the image sensor, resulting in a problem of lowering the resolution, such as deterioration of aberration characteristics.

$$0 < EPD / ImgH / FOV < 0.2 \qquad [ Equation 80 ]$$

Equation 80 may set the relationship between the entrance pupil diameter (EPD), the length of ½ of the maximum diagonal length ImgH of the image sensor, and the field of view. Accordingly, the overall size and brightness of the optical system may be controlled. Preferably, Equation 80 may satisfy: 0<EPD/ImgH/FOV<0.1.

$$5 < FOV / F \# < 40 \qquad [ Equation 81 ]$$

Equation 81 may set the relationship between the field of view and the F number F # of the optical system. Preferably, Equation 81 may satisfy: 10<FOV/F #<30. Here, F # is provided to be 1.6 or less, so as to provide a bright image.

$$1 < ΣGL\_CT / F \# < 20 \qquad [ Equation 82 ]$$

Equation 82 may set the relationship between the sum of center thicknesses ΣGL_CT of glass lenses of an optical system and the F number F #. Preferably, Equation 82 may satisfy: 5<ΣGL_CT/F #<15.

$$1 < ΣPL\_CT / F \# < 20 \qquad [ Equation 83 ]$$

Equation 83 may set the relationship between the sum of center thicknesses ΣPL_CT of plastic lenses of an optical system and the F number (F #). Preferably, Equation 83 may satisfy: 1<ΣPL_CT/F #<10.

$$1 \leq ΣGL\_Nd / F \# < 2 \qquad [ Equation 84 ]$$

Equation 84 may set the relationship between the sum of refractive indices ΣGL_Nd of glass lenses of an optical system and the F number F #. Equation 84 preferably satisfies: 1≤ΣGL_Nd/F #<1.5.

$$0 < ΣPL\_Nd / F \# < 5 \qquad [ Equation 85 ]$$

Equation 85 may set the relationship between the sum of refractive indices ΣPL_Nd and the F number F # of plastic lenses of an optical system. Equation 85 preferably satisfies: 0<ΣPL_Nd/F #<1.5.

$$CT 34 * L 3 R 1 < CT 2 * L 2 R 1 \qquad [ Equation 86 ]$$

In Equation 87, the product of the center thickness CT2 of the second lens 122 and the radius of curvature L2R1 of the object-side surface is set to be greater than the product of the radius of curvature L3R1 of the object-side surface of the center thickness CT34 of the cemented lens 134, so that the optical characteristics of the glass lens between the first lens 121 and the cemented lens 134 may be set.

$$CT 34 * L 3 R 1 < CT 34 * L 4 R 2 \qquad [ Equation 87 ]$$

In Equation 61, the relationship between the radius of curvature L3R1 of the object-side surface of the center thickness CT34 of the cemented lens 134 and the radius of curvature L3R2 of the sensor-side surface may be set, so that the axial chromatic aberration may be reduced, and the gap between the lenses may be removed to reduce the TTL.

$$2 ( CT 5 * L 5 R 1 ) < ( CT 34 * L 3 R 1 ) < 4 ( CT 5 * L 5 R 1 ) \qquad [ Equation 88 ]$$

In Equation 88, the radius of curvature L3R1 of the object-side surface of the cemented lens 134 and the center thickness CT5 and the radius of curvature L5R1 of the object-side surface of the plastic lens adjacent to the cemented lens are set, so that the aberration difference between the adjacent glass lens and the plastic lens may be compensated.

$$( CT 7 * L 7 R 1 ) < ( CT 2 * L 2 R 1 ) < 3 ( CT 7 * L 7 R 1 ) \qquad [ Equation 89 ]$$

In Equation 89, the relationship between the radius of curvature L2R1 of the second lens 122 with the maximum center thickness and the last plastic lens may be set, so that the aberration difference between the glass lens and the plastic lens may be compensated.

$$200 < ( TTL * ΣGL\_Nd ) < 300 \qquad [ Equation 90 ]$$

In Equation 90, by setting the relationship between the sum of the refractive indices of TTL and glass material, the occurrence of spherical aberration due to glass material may be controlled.

$$150 < ( TTL * ΣPL\_Nd ) < 200 \qquad [ Equation 91 ]$$

In Equation 91, by setting the relationship between the sum of the refractive indices of TTL and plastic material, the spherical aberration due to glass material may be corrected by plastic material.

$$0.05 < \vert Sag\_i / ( CA\_i / 2 ) \vert < 0.2 ( i = S 1 , S 2 , S 3 , S 4 \qquad [ Equation 92 ]$$

Equation 92 may set the relationship between the Sag value of the first to fourth surfaces S1, S2, S3, and S4 of the first and second lenses and the effective diameter CA, and if it satisfies this, the refractive power of the lenses may be improved. Here, if Equation 92 further satisfies the following condition: Nd1>1.7, it is possible for the first lens and the second lens to gather light with sufficient power without designing the radius of curvature of the first and second lenses sharply within the effective diameter.

$$Z = \frac{{cY}^{2}}{1 + \sqrt{1 - ( 1 + K ) {c}^{2} {Y}^{2}}} + {AY}^{4} + {BY}^{6} + {CY}^{8} + {DY}^{10} + {EY}^{12} + {FY}^{14} + … \qquad [ Equation 93 ]$$

In the Equation 93, Z may mean a distance in the direction of the optical axis from an arbitrary position on the aspherical surface to the vertex of the aspherical surface. The Y may mean a distance in the direction perpendicular to the optical axis from an arbitrary position on the aspherical surface to the optical axis. The c may mean a curvature of the lens, and K may mean a conic constant. In addition, A, B, C, D, E, and F may mean aspheric coefficients.

The optical system 1000 according to the third embodiment may satisfy at least one or two or more Equations among Equations 1 to 50. In this case, the optical system 1000 may have improved optical characteristics and improved resolution, and may improve aberration and distortion characteristics. In addition, the optical system 1000 can secure a BFL for applying a vehicle image sensor 300, compensate for the deterioration of optical characteristics due to temperature change, and minimize the gap between the last lens and the image sensor 300, thereby providing good optical performance at the center and periphery of the FOV.

Table 5 shows the items of the Equations described above in the optical system 1000 of the third embodiment, including the TTL (mm), BFL, effective focal length F (mm), ImgH (mm), effective diameter CA (mm), thickness (mm), TD (mm), which is an optical axis distance from the first surface S1 to the fourteenth surface S14, the focal length F1-F7 (mm) of each of the first to seventh lenses, the sum of refractive indices, the sum of Abbe numbers, the sum of thicknesses (mm), the sum of distances between adjacent lenses, the effective diameter characteristics, the sum of refractive indices of glass lenses, the sum of refractive indices of plastic materials, FOV (Degree), the edge thickness ET, the focal lengths of the first and second lens groups, and the F number, etc. of the optical system 1000.

TABLE 5

| Items | Values | Items | Values |
|---|---|---|---|
| F | 15.332 | ET1 | 6.336 |
| F1 | −49.354 | ET2 | 5.347 |
| F2 | 21.927 | ET3 | 1.675 |
| F3 | 19.166 | ET4 | 3.177 |
| F4 | −24.269 | ET5 | 2.098 |
| F5 | 39.159 | ET6 | 3.957 |
| F6 | −21.186 | ET7 | 4.222 |
| F7 | −139.190 | F-number | 1.600 |
| F_LG1 | −49.3544 | FOV | 33.100 |
| F_LG2 | 12.80304 | EPD | 9.583 |
| ΣNd | 11.398 | BFL | 1.855 |
| ΣAbbe | 333.954 | TD | 35.194 |
| ΣCT | 28.951 | ImgH | 4.630 |
| ΣCG | 6.243 | SD | 27.292 |
| CA_max | 13.401 | TTL | 37.049 |
| CA_min | 8.458 | ΣGL_Nd | 1.665 |
| CA_Aver | 11.621 | ΣPL_Nd | 1.579 |
| CT_max | 6.994 | Image sensor | 3840*2160 |
| CT_min | 2.000 | CT_Aver | 4.136 |

Table 6 shows the result values for the Equations 1 to 50 described above in the optical system 1000 of the third embodiment. Referring to Table 5, it may be seen that the optical system 1000 satisfies at least one, two or more, or three or more of the Equations 1 to 50. Accordingly, the optical system 1000 may have good optical performance and excellent optical characteristics at the center and periphery of the FOV.

TABLE 6

| Equations | | Values |
|---|---|---|
| 1 | 0.5 < CT1/ET1 < 1 | 0.897 |
| 2 | 0.2 < CT1/CA11 < 0.8 | 0.453 |
| 3 | Po1 < 0 | −0.020 |
| 4 | 1.7 < Nd1 < 2.2 | 1.772 |
| 5 | 20 < FOV_H < 40 | 29.800 |
| 6 | L1R1 < 0 | −15.388 |
| 7 | 1 < L7S2_max_sag to Sensor < 3 | 1.686 |
| 8 | 1 < CT1/CT7 < 3 | 1.410 |
| 9 | 1 < CT1/CT6 < 3 | 1.725 |
| 10 | 1 < CT34/CT5 < 5 | 1.741 |
| 11 | 0 < L2R1/L4R2 < 1 | 0.622 |
| 12 | 0.8 < (CT34 − ET34) < 2 | 1.171 |
| 13 | 0 < CA11/CA31 < 2 | 0.935 |
| 14 | 0 < CA72/CA42 < 2 | 0.762 |
| 15 | 0 < CA12/CA21 < 2 | 1.059 |
| 16 | 0.5 < CA31/CA42 < 2.5 | 1.094 |
| 17 | L3R1 > \|L3R2\| | satisfaction |
| 18 | 2 < L2R1/(CA21/2) < 5 | 4.425 |
| 19 | 0.2 < CA_GL_AVER/CA_PL_AVER < 2.2 | 1.262 |
| 20 | 1.20 < GL_CA1_AVER/PL_CA1_AVER < 1.60 | 1.212 |
| 21 | CA567 < CA34 | satisfaction |
| 22 | CG2 < CG1 < CG6 | satisfaction |
| 23 | 1 < CT7/CG6 < 3 | 1.378 |
| 24 | (CG5 + CG6) < CT34 < 2(CG5 + CG6) | satisfaction |
| 25 | 4(CG2 + CG5) < CT2 < 8(CG2 + CG5) | satisfaction |
| 26 | 1 < CT2/CT1 < 4 | 1.231 |
| 27 | 1 < L7R1/CT7 < 100 | 6.164 |
| 28 | 0 < L5R2/L7R1 < 10 | 0.674 |
| 29 | 0 < L3R1*L4R2 | 773.782 |
| 30 | 1 < L6R1/L5R2 < 10 | 4.546 |
| 31 | 0 < L6R2/L6R1 < 1 | 0.153 |
| 32 | 0 < CT_Max/CG_Max < 5 | 2.391 |
| 33 | 2 < ΣCT/ΣCG < 6 | 4.637 |
| 34 | 10 < ΣNd < 30 | 11.398 |
| 35 | 10 < ΣAbb/ΣNd < 50 | 29.300 |
| 36 | Distortion < 2 | 0.478 |
| 37 | 0 < ΣCT/ΣET < 2 | 1.080 |
| 38 | 0.5 < CA21/CA_min < 2 | 1.415 |
| 39 | 1 < CA_max/CA_min < 5 | 1.584 |
| 40 | 1 < CA_max/CA_Aver < 3 | 1.153 |
| 41 | 0.5 < CA_min/CA_Aver < 2 | 0.728 |
| 42 | 1 < CA_max/(2*ImgH) < 3 | 1.447 |
| 43 | 1 < TD/CA_max < 4 | 2.626 |
| 44 | 1 < F/CA51 < 10 | 1.274 |
| 45 | 0 < F/\|L1R1 \| < 1 | 0.996 |
| 46 | Max_th/Min_th < 5 | 3.906 |
| 47 | 0 < EPD/\|L1R1\| < 1 | 0.623 |
| 48 | −5 < F1/F3 < 0 | −2.575 |
| 49 | Po3 * Po4 < 0 | satisfaction |
| 50 | 15 < Vd3 − Vd4 < 50 | 29.336 |

Table 7 shows the result values for the Equations 51 to 91 described above in the optical system 1000 of the third embodiment. Referring to Table 6, it may be seen that the optical system 1000 satisfies at least one, two or more, or three or more of the Equations 51 to 92. Accordingly, the optical system 1000 may have good optical performance and excellent optical characteristics at the center and periphery of the FOV.

TABLE 7

| Equations | | Values |
|---|---|---|
| 51 | 0 < \| F1\|/F < 10 | 3.219 |
| 52 | 0 < \| F4/F5 \| < 1 | 0.620 |
| 53 | 0 < \| F4/F7 \| < 1 | 0.174 |
| 54 | 0 < \| F6/F1 \| < 1.2 | 0.429 |
| 55 | 0 < \| F27\|/F < 2 | 0.835 |
| 56 | 0 < \| F27 < F6 \| < 1 | 0.604 |
| 57 | 0 < \| F27 < F7 \| < 1 | 0.092 |
| 58 | 0 < F5/F < 5 | 2.554 |
| 59 | F_LG1/F_LG2 < 0 | −3.855 |
| 60 | 1 < nGL/nPL < 2 | 1.333 |
| 61 | CA7 < CA1 < CA3 | satisfaction |
| 62 | 0 < ΣPL_CT/ΣGL_CT < 1.2 | 0.577 |
| 63 | 0 < ΣPL_Nd/ΣGL_Nd < 1 | 0.949 |
| 64 | 10 < TTL < 45 | 37.049 |
| 65 | 2 < ImgH < 20 | 4.630 |
| 66 | 1 < BFL < 3.5 | 1.855 |
| 67 | 3 < BFL/CG5 < 10 | 7.224 |
| 68 | CG2, CG4, CG5 < BFL | satisfaction |
| 69 | 3 < F < 40 | 15.332 |
| 70 | FOV < 45 | 33.100 |
| 71 | 1 < TTL/CA_max < 5 | 2.765 |
| 72 | 2 < TTL/ImgH < 10 | 8.002 |
| 73 | 0.1 < BFL/ImgH < 1 | 0.401 |
| 74 | 5 < TTL/BFL < 30 | 19.969 |
| 75 | 1 < TTL/F < 3 | 2.416 |
| 76 | 3 < F/BFL < 10 | 8.264 |
| 77 | 1 < F/ImgH < 5 | 3.312 |
| 78 | 1 < F/EPD < 5 | 1.600 |
| 79 | 0 < BFL/TD < 0.3 | 0.0527 |
| 80 | 0 < EPD/ImgH/FOV < 0.2 | 0.0625 |
| 81 | 5 < FOV/F# < 40 | 21.355 |
| 82 | 1 < ΣGL_CT/F# < 20 | 11.475 |
| 83 | 1 < ΣPL_CT/F# < 20 | 6.619 |
| 84 | 1 < ΣGL_Nd/F# < 20 | 1.041 |
| 85 | 1 < ΣPL_Nd/F# < 10 | 0.987 |
| 86 | CT34*L3R1 < CT2*L2R1 | satisfaction |
| 87 | CT34*L3R1 < CT34*L4R2 | satisfaction |
| 88 | 2(CT5*L5R1) < (CT34*L3R1) < 4(CT5*L5R1) | satisfaction |
| 89 | (CT7*L7R1) < (CT2*L2R1) < 3(CT7*L7R1) | satisfaction |
| 90 | 200 < (TTL*ΣGL_Nd) < 300 | 61.682 |
| 91 | 150 < (TTL*ΣPL_Nd) < 200 | 58.515 |
| 92 | 0.05 < \|Sag_i/(CA_i/2)\| < 0.2 (i = S1, S2, S3, S4 | satisfaction |

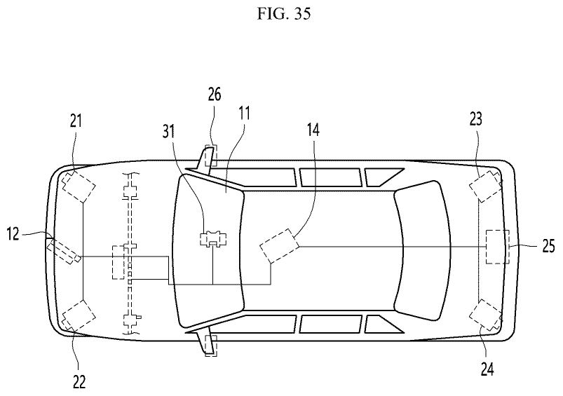

FIG. 35 is an example of a plan view of a vehicle to which a camera module or optical system according to an embodiment of the invention is applied. Referring to FIG. 35, a vehicle camera system according to an embodiment of the invention includes an image generating unit 11, a first information generating unit 12, a second information generating unit 21, 22, 23, 24, 25, and 26, and a control unit 14. The image generating unit 11 may include at least one camera module 31 disposed in the vehicle, and may capture images of the front of the vehicle and/or the driver to generate images of the front or interior of the vehicle. The image generating unit 11 may capture images of the front of the vehicle as well as the surroundings of the vehicle in one or more directions using the camera module 31, to generate images of the surroundings of the vehicle. Here, the front and surrounding images may be digital images, and may include color images, black and white images, and infrared images. In addition, the front and surrounding images may include still images and moving images. The image generating unit 11 provides the driver image, the front image, and the surrounding image to the control unit 14. Next, the first information generating unit 12 may include at least one radar and/or camera placed in the own vehicle, and detects the front of the own vehicle to generate the first detection information. Specifically, the first information generating unit 12 is placed in the own vehicle and detects the position and speed of vehicles located in front of the own vehicle, whether there is a pedestrian, and the position, etc. to generate the first detection information.

Using the first detection information generated by the first information generating unit 12, the distance between the own vehicle and the vehicle in front may be controlled to be maintained at a constant level, and the stability of vehicle operation may be increased in specific cases set in advance, such as when the driver wants to change the driving lane of the own vehicle or when parking in reverse. The first information generating unit 12 provides the first detection information to the control unit 14. The second information generating unit 21, 22, 23, 24, 25, and 26 detects each side of the own vehicle based on the front image generated by the image generating unit 11 and the first detection information generated by the first information generating unit 12 to generate the second detection information. Specifically, the second information generating unit 21, 22, 23, 24, 25, and 26 may include at least one radar and/or camera disposed on the own vehicle, and may detect the position and speed of vehicles located on the side of the own vehicle or capture images. Here, the second information generating unit 21, 22, 23, 24, 25, and 26 may be disposed on each of the front corners, side mirrors, and the rear center and rear corners of the own vehicle.

At least one information generating unit of these vehicle camera systems may be equipped with an optical system and a camera module having the same as described in the above-described embodiments, and may provide or process information acquired through the front, rear, each side, or corner region of the vehicle to a user to enable autonomous driving or to protect the vehicle and objects from surrounding safety. The optical system of the camera module according to the embodiment of the invention may be installed in multiple units in a vehicle to enhance safety regulations, autonomous driving functions, and increase convenience by using an Advanced Driving Assistance System (ADAS). In addition, the optical system of the camera module is applied in a vehicle as a component for control such as a lane keeping assistance system (LKAS), a lane departure warning system (LDWS), and a driver monitoring system (DMS). This vehicle camera module can implement stable optical performance even under ambient temperature changes and can provide a module with price competitiveness, thereby ensuring the reliability of vehicle components.

Features, structures, effects, etc. described in the embodiments are included in at least one embodiment of the invention, and are not necessarily limited to only one embodiment. Furthermore, features, structures, effects, etc. illustrated in each embodiment may be combined or modified for other embodiments by those of ordinary skill in the art to which the embodiments belong. Accordingly, the contents related to such combinations and modifications should be interpreted as being included in the scope of the invention. In addition, although the embodiment has been described above, it is only an example and does not limit the invention, and those of ordinary skill in the art to which the invention pertains are exemplified above in a range that does not depart from the essential characteristics of the present embodiment. It may be seen that various modifications and applications that have not been made are possible. For example, each component specifically shown in the embodiment may be implemented by modification. And the differences related to these modifications and applications should be construed as being included in the scope of the invention defined in the appended claims.

1. An optical system comprising:
an image sensor; and
first to fourth lenses sequentially aligned along an optical axis toward the image sensor from an object,
wherein a power of the first lens is positive,
wherein a power of the second lens is negative,
wherein a power of the third lens is positive,
wherein at least two of the first to fourth lenses are plastic lenses,
wherein the first lens is made of glass,
wherein the first lens has a convex meniscus shape toward the object,
wherein an object-side surface and a sensor-side surface of the first lens are spherical,
wherein a refractive index of the first lens is 1.7 or greater, and
wherein an object-side surface and a sensor-side surface of the fourth lens closest to the image sensor among the first to fourth lenses include a critical point between the optical axis and an edge.

2. An optical system comprising:
at least two plastic lenses and at least two glass lenses,
wherein the glass lenses and the plastic lenses are sequentially aligned along an optical axis from an object side toward an image sensor,
wherein a power of a first lens closest to the object side is positive,
wherein the first lens is made of glass,
wherein the first lens has a convex meniscus shape toward the object side,
wherein an object-side surface and a sensor-side surface of the first lens are spherical,
wherein a composite power of the remaining lenses excluding the first lens closest to the object side is positive,
wherein a lens having a thinnest thickness in the optical axis among the lenses is one of the glass lenses, and
wherein a lens having a thickest thickness in the optical axis among the lenses is one of the plastic lenses.

3. The optical system of claim 2, wherein the thickest lens in the optical axis is a plastic lens closest to the glass lens disposed on a sensor-side of the first lens.

4. The optical system of claim 2, wherein an object-side surface and a sensor-side surface of a lens closest to the image sensor include a critical point between the optical axis and an edge.

5. The optical system of claim 2, wherein a refractive index of the first lens is 1.7 or more.

6. The optical system of claim 2, wherein the glass lenses are two lenses closest to the object side.

7. The optical system of claim 2, wherein each of the glass lenses closest to the object side has a meniscus shape convex toward the object side on the optical axis.

8. The optical system of claim 2, wherein the glass lenses are spherical lenses,
wherein the plastic lenses are aspherical lenses,
wherein the glass lens closest to the plastic lens has a meniscus shape convex toward the image sensor on the optical axis, and
wherein the plastic lens closest to the glass lens has a meniscus shape convex toward the image sensor on the optical axis.

9. The optical system of claim 2, wherein a sum of the thicknesses of the glass lenses along the optical axis is ΣGL_CT,
wherein an optical axis distance from the object-side surface of the first lens to a sensor-side surface of the lens closest to the image sensor is TD, and
wherein the following Equation satisfies: 0.15≤ΣGL_CT/TD≤0.25.

10. An optical system comprising:
lenses of a first material arranged sequentially along an optical axis; and
lenses of a second material arranged sequentially along the optical axis on a sensor side of the lenses of the first material,
wherein the lenses of the first material include lenses having an aspherical surface and lenses having a spherical surface,
wherein the lenses of the second material include lenses having an aspherical surface,
wherein the first material is different from the second material, and
wherein an average of a center thicknesses of the lenses of the first material is larger than an average of a center thicknesses of the lenses of the second material.

11. The optical system of claim 10, wherein the first material is a glass material, and
wherein the second material is a plastic material.

12. The optical system of claim 10, wherein an average of refractive indices of the lenses of the first material is greater than an average of a refractive indices of the lenses of the second material, and
wherein an average effective diameter of the lenses of the first material is larger than an average effective diameter of the lenses of the second material.

13. The optical system of claim 10,
wherein a number of lenses of the first material is greater than that of the lenses of the second material, and
wherein a difference between the number of lenses of the first material and the number of lenses of the second material is less than the number of lenses of the second material.

14. The optical system of claim 11, comprising a cemented lens in which at least two of the lenses of the first material are bonded to each other,
wherein the cemented lens includes a lens having a positive refractive power and a lens having a negative refractive power.

15. A camera module comprising:
an image sensor;
first to fourth lenses sequentially aligned along an optical axis from an object toward an image sensor; and
an optical filter between the image sensor and the fourth lens,
wherein a center thickness of the third lens is greater than a sum of center thicknesses of each of the first and second lenses,
wherein each of effective diameters of the first to third lenses is smaller than a diagonal length of the image sensor,
wherein at least one of the first to fourth lenses is a spherical lens,
wherein at least another one of the first to fourth lenses is an aspherical lens,
wherein the first lens is made of glass,
wherein the first lens has a convex meniscus shape toward the object,
wherein an object-side surface and a sensor-side surface of the first lens are spherical,
wherein a distance from a center of the object-side surface of the first lens to a surface of the image sensor is TTL,
wherein a total effective focal length is F, and half of a diagonal length of the image sensor is ImgH,
wherein the following Equation 1 satisfies: 1 mm≤F≤10 mm,
wherein the following Equation 2 satisfies: 1 mm<TTL/ImgH<5 mm, and
wherein the following Equation 3 satisfies: TTL≤10 mm.

16. The optical system of claim 1,
wherein an average effective diameter of the object-side surface and the sensor-side surface of the first lens is larger than an average effective diameter of an object-side surface and a sensor-side surface of the second lens.

17. The optical system of claim 1,
wherein a center thickness of the third lens is a largest among the center thicknesses of the first to fourth lenses.

18. The optical system of claim 17,
wherein the second lens is made of glass, and
wherein the center thickness of the second lens is a thinnest among the center thicknesses of the first to fourth lenses.

19. The optical system of claim 17,
wherein the third lens has a convex meniscus shape toward the image sensor on the optical axis.

20. The optical system of claim 17,
wherein the second lens is made of glass, and
wherein the third lens and the fourth lens are made of plastic.
